(19) United States
(12) Patent Application Publication
(10) Pub. No.: US 2023/0211329 A1
(43) Pub. Date: Jul. 6, 2023

(54) Metal-Oxo Clusters Comprising Noble Metals and Metal Cluster Units Thereof

(71) Applicant: ExxonMobil Chemical PAtents Inc., Baytown, TX (US)

(72) Inventors: Ulrich Kortz, Bremen (DE); Saurav Bhattacharya, Bremen (DE); Ali S. Mougharbel, Bremen (DE)

(21) Appl. No.: 18/001,401

(22) PCT Filed: Jul. 7, 2021
(86) PCT No.: PCT/EP2021/068765

§ 371 Date: Dec. 9, 2022

(30) Foreign Application Priority Data
Jul. 16, 2020 (EP) 20186131.7

(51) Int. Cl. B01J 31/18; B01J 23/30; B01J 31/34; B01J 29/03; C07F 15/00

(52) U.S. Cl. CPC B01J 31/1895; B01J 23/30; B01J 31/34; B01J 29/0308; C07F 15/006; B01J 2531/0211; B01J 2531/824; B01J 2231/646

(57) ABSTRACT

The invention relates to noble metal-oxo clusters represented by the formula [Mₛ(R₂XO₂)_{z}(OR′)ₓO_{y}X′_{q}] or solvates thereof, corresponding supported noble metal-oxo clusters, and processes for their preparation, as well as corresponding metal cluster units, optionally in the form of a dispersion in a liquid carrier medium or immobilized on a solid support, and processes for their preparation, as well as their use in conversion of organic substrate.

### CROSS REFERENCE TO RELATED APPLICATIONS

The present application claims priority to and the benefit of European Application No. 20186131.7, filed on Jul. 16, 2020, which is hereby incorporated by reference in its entirety.

### FIELD OF THE INVENTION

This invention relates to new noble metal-oxo clusters and metal cluster units. Furthermore, this invention relates to processes for the preparation of said new noble metal-oxo clusters and metal cluster units and to their use in catalytic reactions with organic molecules.

### BACKGROUND OF THE INVENTION

Metal clusters in which the metal atoms are bonded to oxygen atoms are known. Most of these compounds belong to a class of compounds referred to as polyoxometalates (POMs). POMs are a unique class of inorganic metal-oxygen clusters. They consist of a polyhedral cage structure or framework bearing a negative charge which is balanced by cations that are usually external to the cage, and may also contain internally or externally located heteroatom(s) or guest atom(s). The framework of POMs comprises a plurality of metal atoms, which can be the same or different, bonded to oxygen atoms. In the plurality of known POMs, the framework metals are dominated by a few elements including transition metals from Group 5 and Group 6 in their high oxidation states, e.g., tungsten (VI), molybdenum (VI), vanadium (V), niobium (V) and tantalum (V).

The first example in the POM family is the so-called Keggin anion [XM₁₂O₄₀]ⁿ⁻ with X being a heteroatom selected from a variety of elements, e.g., P, and M being a Group 5 or Group 6 metal such as Mo or W. These anions consist of an assembly of corner- and edge-shared MO₆ octahedra of the metals of Groups 5 or 6 around a central XO₄ tetrahedron.

One structural motif that has been intensively studied in the field of POMs is the crown-shaped heteropolyanion [H₇P₈W₄₈O₁₈₄]³³⁻, which species is composed of four [H₂P₂W₁₂O₄₈]¹²⁻ fragments which are linked by capping tungsten atoms resulting in a cyclic [P₈W₄₈O₁₈₄]-arrangement having central cavity of around 10 Å diameter (Inorg. Chem. 1985, 24, 4610-4614; Inorg. Synth. 1990, 27, 110). The polyanion [H₇P₈W₄₈O₁₈₄]³³⁻ has been found a suitable catalyst for the hydrogen evolution reaction (Energy Environ. Sci. 2016, 9, 1012-1023). Initially, it was concluded that the highly stable [H₇P₈W₄₈O₁₈₄]³³⁻ heteropolyanion does not give complexes with divalent or trivalent transition-metal ions.

However, in 2005 Kortz and co-workers proved this assumption wrong. The wheel-shaped [Cu₂₀Cl(OH)₂₄(H₂O)₁₂(P₈W₄₈O₁₈₄)]²⁵⁻ ion has been the first transition-metal-substituted derivative of the [H₇P₈W₄₈O₁₈₄]³³⁻ template and incorporated more paramagnetic 3d metal ions than any other polyoxotungstate at the time. The Cl atom occupies the central cavity surrounded by the 20 Cu atoms, wherein 8 of the Cu ions are coordinated distorted octahedral by oxygen, and 4 of the Cu ions are coordinated square-pyramidal by oxygen, while the remaining 8 Cu ions are coordinated square-planar by oxygen (Angew. Chem. Int. Ed. 2005, 44, 3777-3780). The properties of this POM have been also been studied (J. Am. Chem. Soc. 2006, 128, 10103-10110, Chem. Eur. J. 2009, 15, 7490-7497, Electrochem. Commun. 2005, 7, 841-847, Inorg. Chem. 2006, 45, 2866-2872 and Langmuir 2009, 25, 13000-13006) and the respective Br and I analogues have also been prepared (Inorg. Chem. 2009, 48, 11636-11645).

Kortz and co-workers also accomplished the synthesis of a Fe₁₆-species, i.e., [P₈W₄₈O₁₈₄Fe₁₆(OH)₂₈(H₂O)₄]²⁰⁻, by using the heteropolyanion [H₇P₈W₄₈O₁₈₄]³³⁻ template in a reaction with different iron species containing Fe^{II} (in presence of O₂) or Fe^{III} ions. The compound has 16 edge- and corner-sharing FeO₆ octahedra (Chem. Eur. J. 2008, 14, 1186-1195). WO 2008/118619 A1 suggests that this Fe₁₆-species may only be a representative of a broader class of [P₈W₄₈O₁₈₄]-based POMs containing 16 transition metal atoms in its central cavity which could be illustrated by the general formula [H_{q}M₁₆X₈W₄₈O₁₈₄(OH)₃₂]^{m-} with M being selected from the group of transition metals and X being selected from As and/or P.

The related open wheel compounds [Fe₁₆O₂(OH)₂₃(H₂O)₉(P₈W₄₉O₁₈₉)Ln₄(H₂O)₂₀]¹¹⁻ (with Ln=Eu or Gd) resulted from the controlled ring opening of the [P₈W₄₈O₁₈₄]-wheel in aqueous solution at pH 4 and 80° C. in the presence of Fe^{III}, Eu^{III}/Gd^{III}, and H₂O₂ (Chem. Eur. J. 2012, 18, 6163-6166). In this context it has been found that a bending of the [P₈W₄₈O₁₈₄] macrocycle without ring-opening is possible; in [(RAs^{V}O)₄P^{V}₈W^{VI}₄₈O₁₈₄]³²⁻ (with R═C₆H₅ or p-(H₂N)C₆H₄) the four {RAs^{V}O} units are covalently bound to the two inner rims of the [P₈W₄₈O₁₈₄] wheel through As—O—W bonds, wherein the bending of the [P₈W₄₈O₁₈₄] macrocycle occurs due to the presence of short As—O bonds (Inorg. Chem. 2017, 56, 13822-13828).

[K⊂P₈W₄₈O₁₈₄(H₄W₄O₁₂)₂Ln₂(H₂O)₁₀]¹³⁻ (with Ln=La, Ce, Pr or Nd) was obtained by reaction of acidic aqueous solutions of the cyclic polytungstate anion [P₈W₄₈O₁₈₄]⁴⁰⁻ with early lanthanide cations under hydrothermal or conventional conditions, wherein the cavity of the original anion is occupied by Ln³⁺ cations and W₄O₁₂ groups; more precisely, the polytungstate shell rather consists of four subunits, i.e., two P₂W₁₂O₄₈ and two P₂W₁₆O₆₀ units giving a W₅₆-based shell. The new anions are linked by additional Ln³⁺ into a 3D network (Inorg. Chem. 2007, 46, 1737-1740). Owing to the different radii of the Ln and Mn ions in {[Ln₂(μ-OH)₄(H₂O)ₓ]₂(H₂₄P₈W₄₈O₁₈₄)}¹²⁻ (with Ln=Nd, Sm or Tb) and {[K(H₂O)]₈[Mn₈(H₂O)₁₆](H₄P₈W₄₈O₁₈₄)}¹²⁻, the four large Ln ions are disordered over eight positions and divided into two {Ln₂} units located on two sides of the cavity of the [P₈W₄₈O₁₈₄] wheel, whereas the eight small manganese ions bond to the inside of the [P₈W₄₈O₁₈₄] wheel (Eur. J. Inorg. Chem. 2013, 1693-1698).

The synthesis of a corresponding Ru derivative starting from the [H₇P₈W₄₈O₁₈₄]³³⁻ template was only accomplished by using additional organic ligands. The reaction of [Ru(p-cymene)Cl₂]₂ with [H₇P₈W₄₈O₁₈₄]³³⁻ in aqueous acidic medium results in the organometallic derivative [{K(H₂O)}₃ {Ru(p-cymene)(H₂O)}₄P₈W₄₉O₁₈₆(H₂O)₂]²⁷⁻ having in addition to the four {Ru(p-cymene)(H₂O)} units, an additional WO₆ unit resulting in a P₈W₄₉-shell unit. Each Ru atom coordinates 3 O atoms in addition to the aromatic cymene unit (Dalton Trans. 2007, 2627-2630 and Eur. J. Inorg. Chem. 2010, 3195-3200).

Recently a post-transition metal-containing representative has been prepared based on the [H₇P₈W₄₈O₁₈₄]³³⁻ template. In [K_{4.5}⊂(ClSn)₈P₈W₄₈O₁₈₄]^{17.5-} all eight Sn²⁺ ions are incorporated into the inner cavity of the cyclic {P₈W₄₈O₁₈₄} unit, in particular having eight {ClSn} groups, with each Sn²⁺ ion in trigonal pyramidal geometry and the chloride ligand pointing towards the center of the cavity (Dalton Trans. 2015, 41, 19200-19206).

However, the main focus on [H₇P₈W₄₈O₁₈₄]³³⁻-based POMS clearly lies on early and/or light transition metal atoms. In this context, [Co₄(H₂O)₁₆P₈W₄₈O₁₈₄]³²⁻; [Mn₄(H₂O)₁₆P₈W₄₈O₁₈₄(WO₂(H₂O)₂)₂]²⁸⁻; [Ni₄(H₂O)₁₆P₈W₄₈O₁₈₄(WO₂(H₂O)₂)₂]²⁸⁻; and [(VO₂)₄(P₈W₄₈O₁₈₄)]³⁶⁻ have been synthesized in aqueous-acidic medium from the precursor [H₇P₈W₄₈O₁₈₄]³³⁻ using one-pot reactions. Each of the Co, Mn, and Ni ions is coordinated to 6 oxygen atoms while the V ion is coordinated to 4 oxygen atoms. The Co and V analogues have the common [P₈W₄₈O₁₈₄] wheel while the Mn and Ni analogues have framework structures containing two additional W atoms resulting in P₈W₅₀-shell units (Inorg. Chem. 2010, 49, 4949-4959). In this context, differences in electrochemical properties of [P₈W₄₈O₁₈₄Fe₁₆(OH)₂₈(H₂O)₄]²⁰⁻; [Co₄(H₂O)₁₆P₈W₄₈O₁₈₄]³²⁻; and [Ni₄(H₂O)₁₆P₈W₄₈O₁₈₄(WO₂(H₂O)₂)₂]²⁸⁻ were studied with respect to their electrocatalytic performances (Electrochimica Acta 2015, 176, 1248-1255).

The V-containing representative [K₈⊂{V^{V}₄V^{IV}₂O₁₂(H₂O)₂}₂{P₈W₄₈O₁₈₄}]²⁴⁻ contains linked vanadium oxide cavity-capping groups based on two octahedra and four tetrahedra with V^{IV} and V^{V} centers, respectively (Angew. Chem. Int. Ed. 2007, 46, 4477-4480).

LiK₁₄Na₉[P₈W₄₈O₁₈₄Cu₂₀(N₃)₆(OH)₁₈]·60H₂O contains two {Cu₅(OH)₄}⁶⁺ and two {Cu₅(OH)₂(μ_{1,1,3,3}-N₃)}⁷⁺ subunits, wherein each of the five Cull ions in each subunit forms a square pyramid with two μ₃-hydroxo ligands connecting the apical Cull center to the four basal copper cations (Inorg. Chem. 2007, 46, 5292-5301).

[{Co₁₀(H₂O)₃₄(P₈W₄₈O₁₈₄)}]²⁰⁻ and [{Co₁₀(H₂O)₄₄(P₈W₄₈O₁₈₄)}]²⁰⁻ have six Co atoms in the central cavity and four external cobalt(II) ions linking adjacent polyanions resulting in 1D chains and 3D networks, respectively (Cryst. Eng. Commun. 2009, 11, 36-39).

In Na₈Li₈CO₅[CO_{5.5}(H₂O)₁₉P₈W_{48.5}O₁₈₄]·60 H₂O, K₂Na₄Li₁₁Co₅[Co₇(H₂O)₂₈P₈W₄₈O₁₈₄]Cl·59H₂O, and K₂Na₄LiCo₁₁[Co₈(H₂O)₃₂P₈W₄₈O₁₈₄](CH₃COO)₄Cl·47H₂O the cyclic cavity of the polyanion accommodates 5.5, 7, and 8 cobalt ions, respectively, with external cobalt-containing units linking adjacent [P₈W₄₈O₁₈₄] wheel units resulting in 2D networks and 3D networks (Chem-Asian J. 2014, 9, 470-478).

In [Mn₈(H₂O)₄₈P₈W₄₈O₁₈₄]²⁴⁻ the 8 manganese atoms are linking the outer edges of adjacent [P₈W₄₈O₁₈₄] wheel units, whereas the cavity is free of heavy metal atoms and, in addition to solvent water molecules, contains only the alkali-metal K and Li cations, which may be replaced by copper ions upon addition of copper nitrate (Nat. Chem. 2010, 2, 308-312). In the related derivatives [Mn₁₄(H₂O)₃₀P₈W₄₈O₁₈₄]¹²⁻ and [Mn₁₄(H₂O)₂₆P₈W₄₈O₁₈₄]¹²⁻, 12 manganese atoms are located on the outer edges linking adjacent [P₈W₄₈O₁₈₄] wheel units whereas 2 manganese atoms are located within the wheel unit (Inorg. Chem. 2011, 50, 136-143).

In [Mn₈(H₂O)₂₆(P₈W₄₈O₁₈₄)]²⁴⁻ and [Mn₆(H₂O)₂₂(P₈W₄₈O₁₈₄){WO₂(H₂O)₂}_{1.5}]²⁵⁻ four and six Mn^{II} centers are located inside the [P₈W₄₈O₁₈₄] cavity, respectively, while two other Mn^{II} centers are coordinated to the outer rim (J. Mol. Struct. 2011, 994, 104-108).

[{P₈W₄₈O₁₈₄}{Mo^{VI}O₂}₄{(H₂O)(O═)Mo^{V}(μ₂-O)₂(O═)Mo^{V}(μ₂-H₂O)(μ₂-O)₂Mo^{V}(═O)(μ₂-O)₂Mo^{V}(═O)(H₂O)}₂]³²⁻ has two neutral tetranuclear {Mo^{V}₄O₁₀(H₂O)₃} aggregates acting as handles and four {Mo^{VI}O₂}²⁺ units connected to the [P₈W₄₈O₁₈₄] ring via Mo—O—W bonds, wherein the {Mo^{V}₄O₁₀(H₂O)₃} unit contains two diamagnetic {Mo^{V}₂O₄}²⁺-type units (Chem. Commun. 2009, 7491-7493). The related derivatives [K₄ {Mo₄O₄S₄(H₂O)₃(OH)₂}₂(WO₂)(P₈W₄₈O₁₈₄)]³⁰⁻ and [{Mo₄O₄S₄(H₂O)₃(OH)₂}₂(P₈W₄₈O₁₈₄)]³⁶⁻ have two disordered {Mo₄O₄S₄(H₂O)₃(OH)₂}²⁺ “handles” connected on both sides of the [P₈W₄₈O₁₈₄] ring with internal alkali cations (Inorg. Chem. 2012, 51, 2349-2358).

Also outside the above [P₈W₄₈O₁₈₄]-based class of metal-oxo clusters, there have been increasing efforts towards the modification of metal-oxo clusters, in particular POMs, with various organic and/or transition metal complex moieties, in general, with the aim of generating new catalyst systems as well as functional materials with interesting optical, electronic, magnetic and medicinal properties. In particular, transition metal-substituted POMs (TMSPs) have attracted continuously growing attention as they can be rationally modified on the molecular level including size, shape, charge density, acidity, redox states, stability, solubility etc.

For example, U.S. Pat. No. 4,864,041 demonstrates the general potential of POMs as catalysts for the oxidation of organic compounds. A variety of different POMs with different metal species was investigated, including those with W, Mo, V, Cu, Mn, Fe, Fe and Co.

WO 2010/021600 A1 discloses a method for preparing POMs and reducing them. Thus, for example metallic nanoparticles can be prepared.

As is already evident from the above discussion on the [P₈W₄₈O₁₈₄]-based class of metal-oxo clusters to date many 3d transition metal-containing metal-oxo clusters, in particular POMs, are known, but still only a minority of them contains 4d and 5d metals. However, the introduction of 4d and 5d metals, especially of late 4d and 5d metals, in a metal-oxo cluster would be of fundamental interest en route to new, more efficient and more selective catalysts. Especially Rh, Ir, Pd, Pt, Ag and/or Au-containing metal-oxo clusters would be of high interest, because they are expected to be thermally and oxidatively stable and to possess highly attractive catalytic properties.

Two reviews on POMs containing late transition metals and noble metals (Coord. Chem. Rev. 2011, 255, 1642-1685 and Angew. Chem. Int. Ed. 2012, 51, 9492-9510) reveal that, although there is a noticeable development in this area in recent years, the number and variety, in particular of Rh, Ir, Pd, Pt, Ag and/or Au-containing POMs, is still limited. This is not surprising as Rh, Ir, Pd, Pt, Ag and/or Au suffer from an intrinsic lack of reactivity when it comes to the formation of metal-oxo clusters, such as POMs, as these late transition metals are far less reactive, in particular in the formation of bonds to oxygen, as compared to early transition metals. This is in accordance with the Pearson acid-base concept as Rh, Ir, Pd, Pt, Ag and/or Au form soft Lewis acids whereas oxygen forms a strong Lewis base. This intrinsic lack of reactivity of Rh, Ir, Pd, Pt, Ag and/or Au in the preparation of POMs is also evident from the above discussion on the [P₈W₄₈O₁₈₄]-based class of POMs; although this class of POMS has been studied extensively, none of the [H₇P₈W₄₈O₁₈₄]³³⁻ template-based POMs discussed above contains any of Rh, Ir, Pd, Pt, Ag and/or Au. In 2018, one Pd-containing tungsto-arsenate-based POM has been reported (Z. Anorg. Allg. Chem. 2018, 644, 1379-1382).

However, for other metal-oxo cluster subclasses, in particular other POM subclasses, in recent years, first Rh, Ir, Pd, Pt, Ag and/or Au-containing POMs have been prepared. For example, Kortz and coworkers have found [Pd₇V₆O₂₄(OH)₂]⁶⁻ containing compounds being stable in the solid state and after redissolution when exposed to air and light (Angew. Chem. Int. Ed. 2010, 49, 7807-7811).

In other POMs it was possible to incorporate minor proportions of noble metal atoms, based on the overall metal content of the POM framework. For example, Cronin and coworkers found three Pd-containing POMs K₂₈[H₁₂Pd₀Se₁₀W₅₂O₂₀₆], K₂₆[H₁₄Pd₁₀Se₁₀W₅₂O₂₀₆] and Na₄₀[Pd₆Te₁₉W₄₂O₁₉₀] demonstrating the structural complexity of some of the late transition metal-containing POMs (Inorg. Chem. Front. 2014, 1, 178-185). Furthermore, Cronin and coworkers studied the self-assembly based formation of nanostructures containing high Pd contents using phosphate and acetate ligands; the resulting wheel-shaped POMs are limited to very specific numbers of Pd atoms (Angew. Chem. Int. Ed. 2014, 53, 10032-10037; Proceedings of National Academy of Sciences 2012, 109, 11609-11612; Angew. Chem. Int. Ed. 2016, 55, 12741-12745).

WO 2007/142729 A1 discloses a class of Pd and W as well as Pt and W-based POMs and mixtures thereof with the general formula [M_{y}(H₂O)(p·y)X₂W₂₂O₇₄(OH)₂]^{m-} with M being Pd, Pt, and mixtures thereof, y being 1 to 4, p being the number of water molecules bound to one M and being 3 to 5 and X being Sb, Bi, As, Se and Te. Protocols for the preparation of these POMs were provided. Furthermore, the POMs were found to be useful as catalysts.

WO 2008/089065 A1 discloses a class of W-based POMs including late transition metals with the formula [M_{y}(H₂O)ₚX_{z}Z₂W₁₈O₆₆]^{m-} with M being Cu, Zn, Pd and Pt, X being selected from the group of halides and Z being Sb, Bi, As, Se and Te. The POMs prepared are useful as catalysts.

WO 2007/142727 A1 discloses a class of transition metal-based POMs including W having the formula [M₄(H₂O)₁₀(XW₉O₃₃)₂]^{m-} with M being a transition metal and X being selected from As, Sb, Bi, Se and Te. These POMs are particularly useful as catalysts featuring high levels of conversion in selective alkane oxidation.

US 2005/0112055 A1 discloses a POM including three different transition metals Ru, Zn and W with the formula Na₁₄[Ru₂Zn₂(H₂O)₂(ZnW₉O₃₄)₂]. This particular POM was found to be highly efficient as an electrocatalyst in the generation of oxygen.

WO 2007/139616 A1 discloses a class of W-based POMs including Ru with the formula [Ru₂(H₂O)₆X₂W₂₀O₇₀]^{m-} with X being selected from Sb, Bi, As, Se, and Te. Protocols for the preparation of these POMs are described. Furthermore, the POMs were found to be useful as catalysts.

WO 2009/155185 A1 discloses a class of Ru and W-based POMs provided by the general formula [Ru₂L₂(XW₁₁O₃₉)₂WO₂]^{m-} with L being a ligand and X being Si, Ge, B and mixtures thereof. The POMs are useful as catalysts and precursors for the preparation of mixed metal-oxide catalysts.

In pursuit of noble metal-rich metal-oxo cluster frameworks, such as POM frameworks, having a significantly higher noble metal-content as compared to previously known noble metal atom-containing metal-oxo clusters, i.e., metal-oxo cluster frameworks containing a major proportion of noble metal atoms based on the overall metal content of said metal-oxo cluster frameworks, Kortz and coworkers prepared the star-shaped polyoxo-15-palladate(II) [Pd_{0.4}Na_{0.6}⊂Pd₁₅P₁₀H₅₀H_{6.6}]¹²⁻ (Dalton Trans. 2009, 9385-9387), the double-cuboid-shaped copper(II)-containing polyoxo-22-palladate(II) [Cu^{II}₂Pd^{II}₂₂P^{V}₁₂O₆₀(OH)₈]²⁰⁻ comprising two {CuPd₁₁} fragments (Angew. Chem. Int. Ed. 2011, 50, 2639-2642), and the polyoxo-22-palladate [Na₂Pd^{II}₂₂O₁₂ (As^{V} O₄)₁₅(As^{V}O₃OH)]²⁵⁻ comprising two {NaPd₁₁} units (Dalton Trans. 2016, 45, 2394-2398).

In 2008, Kortz and coworkers reported the first representative of a new and highly promising class of noble metal-rich POMs, i.e., the molecular palladium-oxo polyanion [Pd₁₃As₈O₃₄(OH)₆]⁸⁻ (Angew. Chem. Int. Ed. 2008, 47, 9542-9546). Twelve palladium atoms surround the thirteenth, the central palladium atom, resulting in a distorted icosahedral arrangement {PdPd₁₂O₈}. Each oxygen atom of the ‘inner’ PdO₈ fragment is coordinated by the central Pd atom and by three ‘external’ palladiums being situated on a trigonal face of a cuboctahedron. In 2009, two further representatives of said class of POMs have been reported, the discrete anionic PhAsO₃H₂- and SeO₂-derived palladium(II)-oxo clusters [Pd₁₃(As^{V}Ph)₈O₃₂]⁶⁻ and [Pd₁₃Se^{IV}₈O₃₂]⁶⁻ (Inorg. Chem. 2009, 48, 7504-7506).

In US 2009/0216052 A1 closely related POM analogues are disclosed based on this common structural motif comprising [M₁₃X₈R_{q}O_{y}]^{m-} with M being selected from Pd, Pt, Au, Rh, Ir, and mixtures thereof, while X is a heteroatom such as As, Sb, Bi, P, Si, Ge, B, Al, Ga, S, Se, Te, and mixtures thereof. These POMs in general were demonstrated to be promising candidates for the further development of useful catalysts and precursors for mixed metal-oxide catalysts and metal clusters (also referred to as metal-clusters).

Kortz and coworkers also developed a related subclass of POMs displaying a similar structural arrangement but a slightly different elemental composition. In the [MPd₁₂P₈O₄₀H_{z}]^{m-} polyanions the ‘inner’ MO₈ motif is also surrounded by twelve square-planar PdO₄ units and M is represented by Mn^{II}, Fe^{III}, Co^{II}, Cu^{II} and Zn^{II} (Chem. Eur. J. 2012, 18, 6167-6171).

Furthermore, related POMs [MO₈Pd₁₂(PO₄)₈]¹²⁻ with M being Sn^{IV} or Pb^{IV} have been reported and found to possess anticancer activity by causing oxidative stress inducing caspase activation and consecutive apoptosis of leukemic cell (Inorg. Chem. 2019, 58, 11294-11299).

In this context, Kortz and coworkers found that in the [MO₈Pd₁₂L₈]ⁿ⁻ polyanions the 8-fold coordinated guest metal ions M, which are incorporated in the cuboidal {Pd₁₂O₈L₈} shell, can be selected from Sc^{III}, Mn^{II}, Fe^{III}, Co^{II}, Ni^{II}, Cu^{II}, Zn^{II} and Lu^{III}, while L is represented by PhAsO₃²⁻, PhPO₃²⁻ or SeO₃²⁻ (Inorg. Chem. 2012, 51, 13214-13228).

Furthermore, Kortz and coworkers prepared a series of yttrium- and lanthanide-based heteropolyoxopalladate analogues containing [X^{III}Pd^{II}₁₂O₃₂(AsPh)₈]⁵⁻ cuboid units with X being selected from Y, Pr, Nd, Sm, Eu, Gd, Tb, Dy, Ho, Er, Tm, Yb, and Lu (Chem. Eur. J. 2010, 16, 9076-9085).

Additionally, Wang, Hu and coworkers disclosed the two related POMs Na₂H₃[Pd₂(μ₃—SeO₃)₈(μ₄-O)₆(μ₃-O)₂Cr]·25H₂O and Na₈H₇[Pd₁₂(μ₃-SeO₃)₈(μ₄-O)₈In]·24H₂O (Eur. J. Inorg. Chem. 2013, 3458-3463).

In 2019, the radiolabeled POMs [MO₁₀Pd₁₅(PhAsO₃)₁₀]⁸⁻ with M being ¹³³Ba and ²²⁴Ra have been reported; the M ion is centered within a {MO₁₀} moiety, in which the 10 μ₄-oxo ligands, spanning a ligand field and bridge the central guest and 15 Pd^{II} ions (Chem. Commun. 2019, 55, 7631-7634).

In 2014, Kortz and coworkers published the first fully inorganic discrete gold-palladium-oxo polyanion [NaAu₄Pd₈O₈(AsO₄)₈]¹¹⁻ without the stabilization of any organic ligands and with both Au and Pd occupying the atom positions of the metal framework. With regard to the structure, the cubic ‘NaO₈’ moiety is surrounded by 12 noble metal centers, i.e., 4 Au and 8 Pd atoms, forming the classical cuboctahedron, which is capped by eight tetrahedral arsenate groups (Chem. Eur. J. 2014, 20, 8556-8560).

In this context, it has been demonstrated that it is also possible to replace the P, As or Se-based capping groups in a respective {LaPd₁₂}-motif by the naturally occurring amino acid cysteine and thus a dodecanuclear palladium(II)-thio cluster [LaPd₁₂(C₃H₅NO₂S)₃(C₃H₆NO₂S)₂₁] is obtained (Inorg. Chem. 2016, 55, 7811-7813).

Even by replacing only two of the eight As-based capping groups in a {SrPd₁₂}-POM with acetate groups, an unusual low-symmetry open-shell structure [SrPd₁₂O₆(OH)₃(PhAsO₃)₆(OAc)₃]⁴⁻ is obtained, wherein two of the eight ‘inner’ O²⁻ ions are substituted by three OH⁻ ions and thus the central Sr atom is nine-coordinated giving an ‘inner’ SrO₆(OH)₃ motif. Furthermore, [SrPd₁₂O₆(OH)₃(PhAsO₃)₆(OAc)₃]⁴⁻ was found to be rather labile at least partially decomposing under aqueous conditions (Angew. Chem. Int. Ed. 2014, 53, 11974-11978).

In [SrPd₁₂O₆(OH)₃(PhAsO₃)₆(OAc)₃]⁴⁻, the three acetate ligands have been replaced by saturated carboxylic acids with increasing chain lengths, i.e., [SrPd₁₂O₆(OH)₃(PhAsO₃)₆(CₙH₍₂ₙ₊₁₎COO)₃]⁴⁻ with n being 2 to 5 have been prepared; the two polyanions with the longest chain lengths of 5 and 6 (i.e., n=4 and 5) are the first examples of polyoxopalladates that are soluble and stable in organic media (Chem. Eur. J. 2018, 24, 3052-3057).

All-acetatee-capped POM [InPd₁₂O₈(OAc)₁₆]⁵⁻ has been reported which may be used to form double-cube [In₂Pd₂₃O₁₇(OH)(PO₄)₁₂(PO₃OH)]²¹⁻ and monocube [InPd₁₂O₈(PO₄)₈]¹³⁻; [InPd₁₂O₈(OAc)₁₆]⁵⁻ comprises a distorted {InPd₁₂} nanocube capped by 16 acetate ligands exhibiting two different coordination modes, bidentate (eight of them) and monodentate (eight of them). The central indium(III) guest ion is coordinated by eight μ₄-O atoms forming a slightly distorted cubic {InO₈} unit, which is highly unusual for main group III elements (Inorg. Chem. 2019, 58, 15864-15871).

The catalytic performance of previously synthesized POMs [MO₈Pd₁₂L₈] and [MO₁₀Pd₁₅L₁₀] (M=Mn^{II}, Fe^{III}, Co^{II}, Ni^{II}, Cu^{II}, Zn^{II}, Pd^{II}; L=AsO₄³⁻, SeO₃²⁻, PO₄³⁻, PhAsO₃²⁻) has been studied (Inorg. Chem. 2019, 58, 5576-5582).

Based on the noble metal-containing POMs, a Polyoxo-palladate (POP)-based metal-organic framework (MOF) has been prepared comprising POP-based secondary building units (SBU) from [Pd₁₃O₈(OOC—C₆H₄—AsO₃)₈] and four Ba²⁺ ions on each of two opposite faces, wherein each SBU is linked to eight adjacent SBUs by the p-carboxyphenyl-arsonate linkers (J. Am. Chem. Soc. 2019, 141, 3385-3389).

The interaction between the [MO₈Pd₁₂(SeO₃)₈]⁶⁻ anions (with M being Zn²⁺ or Ni²⁺) and monovalent cations and the impact on their hydration shell has been studied (Chem. Eur. J. 2018, 24, 3052-3057).

As is evident from a recently published review on POPs (Acc. Chem. Res. 2018, 51, 1599-1608), known noble metal-containing metal-oxo clusters, in essence, rely on As- and P-based ligands as capping groups which are selected from the oxyacid heterogroups AsO₄³⁻ and PO₄³⁻, and the respective mono-substituted derivatives RAsO₃²⁻ and RPO₃²⁻ with R being a hydrocarbyl group, i.e., mono-substituted derivatives in which one oxygen atom has been replaced by a hydrocarbyl group. Irrespective of the presence of the mono-substitution, AsO₄³⁻ and PO₄³⁻ as well as RAsO₃²⁻ and RPO₃²⁻ are tridentate ligands.

The respective di-substituted derivatives R₂AsO₂⁻ and R₂PO₂⁻ with R being a hydrocarbyl group have been used as ligands, i.e., di-substituted derivatives in which two oxygen atoms have been replaced by hydrocarbyl groups. However, so far it was not possible to use such bidentate di-substituted derivatives in the synthesis of noble metal-containing metal-oxo clusters. So far, it was only possible to use such bidentate di-substituted oxyacid derivatives in the preparation of Mo-based POMs (Inorg. Chem. 1980, 19, 2531-2537, J. Am. Chem. Soc. 1975, 97, 4146-4147, and Bull. Chem. Soc. Jpn. 1979, 52, 3284-3291). As is evident from the above summary of the prior art, up to now, the only bidentate ligands successfully used in noble metal-containing metal-oxo clusters are carboxylate-based ligands.

This is further evidenced by the several new classes of noble metal-containing metal-oxo clusters very recently reported Kortz and coworkers, which rely on tridentate oxyacid heterogroups and carboxylates as ligands, which new classes of noble metal-containing metal-oxo clusters comprise POMs (Aₙ)^{m+}{M′ₛ[M″M₁₂X₈O_{y}R_{z}H_{q}]}^{m-} with M being Pd, Pt, Rh, Ir, Ag, and M′ being Rh, Ir, Pd, Pt, Ag, Au, Cd, Hg (WO 2017/076603 A1), (Aₙ)^{m+}{M′ₛ[M″M₁₅X₁₀O_{y}R_{z}H_{q}]}^{m-} with M being Pd, Pt, Rh, Ir, Ag, and M′ being Rh, Ir, Pd, Pt, Ag, Au, Cd, Hg (WO 2017/133898 A1), (Aₙ)^{m+}[M′M₁₂X₈O_{y}R_{z}H_{q}]^{m-} with M being Pd, Pt, Rh, Ir, Ag, and M′ being Ga, In, Tl, Ge, Sn, Pb, Sb, and Bi (WO 2018/162144 A1) and (Aₙ)^{m+}[M′M₁₂O_{y}(RCOO)_{z}H_{q}]^{m-} with M being Pd, Pt, Rh, Ir, Ag, and M′ being Li, Na, K, Mg, Ca, Sr, Sc, Ti, V, Cr, Mn, Fe, Co, Ni, Cu, Zn, Y, Zr, Ru, Rh, Pd, Ag, Cd, Lu, Hf, Re, Os, Ir, Pt, Au, Hg, lanthanide metal, Ga, In, Tl, Ge, Sn, Pb, Sb, and Bi (WO 2018/202420 A1).

However, despite this recent development in the preparation of noble metal-containing metal-oxo clusters and their highly promising catalytic activities and their exceptional potential in the development of new catalysts, representatives of the class of noble metal-containing metal-oxo clusters still suffer from several drawbacks. (i) Primarily due to the presence of the noble metal species used therein, noble metal-containing metal-oxo clusters have been shown to have catalytic activity. However, mostly, a desirable degree of activity is subject to specific conditions and under various conditions it would be desirable to enhance the catalytic activity imparted to the known noble metal-containing metal-oxo clusters by the noble metal species. Thus, in order to ensure suitable activities under different conditions it may be desirable to prepare noble metal-containing metal-oxo cluster having different properties. However, as is evident from the above summary of the prior art, most known noble metal-containing metal-oxo clusters have highly common structural features. Thus, it is particularly desirable to provide novel noble metal-containing metal-oxo clusters having increased catalytic activity, specifically under conditions not suitable for using known noble metal-containing metal-oxo clusters. (ii) More specifically, as is evident from the above summary of the prior art, known noble metal-containing metal-oxo clusters belong to the class of POMs, i.e., a molecular entity or framework bearing a negative charge which is balanced by cations that are external to the entity or framework. These structural features largely determine the properties of the known noble metal-containing metal-oxo clusters. These properties may be beneficial for some applications. However, for other applications the properties imparted by their common structural features render the known noble metal-containing metal-oxo clusters unsuitable. In particular, in view of their above-indicated common properties, specific conditions might lead to increased degradation and/or deactivation of known noble metal-containing metal-oxo clusters (i.e., noble metal-containing POMs) by, e.g., shielding of active sites. Thus, in order to extend the scope of their potential applications, it is particularly desirable to provide noble metal-containing metal-oxo clusters having a unique combination of (i) exceptionally high catalytic activity and (ii) exceptionally high versatility. In particular, noble metal-containing metal-oxo clusters are desired whose properties may be fine-tuned for specific applications not accessible by using known noble metal-containing metal-oxo clusters (i.e., noble metal-containing POMs).

Thus, there is a need for new and improved noble metal-oxo clusters containing a noble metal centers showing useful properties in homogeneous or heterogeneous catalytic applications. In this regard, particularly those noble metal-oxo clusters which solely contain one type of noble metal, i.e., which do contain solely one specific noble metal species, and those which contain more than one different type of noble metal atom species and in particular those noble metal-oxo clusters which have properties allowing for broad applicability and contain a well-defined noble metal core having a significant content of noble metal atoms, based on the overall metal content of said metal-oxo clusters, are highly promising candidates en route to new, more efficient and more selective catalysts due to the well-established unique catalytic properties of noble metals.

Therefore, it is an object of the present invention to provide noble metal-oxo clusters containing inter alia noble metal atoms. Furthermore, it is an object of the present invention to provide one or multiple processes for the preparation of said noble metal-oxo clusters. In addition, it is an object of the present invention to provide supported noble metal-oxo clusters containing inter alia noble metal atoms as well as one or multiple processes for the preparation of said supported noble metal-oxo clusters. Another object of the present invention is the provision of metal cluster units, in particular the provision of highly dispersed metal cluster unit particles, and processes for the preparation of said metal cluster units either in the form of a dispersion in a liquid carrier medium or in supported form, immobilized on a solid support. Finally, it is an object of the present invention to provide one or multiple processes for the homogeneous or heterogeneous conversion of organic substrate using said optionally supported noble metal-oxo cluster(s) and/or said optionally supported or dispersed metal cluster unit(s).

### SUMMARY OF THE INVENTION

An objective of the present invention among others is achieved by the provision of noble metal-oxo clusters represented by the formula

[Mₛ(R₂XO₂)_{z}(OR′)ₓO_{y}X′_{q}]

or solvates thereof, wherein
each M is independently selected from the group consisting of Pd, Pt, Rh, Ir, Ag and Au, and each M has d⁸ valence electron configuration,
each R is independently selected from the group consisting of hydrogen and substituted or unsubstituted hydrocarbyl, wherein each hydrocarbyl provides a carbon atom for coordination to X and wherein preferably no more than one R is hydrogen per (R₂XO₂) group,
each X is independently selected from the group consisting of P and As,
each R′ is independently selected from the group consisting of a proton or a monovalent cation,
each X′ is independently selected from the group consisting of monovalent anions,
s is a number from 8 to 96,
z is a number from 8 to 96,
x is a number from 2 to 48,
y is a number from 2 to 48, and
q is a number from 0 to 46,
with the proviso that x+q≤48.

An objective of the present invention among others is achieved by the provision of a process for the preparation of any one of the noble metal-oxo clusters provided by the present invention, said process comprising:
(a) reacting at least one source of M and at least one source of R₂XO₂ and optionally at least one source of X′ to form a noble metal-oxo cluster [Mₛ(R₂XO₂)_{z}(OR′)ₓO_{y}X′_{q}] or a solvate thereof,
(b) optionally adding at least one source of A to the reaction mixture of step (a) to form a noble metal-oxo cluster [Mₛ(R₂XO₂)_{z}(OR′)ₓO_{y}X′_{q}] or a solvate thereof with neutral entities A being attracted to the noble metal-oxo cluster [Mₛ(R₂XO₂)_{z}(OR′)ₓO_{y}X′_{q}] or a solvate thereof, and
(c) recovering the noble metal-oxo cluster or solvate thereof.

An objective of the present invention among others is achieved by the provision of supported noble metal-oxo clusters comprising any one of the noble metal-oxo clusters provided by the present invention or prepared according to the present invention, on a solid support.

An objective of the present invention among others is achieved by the provision of a process for the preparation of the supported noble metal-oxo clusters provided by the present invention, said process comprising the step of contacting any one of the noble metal-oxo clusters provided by the present invention or prepared according to the present invention, with a solid support.

An objective of the present invention among others is achieved by the provision of metal cluster units of the formula

[M⁰ₛ],

wherein
each M⁰ is independently selected from the group consisting of Pd⁰, Pt⁰, Rh⁰, Ir⁰, Ag⁰, and Au⁰, and
s is a number from 8 to 96.

An objective of the present invention among others is achieved by the provision of the metal cluster units provided by the present invention in the form of a dispersion in a liquid carrier medium.

An objective of the present invention among others is achieved by the provision of supported metal cluster units comprising any one of the metal cluster units provided by the present invention immobilized on a solid support.

An objective of the present invention among others is achieved by the provision of a process for the preparation of any one of the metal cluster units provided by the present invention, in the form of a dispersion of said metal cluster units dispersed in a liquid carrier medium, said process comprising the steps of
(a) dissolving any one of the noble metal-oxo clusters provided by the present invention or prepared according to the present invention in a liquid carrier medium,
(b) optionally providing additive means to prevent agglomeration of the metal cluster units to be prepared, and
(c) subjecting the dissolved noble metal-oxo cluster to chemical or electrochemical reducing conditions sufficient to at least partially reduce said noble metal-oxo cluster into corresponding metal cluster units.

An objective of the present invention among others is achieved by the provision of a process for the preparation of supported metal cluster units, i.e., any one of the metal cluster units provided by the present invention, in the form of metal cluster units immobilized on a solid support, said process comprising the steps of
(a) contacting the dispersion of metal cluster units provided by the present invention or prepared according to the present invention, with a solid support, thereby immobilizing at least part of the dispersed metal cluster units onto the support and obtaining supported metal cluster units; and
(b) optionally isolating the supported metal cluster units.

An objective of the present invention among others is achieved by the provision of a process for the preparation of supported metal cluster units, i.e., any one of the metal cluster units provided by the present invention, in the form of metal cluster units immobilized on a solid support, said process comprising the steps on
(a) subjecting any one of the supported noble metal-oxo cluster provided by the present invention or prepared according to the present invention to chemical or electrochemical reducing conditions sufficient to at least partially reduce said noble metal-oxo cluster into corresponding metal cluster units provided by the present invention; and
(b) optionally isolating the supported metal cluster units.

An objective of the present invention among others is achieved by the provision of a process for the homogeneous or heterogeneous conversion of organic substrate.

In the context of the present invention the term noble metal comprises the following elements: Rh, Ir, Pd, Pt, Ag, and Au.

With regard to the present invention the expressions Group 1, Group 2, Group 3 etc. refer to the Periodic Table of the Elements and the expressions 3d, 4d and 5d metals refer to transition metals of respective Periods 4, 5 and 6 of the Periodic Table of the Elements, i.e., the 4d metal in Group 10 is Pd.

With regard to the present invention the term noble metal-oxo cluster describes the structural arrangement [Mₛ(R₂XO₂)_{z}(OR′)ₓO_{y}X′_{q}].

With regard to the present invention the term protonated noble metal-oxo cluster describes the structural arrangement [Mₛ(R₂XO₂)_{z}(OH)ₓO_{y}X′_{q}], i.e., the structural arrangement [Mₛ(R₂XO₂)_{z}(OR′)ₓO_{y}X′_{q}] with each R′ being a proton.

With regard to the present invention the term deprotonated noble metal-oxo cluster describes the structural arrangement [Mₛ(R₂XO₂)_{z}(OR′)ₓO_{y}X′_{q}], wherein at least one R′ is not a proton. With regard to the present invention the term deprotonated noble metal-oxo cluster encompasses partially deprotonated noble metal-oxo clusters as well as fully deprotonated noble metal-oxo clusters.

With regard to the present invention the term partially deprotonated noble metal-oxo cluster describes the structural arrangement [Mₛ(R₂XO₂)_{z}(OR′)ₓO_{y}X′_{q}], wherein at least one 1^{st} R′ is not a proton and at least one 2^{nd} R′ is a proton. With regard to the present invention the term fully deprotonated noble metal-oxo cluster describes the structural arrangement [Mₛ(R₂XO₂)_{z}(OR′)ₓO_{y}X′_{q}], wherein no R′ is a proton.

With regard to the present invention the term noble metal core unit describes the structural arrangement of the s M atoms, i.e., the Mₛ unit, in the noble metal-oxo cluster [Mₛ(R₂XO₂)_{z}(OR′)ₓO_{y}X′_{q}].

With regard to the present invention the term capping group describes ligands that coordinate the outer noble metal atoms M of the noble metal core unit. Within the noble metal-oxo cluster [Mₛ(R₂XO₂)_{z}(OR′)ₓO_{y}X′_{q}] the (R₂XO₂) groups represent the capping groups.

With regard to the present invention the term peripheral noble metal atom describes the noble metal atoms M within the noble metal-oxo cluster [Mₛ(R₂XO₂)_{z}(OR′)ₓO_{y}X′_{q}] which are coordinated by a capping group.

With regard to the present invention the term noble metal M₈ ring unit describes a ring-shaped structural arrangement of 8 noble metal atoms M within the centre of the noble metal core unit.

With regard to the present invention the term inner noble metal M₄ ring unit describes a ring-shaped structural arrangement of 4 noble metal atoms M which is directly linked to the noble metal M₈ ring unit within the noble metal core unit.

With regard to the present invention the term outer noble metal M₄ ring unit describes a ring-shaped structural arrangement of 4 noble metal atoms M which is directly linked to the inner noble metal M₄ ring unit within the noble metal core unit and, thus, indirectly linked to the noble metal M₈ ring unit within the noble metal core unit via the linkage to the inner noble metal M₄ ring unit within the noble metal core unit. With regard to the present invention the term noble metal M₄-M₄ double ring unit describes the structural arrangement of one inner noble metal M₄ ring unit and one outer noble metal M₄ ring unit, wherein the inner noble metal M₄ ring unit and the outer noble metal M₄ ring unit are connected to each other.

With regard to the present invention the term noble metal M₂₄ ring unit describes a ring-shaped structural arrangement of 24 noble metal atoms M which surrounds and is directly linked to the noble metal M₈ ring unit within the noble metal core unit.

With regard to the present invention the term metal cluster unit describes the structural arrangement [M⁰ₛ].

With regard to the present invention the term immobilizing means to render immobile or to fix the position. In the context of a solid support the term immobilizing describes the adhesion to a surface by means of adsorption, including physisorption and chemisorption. Adsorption is based on interactions between the material to be adsorbed and the surface of the solid support such as van-der-Waals interactions, hydrogen-bonding interactions, ionic interactions, etc.

With regard to the present invention the term supported noble metal-oxo cluster unit describes noble metal-oxo clusters immobilized on a solid support.

With regard to the present invention the term supported metal cluster unit describes metal cluster units immobilized on a solid support.

With regard to the present invention the term metal cluster describes compounds having three or more metals and featuring significant metal-metal interactions, wherein the metal-metal interactions may be present in the form of direct metal-metal bonds, in which one metal atom is bond directly to another metal atom without a bridging group, and/or indirect metal-metal bonds, in which one metal atom is bond indirectly to another metal atom via a bridging group. With regard to the present invention the term supported metal cluster describes metal clusters immobilized on a solid support.

With regard to the present invention the expression primary particles of noble metal-oxo cluster or noble metal-oxo cluster primary particles describes isolated particles that contain exactly one noble metal-oxo cluster [Mₛ(R₂XO₂)_{z}(OR′)ₓO_{y}X′_{q}]. The noble metal-oxo cluster primary particles of the present invention are substantially mono-dispersed particles, i.e., the noble metal-oxo cluster primary particles have a uniform size, corresponding to the size of one noble metal-oxo cluster [Mₛ(R₂XO₂)_{z}(OR′)ₓO_{y}X′_{q}]. The expression noble metal-oxo cluster secondary particles describes agglomerates of noble metal-oxo cluster primary particles. With regard to the present invention the expression primary particles of metal cluster unit or metal cluster unit primary particles describes isolated particles that contain exactly one metal cluster unit M⁰ₛ. The metal cluster unit primary particles of the present invention are substantially mono-dispersed particles, i.e. the metal cluster unit primary particles have a substantially uniform size, corresponding to the size of one metal cluster unit. The expression metal cluster unit secondary particles describes agglomerates of metal cluster unit primary particles.

The particle size of the non-aggregated and aggregated noble metal-oxo clusters, and of the non-aggregated and aggregated metal cluster units, respectively, can be determined by various physical methods known in the art. If the particles are dispersed in a liquid medium, the particle size can be determined by light scattering. If the particles are supported on a solid support, solid state techniques are required for determining the particle size of the supported particles, and to distinguish between primary particles (non-aggregated) and secondary particles (aggregated). Suitable solid state techniques include scanning electron microscopy (SEM), transmission electron microscopy (TEM), powder X-ray diffraction or crystallography (powder XRD), etc. Another suitable technique for determining the particle size is pulsed chemi-/physisorption.

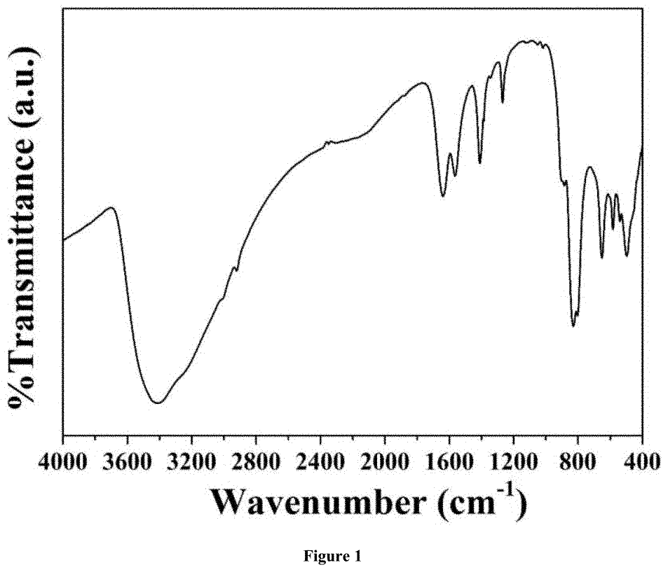

### BRIEF DESCRIPTION OF THE FIGS. 1-15

FIG. 1: Fourier Transform Infrared (FT-IR) spectrum of [Pd₁₆{(CH₃)₂AsO₂}₈(μ₂-OH)₈(μ₄-O)₈]·{Na(CH₃)₂AsO₂}·0.25{Na(CH₃COO)}·19H₂O (“Pd₁₆{(CH₃)₂AsO₂}₈”) from 4000 cm⁻¹ to 400 cm⁻¹.

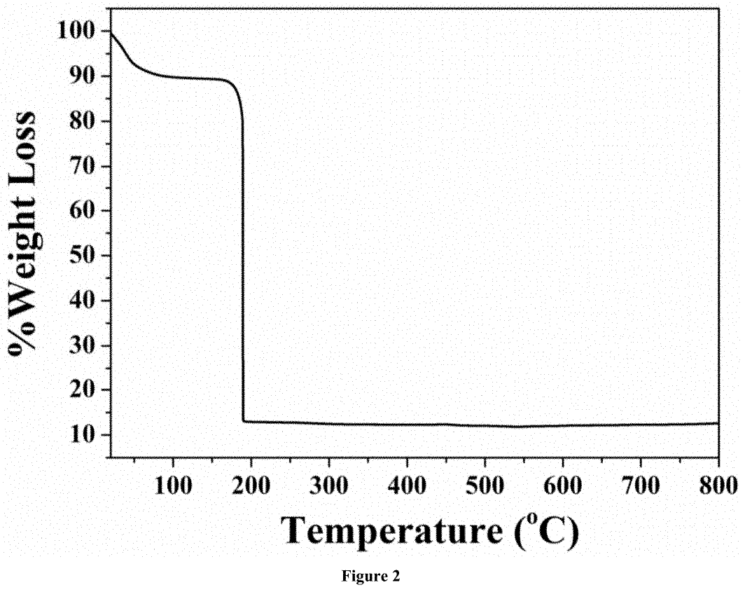

FIG. 2: Thermogravimetric analysis (TGA) curve of [Pd₁₆{(CH₃)₂AsO₂}₈(μ₂-OH)₈(μ₄-O)₈]·{Na(CH₃)₂AsO₂}·0.25{Na(CH₃COO)}·19H₂O (“Pd₁₆{(CH₃)₂AsO₂}₈”) from 20° C. to 800° C.

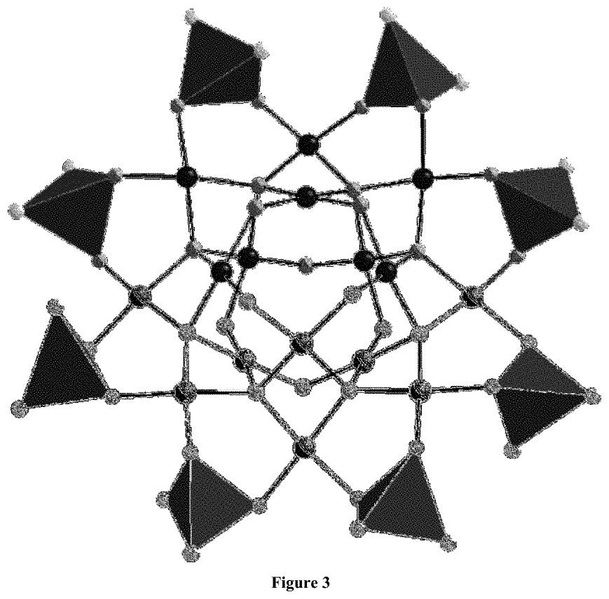

FIG. 3: Ball-and-stick representation of the [Pd₁₆{(CH₃)₂AsO₂}₈(μ₂-OH)₈(μ₄-O)₈] cluster of [Pd₁₆{(CH₃)₂AsO₂}₈(μ₂-OH)₈(μ₄-O)₈]·{Na(CH₃)₂AsO₂}·0.25{Na(CH₃COO)}·19H₂O (“Pd₁₆{(CH₃)₂AsO₂}₈”). Legend: Pd, black spheres; O, dark gray spheres; C, light gray spheres; cacodylates, black polyhedra.

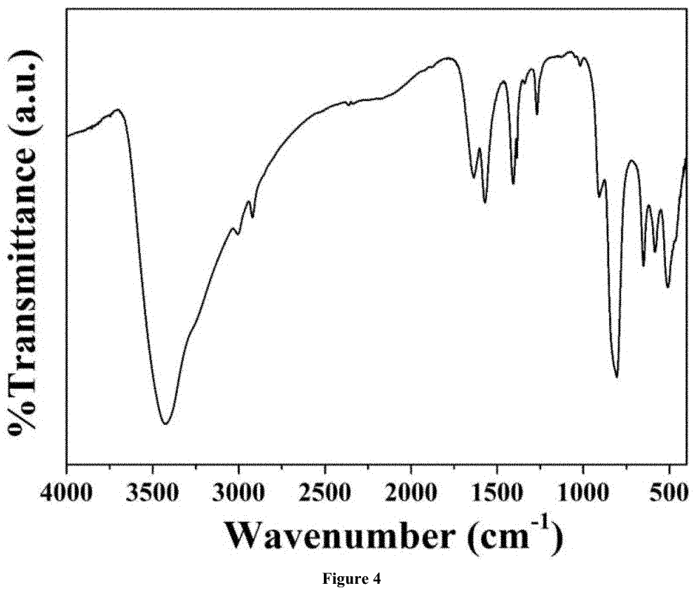

FIG. 4: Fourier Transform Infrared (FT-IR) spectrum of [Pd₂₄{(CH₃)₂AsO₂}₁₆(μ₂-OH)₈(μ₄-O)₁₂]·3{Na(CH₃)₂AsO₂}·2{Na(CH₃COO)}·35H₂O (“Pd₂₄{(CH₃)₂AsO₂}₁₆”) from 4000 cm⁻¹ to 400 cm⁻¹.

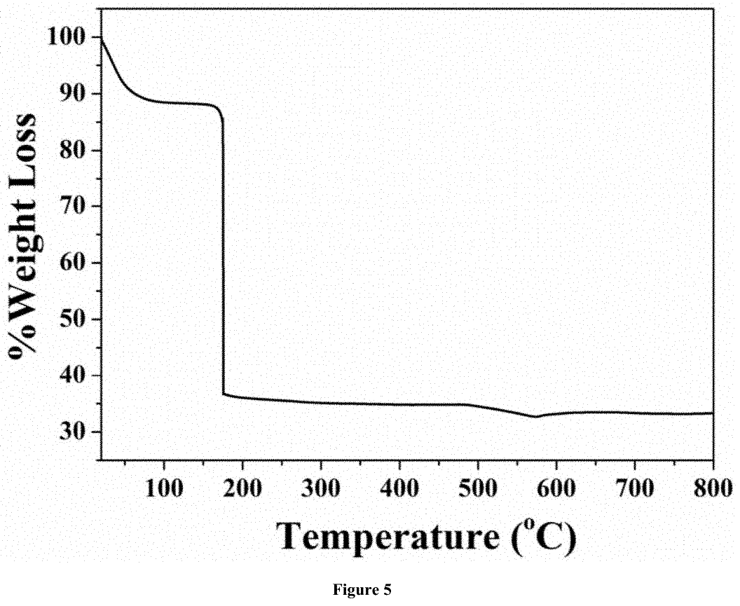

FIG. 5: Thermogravimetric analysis (TGA) curve of [Pd₂₄{(CH₃)₂AsO₂}₁₆(μ₂-OH)₈(μ₄-O)₁₂]·3{Na(CH₃)₂AsO₂}·2{Na(CH₃COO)}·35H₂O (“Pd₂₄{(CH₃)₂AsO₂}₁₆”) from 20° C. to 800° C.

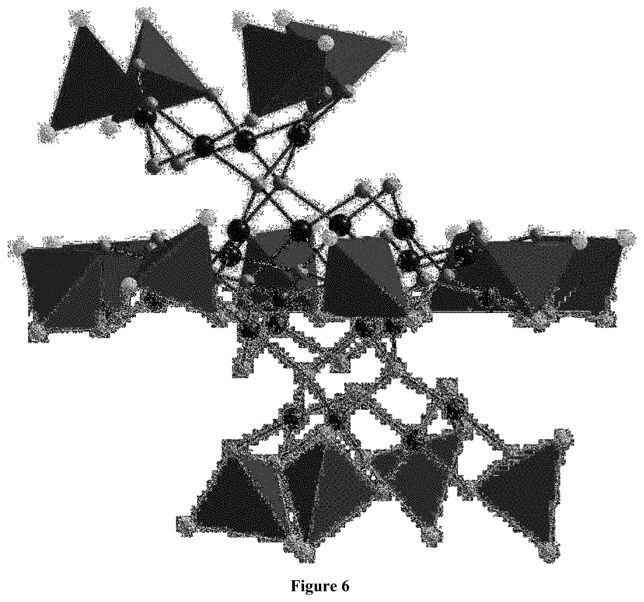

FIG. 6: Ball-and-stick representation of the [Pd₂₄{(CH₃)₂AsO₂}₁₆(μ₂-OH)₈(μ₄-O)₁₂] cluster of [Pd₂₄{(CH₃)₂AsO₂}₁₆(μ₂-OH)₈(μ₄-O)₁₂]·3{Na(CH₃)₂AsO₂}·2{Na(CH₃COO)}·35H₂O (“Pd₂₄{(CH₃)₂AsO₂}₁₆”). Legend: Pd, black spheres; O, dark gray spheres; C, light gray spheres; cacodylates, black polyhedra.

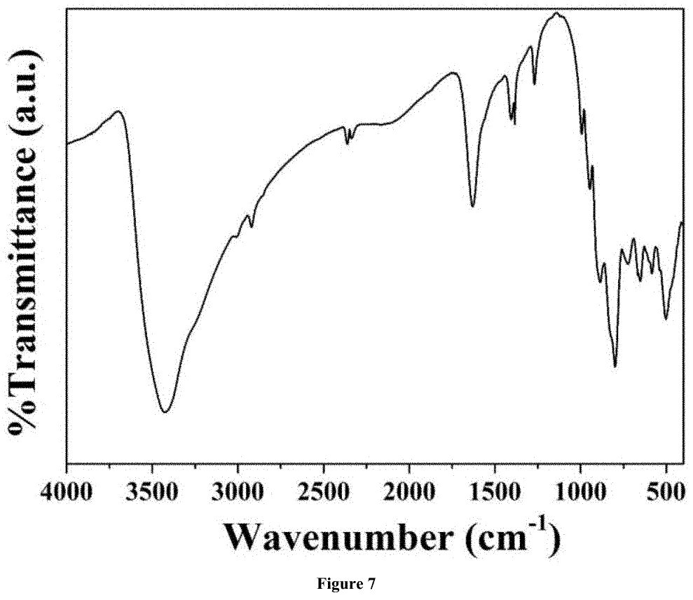

FIG. 7: Fourier Transform Infrared (FT-IR) spectrum of [Pd₄₀{(CH₃)₂AsO₂}₁₆(μ₂-OH)₈(μ₂-ONa)₈(μ₄-O)₂₄]·1.5{Na₄(SiW₁₂O₄₀)}·2{Na(CH₃)₂AsO₂}·2{Na(CH₃COO)}·135H₂O (“Pd₄₀{(CH₃)₂AsO₂}₁₆—SiW₁₂O₄₀”) from 4000 cm⁻¹ to 400 cm⁻¹.

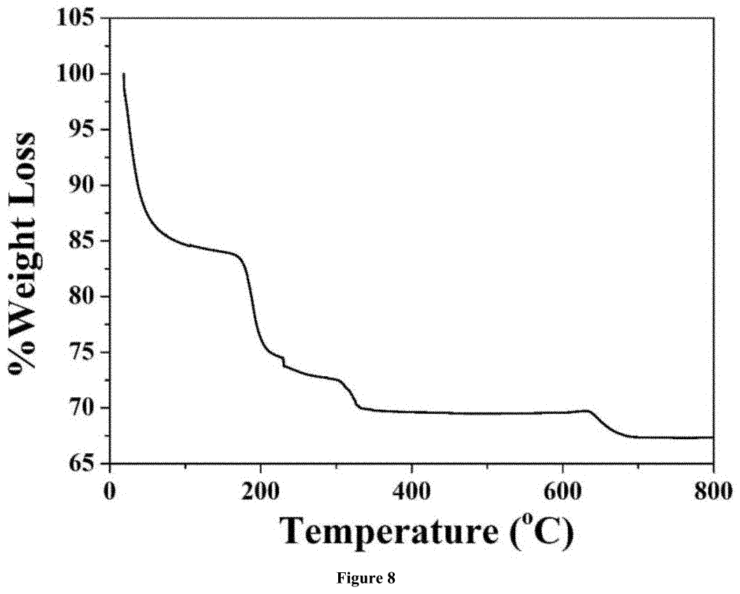

FIG. 8: Thermogravimetric analysis (TGA) curve of [Pd₄₀{(CH₃)₂AsO₂}₁₆(μ₂-OH)₈(μ₂-ONa)₈(μ₄-O)₂₄]·1.5{Na₄(SiW₁₂O₄₀)}·2{Na(CH₃)₂AsO₂}·2{Na(CH₃COO)}·135H₂O (“Pd₄₀{(CH₃)₂AsO₂}₁₆—SiW₁₂O₄₀”) from 20° C. to 800° C.

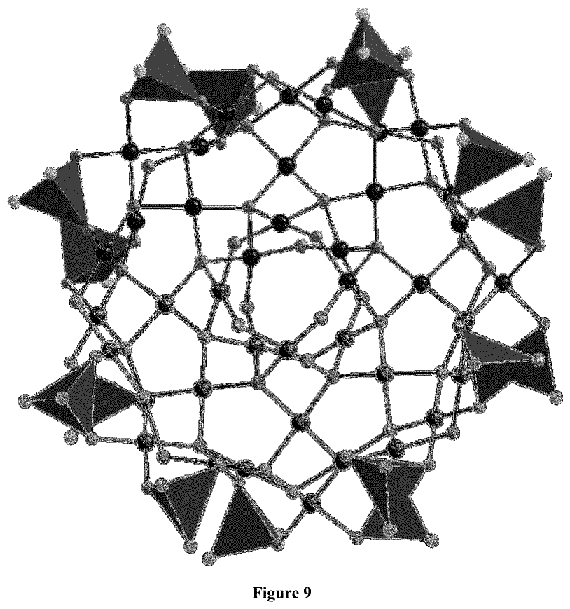

FIG. 9: Ball-and-stick representation of the [Pd₄₀{(CH₃)₂AsO₂}₁₆(μ₂-OH)₈(μ₂-ONa)₈(μ₄-O)₂₄] cluster of [Pd₄₀{(CH₃)₂AsO₂}₁₆(μ₂-OH)₈(μ₂-ONa)₈(μ₄-O)₂₄]·1.5{Na₄(SiW₁₂O₄₀)}·2{Na(CH₃)₂AsO₂}·2{Na(CH₃COO)}·135H₂O (“Pd₄₀{(CH₃)₂AsO₂}₁₆—SiW₁₂O₄₀”). Legend: Pd, black spheres; O, dark gray spheres; C, light gray spheres; cacodylates, black polyhedra.

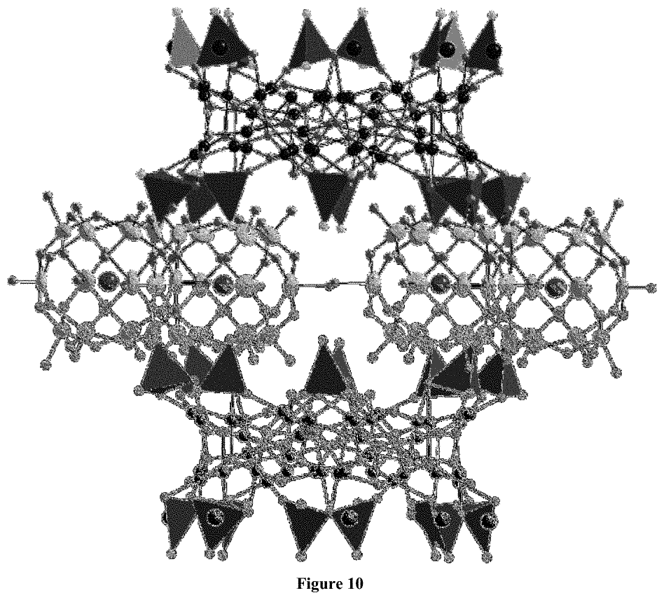

FIG. 10: Ball-and-stick representation of one of the H-bonded supramolecular octahedral assemblies of the [Pd₄₀{(CH₃)₂AsO₂}₁₆(μ₂-OH)₈(μ₂-ONa)₈(μ₄-O)₂₄] clusters and [SiW₁₂O₄₀]⁴⁻ anions of [Pd₄₀{(CH₃)₂AsO₂}₁₆(μ₂-OH)₈(μ₂-ONa)₈(μ₄-O)₂₄]·1.5{Na₄(SiW₁₂O₄₀)}·2{Na(CH₃)₂AsO₂}·2{Na(CH₃COO)}·135H₂O (“Pd₄₀{(CH₃)₂AsO₂}₁₆—SiW₁₂O₄₀”) with the [Pd₄₀{(CH₃)₂AsO₂}₁₆(μ₂-OH)₈(μ₂-ONa)₈(μ₄-O)₂₄] clusters occupying the axial positions and the [SiW₁₂O₄₀]⁴⁻ anions occupying the equatorial positions. Legend: Pd, black spheres; O, dark gray spheres; C, light gray spheres; cacodylates, black polyhedra; W, light gray ellipses; Si, big dark gray spheres.

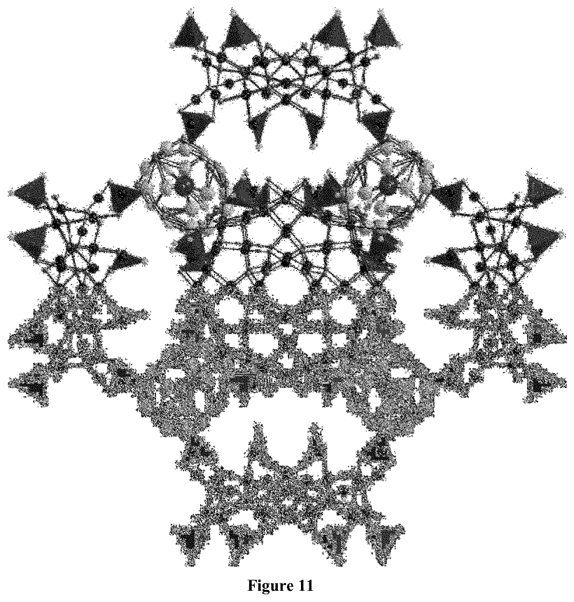

FIG. 11: Ball-and-stick representation of a second H-bonded supramolecular octahedral assembly of the [Pd₄₀{(CH₃)₂AsO₂}₁₆(μ₂-OH)₈(μ₂-ONa)₈(μ₄-O)₂₄] clusters and [SiW₁₂O₄₀]⁴⁻ anions of [Pd₄₀{(CH₃)₂AsO₂}₁₆(μ₂-OH)₈(μ₂-ONa)₈(μ₄-O)₂₄]·1.5{Na₄(SiW₁₂O₄₀)}·2{Na(CH₃)₂AsO₂}·2{Na(CH₃COO)}·135H₂O (“Pd₄₀{(CH₃)₂AsO₂}₁₆—SiW₁₂O₄₀”) with the [Pd₄₀{(CH₃)₂AsO₂}₁₆(μ₂-OH)₈(μ₂-ONa)₈(μ₄-O)₂₄] clusters occupying the corner positions and the [SiW₁₂O₄₀]⁴⁻ anions occupying the face positions. Legend: Pd, black spheres; O, dark gray spheres; C, light gray spheres; cacodylates, black polyhedra; W, light gray ellipses; Si, big dark gray spheres.

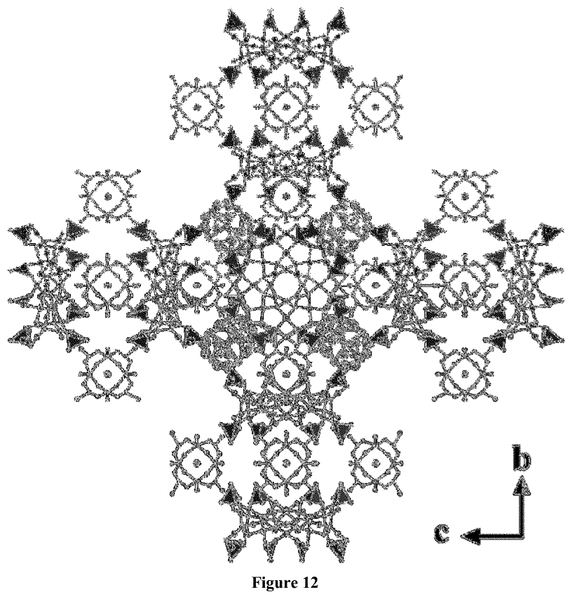

FIG. 12: Ball-and-stick representation of the all-inorganic H-bonded supramolecular framework of [Pd₄₀{(CH₃)₂AsO₂}₁₆(μ₂-OH)₈(μ₂-ONa)₈(μ₄-O)₂₄]·1.5{Na₄(SiW₁₂O₄₀)}·2{Na(CH₃)₂AsO₂}·2{Na(CH₃COO)}·135H₂O (“Pd₄₀{(CH₃)₂AsO₂}₁₆—SiW₁₂O₄₀”) formed by the first and second H-bonded supramolecular octahedral assemblies of the [Pd₄₀{(CH₃)₂AsO₂}₁₆(μ₂-OH)₈(μ₂-ONa)₈(μ₄-O)₂₄] clusters and [SiW₁₂O₄₀]⁴⁻ anions. Legend: Pd, black spheres; O, dark gray spheres; C, light gray spheres; cacodylates, black polyhedra; W, light gray ellipses; Si, big dark gray spheres.

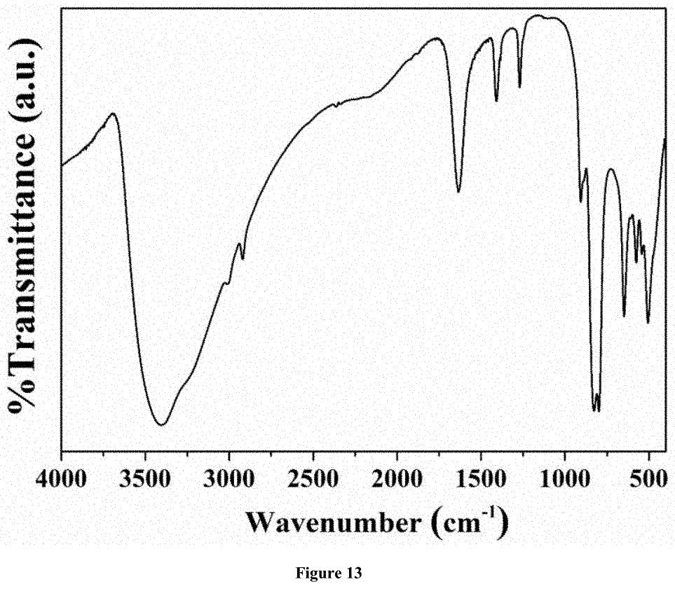

FIG. 13: Fourier Transform Infrared (FT-IR) spectrum of [Pd₁₆{(CH₃)₂AsO₂}₈(μ₂-OH)₃(μ₂-ONa)₂(μ₄-O)₈Cl₃]·0.25{Na(CH₃)₂AsO₂}·17H₂O (“Pd₁₆{(CH₃)₂AsO₂}₈Cl₃”) from 4000 cm⁻¹ to 400 cm⁻¹.

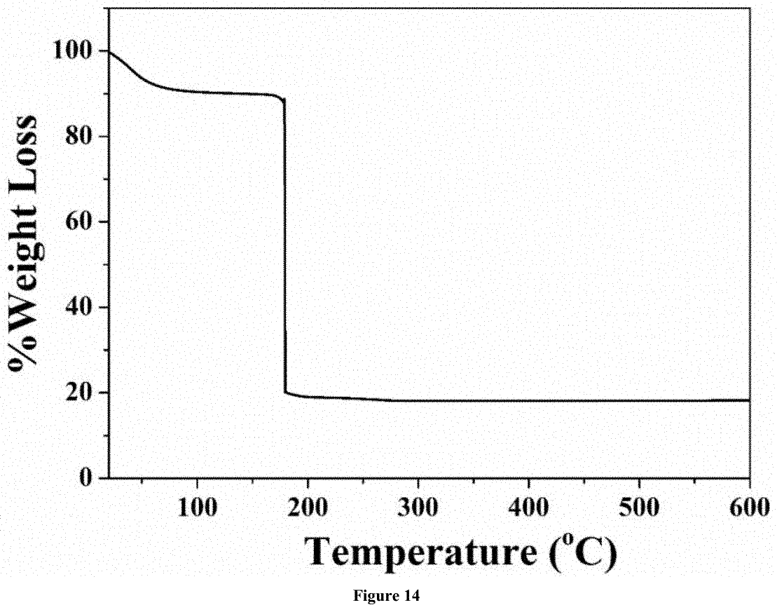

FIG. 14: Thermogravimetric analysis (TGA) curve of [Pd₁₆{(CH₃)₂AsO₂}₈(μ₂-OH)₃(μ₂-ONa)₂(μ₄-O)₈Cl₃]·0.25{Na(CH₃)₂AsO₂}·17H₂O (“Pd₁₆{(CH₃)₂AsO₂}₈Cl₃”) from 20° C. to 800° C.

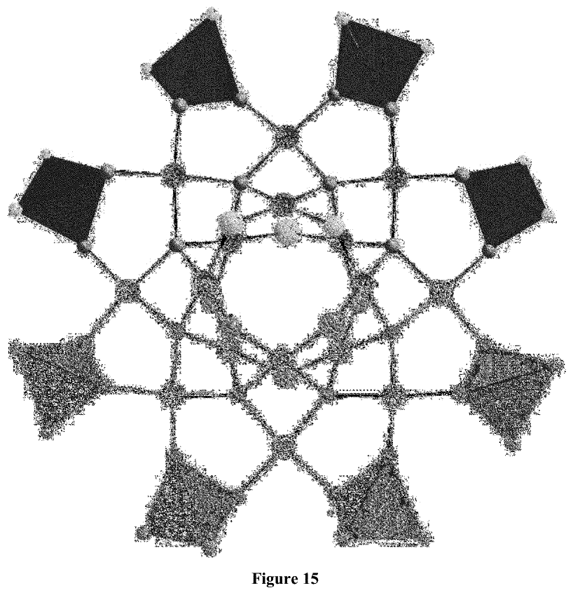

FIG. 15: Ball-and-stick representation of the [Pd₁₆{(CH₃)₂AsO₂}₈(μ₂-OH)₃(μ₂-ONa)₂(μ₄-O)₈Cl₃] cluster of [Pd₁₆{(CH₃)₂AsO₂}₈(μ₂-OH)₃(μ₂-ONa)₂(μ₄-O)₈Cl₃]·0.25{Na(CH₃)₂AsO₂}·17H₂O (“Pd₁₆{(CH₃)₂AsO₂}₈Cl₃”). Legend: Pd, black spheres; O, small dark gray spheres; C, small light gray spheres; cacodylates, black polyhedra; Cl, large light gray spheres.

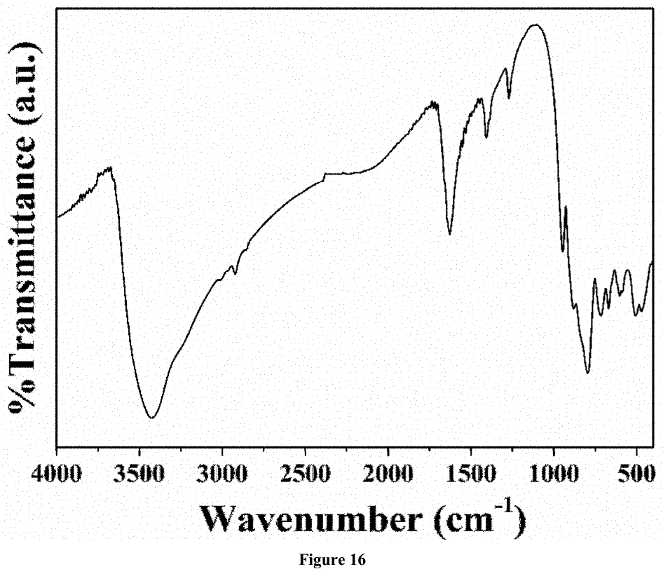

FIG. 16: Fourier Transform Infrared (FT-IR) spectrum of [Pd₄₀{(CH₃)₂AsO₂}₁₆(μ₂-OH)₁₆(μ₄-O)₂₄]·2.5{Na₄(GeW₁₂O₄₀)}·4{Na(CH₃)₂AsO₂}·110H₂O (“Pd₄₀{(CH₃)₂AsO₂}₁₆—GeW₁₂O₄₀”) from 4000 cm⁻¹ to 400 cm⁻¹.

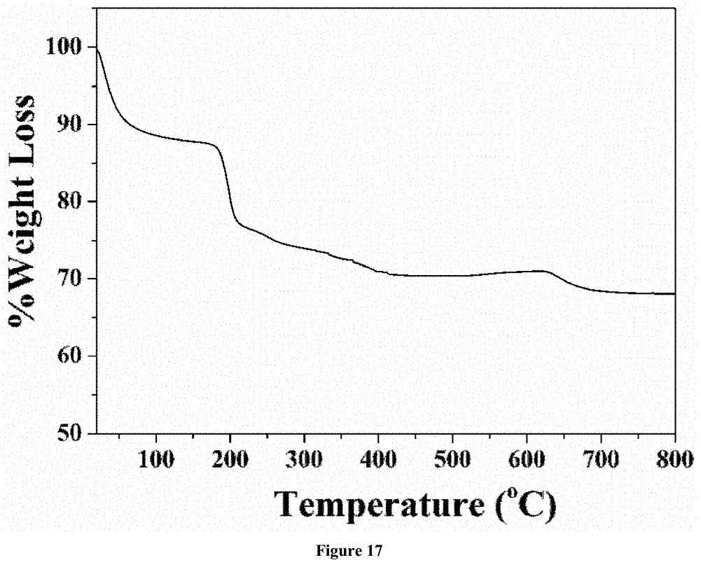

FIG. 17: Thermogravimetric analysis (TGA) curve of [Pd₄₀{(CH₃)₂AsO₂}₁₆(μ₂-OH)₁₆(μ₄-O)₂₄]·2.5{Na₄(GeW₁₂O₄₀)}·4{Na(CH₃)₂AsO₂}·110H₂O (“Pd₄₀{(CH₃)₂AsO₂}₁₆—GeW₁₂O₄₀”) from 20° C. to 800° C.

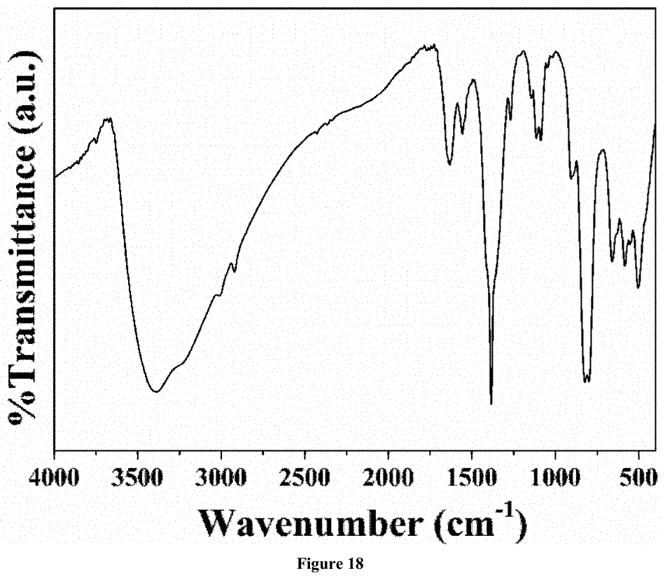

FIG. 18: Fourier Transform Infrared (FT-IR) spectrum of [Pd₄₀{(CH₃)₂AsO₂}₁₆(μ₂-OH)₁₆(μ₄-O)₂₄]·5Ba(NO₃)₂·7{Na(CH₃)₂AsO₂}·2{Na(CH₃COO)}·NaNO₃·80H₂O (“Pd₄₀{(CH₃)₂AsO₂}₁₆—Ba”) from 4000 cm⁻¹ to 400 cm⁻¹.

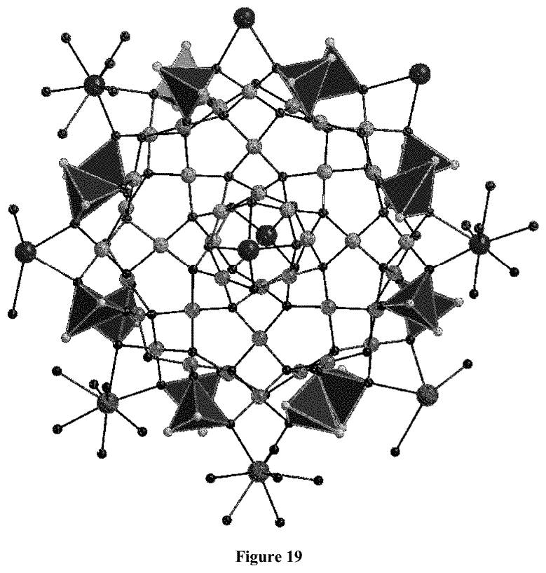

FIG. 19: Ball-and-stick representation of the [Pd₄₀{(CH₃)₂AsO₂}₁₆(μ₂-OH)₁₆(μ₄-O)₂₄] cluster of [Pd₄₀{(CH₃)₂AsO₂}₁₆(μ₂-OH)₁₆(μ₄-O)₂₄]·5Ba(NO₃)₂·7{Na(CH₃)₂AsO₂}·2{Na(CH₃COO)}·NaNO₃·80H₂O (“Pd₄₀{(CH₃)₂AsO₂}₁₆—Ba”). Legend: Pd, dark gray spheres; O, small black spheres; C, light gray spheres; cacodylates, black polyhedra; Ba, big black spheres.

### DETAILED DESCRIPTION

According to a first embodiment, the noble metal-oxo clusters of the present invention are represented by the formula

[Mₛ(R₂XO₂)_{z}(OH)ₓO_{y}]

or solvates thereof, wherein
each M is independently selected from the group consisting of Pd, Pt, Rh, Ir, Ag and Au, and each M has d⁸ valence electron configuration,
each R is independently selected from the group consisting of hydrogen and substituted or unsubstituted hydrocarbyl, wherein each hydrocarbyl provides a carbon atom for coordination to X and wherein preferably no more than one R is hydrogen per (R₂XO₂) group,
each X is independently selected from the group consisting of P and As,
s is a number from 8 to 96,
z is a number from 8 to 96,
x is a number from 2 to 48, and
y is a number from 2 to 48.

According to a second embodiment, the noble metal-oxo clusters of the present invention are represented by the formula

[Mₛ(R₂XO₂)_{z}(OR′)ₓO_{y}]

or solvates thereof, wherein
M, R, X, s, x, y and z are the same as defined above, and
each R′ is independently selected from the group consisting of a proton or a monovalent cation.

According to a third embodiment, the noble metal-oxo clusters of the present invention are represented by the formula

[Mₛ(R₂XO₂)_{z}(OR′)ₓO_{y}X′_{q}]

or solvates thereof, wherein
M, R, X, R′, s, x, y and z are the same as defined above,
each X′ is independently selected from the group consisting of monovalent anions, and
q is a number from 0 to 46,
with the proviso that x+q≤48.

In a first preferred variant of the first, second or third embodiments, all M are the same; preferably wherein all M are the same, and are selected from Pd, Pt, Rh, and Ir, more preferably Pd, Pt and Rh, most preferably Pd and Pt, in particular Pd. In the alternative, all M are selected from mixtures of Pd and Pt.

In a second preferred variant of the first, second or third embodiments or of the first preferred variant of said embodiments, all X are the same; in particular wherein all X are P, preferably wherein all X are As; more particularly, wherein all M are Pd and all X are As.

In a third preferred variant of the first, second or third embodiments or of the first or second preferred variant of said embodiments, each of the y O atoms is in the form of a (μ₄-O)²⁻ oxy anion and each of the x (OR′) groups is in the form of a (μ₂-OR′)⁻ anion, in particular a (μ₂-OH)⁻ hydroxy anion.

In a fourth preferred variant of the first, second or third embodiments or of the first, second or third preferred variant of said embodiments, within the noble metal-oxo clusters according to the present invention the (R₂XO₂) capping groups have a negative charge of −1, i.e., the noble metal-oxo clusters according to the present invention comprise (R₂XO₂)⁻ capping groups. (R₂XO₂)⁻ groups can be monodentate or bidentate ligands, i.e., the (R₂XO₂)⁻ groups can be bonded via one or via both of the two oxygen atoms, respectively. Monodentate (R₂XO₂)⁻ groups are bonded to one atom only, whereas bidentate (R₂XO₂)⁻ groups are bonded to two atoms. The bidentate (R₂XO₂)⁻ groups can be bonded to either one or two different atoms. Within this variant, the noble metal-oxo clusters according to the present invention contain only monodentate (R₂XO₂)⁻ groups, only bidentate (R₂XO₂)⁻ groups or a combination of monodentate and bidentate (R₂XO₂)⁻ groups. Within this variant, it is preferred that the noble metal-oxo clusters according to the present invention contain bidentate (R₂XO₂)⁻ groups only (see, e.g., FIG. 3). Within this variant, it is further preferred that the bidentate (R₂XO₂)⁻ groups are bonded to two different atoms via each of the two oxygen atoms, respectively, i.e., each of the two oxygen atoms of the bidentate (R₂XO₂)⁻ group is bonded to a different atom.

In a fifth preferred variant of the first, second or third embodiments or of the first, second, third or fourth preferred variant of said embodiments, the noble metal-oxo cluster comprises a noble metal M₈ ring unit in the form of a M₈(μ₄-O)₈ unit, wherein 8 square planar M are linked by 8 (μ₄-O)²⁻ oxy anions and wherein each of the 8 (μ₄-O)²⁻ oxy anions is bonded to two different of the 8 square planar M and each of the 8 square planar M is bonded to two different of the 8 (μ₄-O)²⁻ oxy anions (see, e.g., FIG. 3). Within this variant, it is further preferred that the 8 square planar M are 8 peripheral noble metal atoms M capped by 8 bidentate (R₂XO₂)⁻ capping groups, wherein each of the 8 square planar peripheral M is bonded to two different of the 8 bidentate (R₂XO₂)⁻ capping groups, and wherein each oxygen atom of each of the 8 bidentate (R₂XO₂)⁻ capping groups is bonded to one of the 8 square planar peripheral M and the two oxygen atoms of each of the 8 bidentate (R₂XO₂)⁻ capping groups are bonded to two different of the 8 square planar peripheral M, i.e., each of the 8 bidentate (R₂XO₂)⁻ capping groups is bonded to two different of the 8 square planar peripheral M with each bond being formed via one of the two oxygen atom of each of the 8 bidentate (R₂XO₂)⁻ capping groups (see, e.g., FIG. 3).

In a sixth preferred variant of the first, second or third embodiments or of the first, second, third, fourth or fifth preferred variant of said embodiments, the noble metal-oxo cluster comprises an inner noble metal M₄ ring unit which is a M₄(μ₂-OR′)₄ ring or a M₄(μ₄-O)₂(μ₂-OR′)₂ ring.

In the sixth preferred variant, wherein the inner noble metal M₄ ring unit is a M₄(μ₂-OR′)₄ ring, it is further preferred that the 4 square planar M are linked by 4 (μ₂-OR′)⁻ anions, wherein each of the 4 (μ₂-OR′)⁻ anions is bonded to two different of the 4 square planar M, and wherein each of the 4 square planar M is bonded to two different of the 4 (μ₂-OR′)⁻ anions (see, e.g., FIG. 3). Within this variant, it is further preferred that the noble metal-oxo cluster comprises two M₄(μ₂-OR′)₄ inner noble metal M₄ ring units as described above and one M₈(μ₄-O)₈ noble metal M₈ ring unit as described above, wherein each of the two M₄(μ₂-OR′)₄ inner noble metal M₄ ring units is bonded to the M₈(μ₄-O)₈ noble metal Mg ring unit (i.e., one of the two M₄(μ₂-OR′)₄ inner noble metal M₄ ring units above and the other of the two M₄(μ₂-OR′)₄ inner noble metal M₄ ring units below the M₈(μ₄-O)₈ noble metal M₈ ring unit) via bonds between the 4 square planar M of each of the two M₄(μ₂-OR′)₄ inner noble metal M₄ ring units and the 8 (μ₄-O)²⁻ oxy anions of the M₈(μ₄-O)₈ noble metal Mg ring unit, wherein each of the 4 square planar M of each of the two M₄(μ₂-OR′)₄ inner noble metal M₄ ring units is bonded to two different of the 8 (μ₄-O)²⁻ oxy anions of the M₈(μ₄-O)₈ noble metal M₈ ring unit, and wherein each of the 8 (μ₄-O)²⁻ oxy anions of the M₈(μ₄-O)₈ noble metal M₈ ring unit is bonded to two different of the 2×4 square planar M of the two M₄(μ₂-OR′)₄ inner noble metal M₄ ring units in such a way that each of the 8 (μ₄-O)²⁻ oxy anions of the M₈(μ₄-O)₈ noble metal M₈ ring unit is bonded to one of the 4 square planar M of each of the two M₄(μ₂-OR′)₄ inner noble metal M₄ ring units, i.e., each of the 8 (μ₄-O)²⁻ oxy anions of the M₈(μ₄-O)₈ noble metal M₈ ring unit is bonded to both of the two M₄(μ₂-OR′)₄ inner noble metal M₄ ring units (see, e.g., FIG. 3).

In the sixth preferred variant, wherein the inner noble metal M₄ ring unit is a M₄(μ₄-O)₂(μ₂-OR′)₂ ring, it is further preferred that the 4 square planar M are linked by 2 (μ₂-OR′)⁻ anions and 2 (μ₄-O)²⁻ oxy anions, wherein each of the 2 (μ₂-OR′)⁻ anions and each of the 2 (μ₄-O)²⁻ oxy anions is bonded to two different of the 4 square planar M, and wherein each of the 4 square planar M is bonded to two different of the 4 anions consisting of the 2 (μ₂-OR′)⁻ anions and the 2 (μ₄-O)²⁻ oxy anions (see, e.g., FIG. 6). Within this variant, it is preferred, in particular, that in the M₄(μ₄-O)₂(μ₂-OR′)₂ ring both of the 2 (μ₂-OR′)⁻ anions are adjacent to each other and both of the 2 (μ₄-O)²⁻ oxy anions are adjacent to each other, i.e., the 4 square planar M are linked by the 2 (μ₂-OR′)⁻ anions and the 2 (μ₄-O)²⁻ oxy anions such that each of the 2 (μ₂-OR′)⁻ anions and each of the 2 (μ₄-O)²⁻ oxy anions is bonded to two different of the 4 square planar Pd²⁺ ions, and such that a 1st of the 4 square planar M is bonded to each of the 2 (μ₂-OR′)⁻ anions, a 2nd of the 4 square planar M is bonded to each of the 2 (μ₄-O)²⁻ oxy anions, and each of the 2 remaining of the 4 square planar M is bonded to one different of the 2 (μ₂-OR′)⁻ anions and one different of the 2 (μ₄-O)²⁻ oxy anions, i.e., each of the 2 remaining of the 4 square planar M is bonded to a different of the 2 (μ₂-OR′)⁻ anions and to a different of the 2 (μ₄-O)²⁻ oxy anions (see, e.g., FIG. 6). Within this variant, wherein the inner noble metal M₄ ring unit is a M₄(μ₄-O)₂(μ₂-OR′)₂ ring, it is further preferred that the noble metal-oxo cluster comprises two M₄(μ₄-O)₂(μ₂-OR′)₂ inner noble metal M₄ ring units as described above and one noble metal M₈ ring unit as described above, wherein each of the two M₄(μ₄-O)₂(μ₂-OR′)₂ inner noble metal M₄ ring units is bonded to the M₈(μ₄-O)₈ noble metal M₈ ring unit (i.e., one of the two M₄(μ₄-O)₂(μ₂-OR′)₂ inner noble metal M₄ ring units above and the other of the two M₄(μ₄-O)₂(μ₂-OR′)₂ inner noble metal M₄ ring units below the M₈(μ₄-O)₈ noble metal M₈ ring unit) via bonds between the 4 square planar M of each of the two M₄(μ₄-O)₂(μ₂-OR′)₂ inner noble metal M₄ ring units and the 8 (μ₄-O)²⁻ oxy anions of the M₈(μ₄-O)₈ noble metal M₈ ring unit, wherein each of the 4 square planar M of each of the two M₄(μ₄-O)₂(μ₂-OR′)₂ inner noble metal M₄ ring units is bonded to two different of the 8 (μ₄-O)²⁻ oxy anions of the M₈(μ₄-O)₈ noble metal M₈ ring unit, and wherein each of the 8 (μ₄-O)²⁻ oxy anions of the M₈(μ₄-O)₈ noble metal M₈ ring unit is bonded to two different of the 2×4 square planar M of the two M₄(μ₄-O)₂(μ₂-OR′)₂ inner noble metal M₄ ring units in such a way that each of the 8 (μ₄-O)²⁻ oxy anions of the M₈(μ₄-O)₈ noble metal M₈ ring unit is bonded to one of the 4 square planar M of each of the two M₄(μ₄-O)₂(μ₂-OR′)₂ inner noble metal M₄ ring units, i.e., each of the 8 (μ₄-O)²⁻ oxy anions of the M₈(μ₄-O)₈ noble metal Mg ring unit is bonded to both of the two M₄(μ₄-O)₂(μ₂-OR′)₂ inner noble metal M₄ ring units (see, e.g., FIG. 6).

In a seventh preferred variant of the first, second or third embodiments or of the first, second, third, fourth, fifth or sixth preferred variant of said embodiments, the noble metal-oxo cluster comprises an outer noble metal M₄ ring unit which is a M₄(μ₄-O)₂(μ₂-OR′)₂ ring, wherein the 4 square planar M are linked by 2 (μ₂-OR′)⁻ anions and 2 (μ₄-O)²⁻ oxy anions, wherein each of the 2 (μ₂-OR′)⁻ anions and each of the 2 (μ₄-O)²⁻ oxy anions is bonded to two different of the 4 square planar M, and wherein each of the 4 square planar M is bonded to two different of the 4 anions consisting of the 2 (μ₂-OR′)⁻ anions and the 2 (μ₄-O)²⁻ oxy anions (see, e.g., FIG. 6). Within this variant, it is preferred, in particular, that in the M₄(μ₄-O)₂(μ₂-OR′)₂ ring both of the 2 (μ₂-OR′)⁻ anions are adjacent to each other and both of the 2 (μ₄-0)²⁻ oxy anions are adjacent to each other, i.e., the 4 square planar M are linked by the 2 (μ₂-OR′)⁻ anions and the 2 (μ₄-O)²⁻ oxy anions such that each of the 2 (μ₂-OR′)⁻ anions and each of the 2 (μ₄-O)²⁻ oxy anions is bonded to two different of the 4 square planar Pd²⁺ ions, and such that a 1st of the 4 square planar M is bonded to each of the 2 (μ₂-OR′)⁻ anions, a 2nd of the 4 square planar M is bonded to each of the 2 (μ₄-O)²⁻ oxy anions, and each of the 2 remaining of the 4 square planar M is bonded to one different of the 2 (μ₂-OR′)⁻ anions and one different of the 2 (μ₄-O)²⁻ oxy anions, i.e., each of the 2 remaining of the 4 square planar M is bonded to a different of the 2 (μ₂-OR′)⁻ anions and to a different of the 2 (μ₄-O)²⁻ oxy anions (see, e.g., FIG. 6). Within this variant, wherein the noble metal-oxo cluster comprises an M₄(μ₄-O)₂(μ₂-OR′)₂ outer noble metal M₄ ring unit as described above, it is further preferred that the 4 square planar M are 4 peripheral noble metal atoms M capped by 4 bidentate (R₂XO₂)⁻ capping groups, wherein each of the 4 square planar peripheral M is bonded to two different of the 4 bidentate (R₂XO₂)⁻ capping groups, and wherein each oxygen atom of each of the 4 bidentate (R₂XO₂)⁻ capping groups is bonded to one of the 4 square planar peripheral M and the two oxygen atoms of each of the 4 bidentate (R₂XO₂)⁻ capping groups are bonded to two different of the 4 square planar peripheral M, i.e., each of the 4 bidentate (R₂XO₂)⁻ capping groups is bonded to two different of the 4 square planar peripheral M with each bond being formed via one of the two oxygen atom of each of the 4 bidentate (R₂XO₂)⁻ capping groups (see, e.g., FIG. 6). Within this variant, it is further preferred that the noble metal-oxo cluster comprises a M₄(μ₄-O)₂(μ₂-OR′)₂ outer noble metal M₄ ring unit as described above and a M₄(μ₄-O)₂(μ₂-OR′)₂ inner noble metal M₄ ring unit as described above, wherein the two are connected to each other in so far as the M₄(μ₄-O)₂(μ₂-OR′)₂ outer noble metal M₄ ring unit and the M₄(μ₄-O)₂(μ₂-OR′)₂ inner noble metal M₄ ring unit share the same 2 (μ₄-O)²⁻ oxy anions, i.e., the M₄(μ₄-O)₂(μ₂-OR′)₂ outer noble metal M₄ ring unit and the M₄(μ₄-O)₂(μ₂-OR′)₂ inner noble metal M₄ ring unit form a [M₄(μ₂-OR′)₂](μ₄-O)₂[M₄(μ₂-OR′)₂] noble metal M₄-M₄ double ring unit (see, e.g., FIG. 6). Within this variant, it is further preferred that the noble metal-oxo cluster comprises two M₄(μ₄-O)₂(μ₂-OR′)₂ outer noble metal M₄ ring units as described above, two M₄(μ₄-O)₂(μ₂-OR′)₂ inner noble metal M₄ ring units as described above and one M₈(μ₄-O)₈ noble metal M₈ ring unit as described above, wherein each of the two M₄(μ₄-O)₂(μ₂-OR′)₂ inner noble metal M₄ ring units is bonded to one side of the M₈(μ₄-O)₈ noble metal M₈ ring unit as described above (i.e., one of the two M₄(μ₄-O)₂(μ₂-OR′)₂ inner noble metal M₄ ring units above and the other of the two M₄(μ₄-O)₂(μ₂-OR′)₂ inner noble metal M₄ ring units below the M₈(μ₄-O)₈ noble metal M₈ ring unit), and wherein a 1^{st} M₄(μ₄-O)₂(μ₂-OR′)₂ outer noble metal M₄ ring unit and a 1st m (μ₄-O)₂(μ₂-OR′)₂ inner noble metal M₄ ring unit are connected to each other by sharing the same 2 (μ₄-O)²⁻ oxy anions as described above and the 2^{nd} M₄(μ₄-O)₂(μ₂-OR′)₂ outer noble metal M₄ ring unit and the 2^{nd} M₄(μ₄-O)₂(μ₂-OR′)₂ inner noble metal M₄ ring unit are connected to each other by sharing the same 2 (μ₄-O)²⁻ oxy anions as described above, i.e., two [M₄(μ₂-OR′)₂](μ₄-O)₂[M₄(μ₂-OR′)₂] noble metal M₄-M₄ double ring units are formed, each of which is bonded to one side of the M₈(μ₄-O)₈ noble metal M₈ ring unit via its inner noble metal M₄ ring unit as described above (i.e., one of the two [M₄(μ₂-OR′)₂](μ₄-O)₂[M₄(μ₂-OR′)₂] noble metal M₄-M₄ double ring units above and the other of the two [M₄(μ₂-OR′)₂](μ₄-O)₂[M₄(μ₂-OR′)₂] noble metal M₄-M₄ double ring units below the M₈(μ₄-O)₈ noble metal M₈ ring unit) (see, e.g., FIG. 6).

In a eights preferred variant of the first, second or third embodiments or of the first, second, third, fourth, fifth, sixth or seventh preferred variant of said embodiments, the noble metal-oxo cluster comprises a noble metal M₂₄ ring unit in the form of [M₂₄(μ₂-OR′)₈(μ₄-O)₁₆] ring, wherein 24 square planar M are linked by 16 (μ₄-O)²⁻ oxy anions and 8 (μ₂-OR′)⁻ anions, wherein each of the 16 (μ₄-O)²⁻ oxy anions is bonded to three different of the 24 square planar M, each of the 24 square planar M is bonded to two different of the 16 (μ₄-O)²⁻ oxy anions, each of the 8 (μ₂-OR′)⁻ anions is bonded to two different of 16 of the 24 square planar M, each of said 16 of the 24 square planar M is bonded to one of the 8 (μ₂-OR′)⁻ anions and each of the remaining 8 of the 24 square planar M is not bonded to any of the 8 (μ₂-OR′)⁻ anions (see, e.g., FIG. 9). Within this variant, it is further preferred that the 24 square planar M are 24 peripheral noble metal atoms M capped by 16 bidentate (R₂XO₂)⁻ capping groups, wherein each of 8 of the 24 square planar M, which are not bonded to any of the 8 (μ₂-OR′)⁻ anions, is bonded to two different of the 16 bidentate (R₂XO₂)⁻ capping groups, each of the remaining 16 of the 24 square planar M, which are bonded to one of the 8 (μ₂-OR′)⁻ anions, is bonded to one different of the 16 bidentate (R₂XO₂)⁻ capping groups, each oxygen atom of each of the 16 bidentate (R₂XO₂)⁻ capping groups is bonded to one of the 24 square planar M and the two oxygen atoms of each of the bidentate (R₂XO₂)⁻ capping groups are bonded to two different of the 24 square planar M (i.e., each of the 16 bidentate (R₂XO₂)⁻ capping groups is bonded to two different of the 24 square planar M with each bond being formed via one of the two oxygen atoms of each of the 16 bidentate (R₂XO₂)⁻ capping groups), each of the 8 (μ₂-OR′)⁻ anions is bonded to two different of said remaining 16 of the 24 square planar M, which are bonded to one different of the 16 bidentate (R₂XO₂)⁻ capping groups, and each of said remaining 16 of the 24 square planar M, which are bonded to one different of the 16 bidentate (R₂XO₂)⁻ capping groups, is bonded to one different of the 8 (μ₂-OR′)⁻ anions (see, e.g., FIG. 9). Within this variant, it is further preferred that the noble metal-oxo cluster comprises one [M₂₄(μ₂-OR′)₈(μ₄-O)₁₆] noble metal M₂₄ ring unit as described above and one M₈(μ₄-O)₈ noble metal M₈ ring unit as described above, wherein the M₈(μ₄-O)₈ noble metal M₈ ring unit is located within the [M₂₄(μ₂-OR′)₈(μ₄-O)₁₆] noble metal M₂₄ ring unit and the M₈(μ₄-O)₈ noble metal M₈ ring unit is bonded to the [M₂₄(μ₂-OR′)₈(μ₄-O)₁₆] noble metal M₂₄ ring unit via bonds between the 8 square planar M of the M₈(μ₄-O)₈ noble metal M₈ ring unit and the 16 (μ₄-O)²⁻ oxy anions of the [M₂₄(μ₂-OR′)₈(μ₄-O)₁₆] noble metal M₂₄ ring unit, wherein each of the 8 square planar M of the M₈(μ₄-O)₈ noble metal M₈ ring unit is bonded to two different of the 16 (μ₄-O)²⁻ oxy anions of the [M₂₄(μ₂-OR′)₈(μ₄-O)₁₆] noble metal M₂₄ ring unit, and each pair of two adjacent of the 16 (μ₄-O)²⁻ oxy anions of the [M₂₄(μ₂-OR′)₈(μ₄-O)₁₆] noble metal M₂₄ ring unit is bonded to one different of the 8 square planar M of the M₈(μ₄-O)₈ noble metal M₈ ring unit, i.e., every second of the 16 (μ₄-O)²⁻ oxy anions of the [M₂₄(μ₂-OR′)₈(μ₄-O)₁₆] noble metal M₂₄ ring unit is bonded to one different of the 8 square planar M of the M₈(μ₄-O)₈ noble metal M₈ ring unit (see, e.g., FIG. 9). Within this variant, it is further preferred that the noble metal-oxo cluster comprises two M₄(μ₂-OR′)₄ inner noble metal M₄ ring units as described above, one [M₂₄(μ₂-OR′)₈(μ₄-O)₁₆] noble metal M₂₄ ring unit as described above and one M₈ (μ₄-O)₈ noble metal M₈ ring unit as described above, wherein the M₈(μ₄-O)₈ noble metal M₈ ring unit is bonded to the [M₂₄(μ₂-OR′)₈(μ₄-O)₁₆] noble metal M₂₄ ring unit as described above and wherein each of the two M₄(μ₂-OR′)₄ inner noble metal M₄ ring units is bonded to one side of the M₈(μ₄-O)₈ noble metal M₈ ring unit as described above (i.e., one of the two M₄(μ₂-OR′)₄ inner noble metal M₄ ring units above and the other of the two M₄(μ₂-OR′)₄ inner noble metal M₄ ring units below the Mg(μ₄-O)₈ noble metal M₈ ring unit) (see, e.g., FIG. 9).

In a ninths preferred variant of the third embodiment or of the first, second, third, fourth, fifth, sixth, seventh or eights preferred variant of said embodiment, in the noble metal-oxo cluster [Mₛ(R₂XO₂)_{z}(OR′)ₓO₇X′_{q}], q is at least 1. Within this variant, it is further preferred that each of the q (i.e., one or more) monovalent anions X′ in the noble metal-oxo cluster [Mₛ(R₂XO₂)_{z}(OR′)ₓO_{y}X′_{q}] replaces one of the (μ₂-OR′)⁻ anions in the M₄(μ₂-OR′)₄ inner noble metal M₄ ring unit as described above and/or in the M₄(μ₄-O)₂(μ₂-OR′)₂ inner noble metal M₄ ring unit as described above and/or in the M₄(μ₄-O)₂(μ₂-OR′)₂ outer noble metal M₄ ring unit as described above and/or in the [M₂₄(μ₂-OR′)₈(μ₄-O)₁₆] noble metal M₂₄ ring unit as described above.

Hereinbelow, further preferred embodiments, variants and/or aspects of the noble metal-oxo clusters [Mₛ(R₂XO₂)_{z}(OR′)ₓO_{y}X′_{q}] according to the present invention, and in particular of the first, second or third embodiments and/or of the preferred variants thereof, are disclosed.

The noble metal-oxo clusters of the present invention are neutral, i.e., they have a net charge of 0. The s (i.e., 8 to 96) noble metal centers M have a d⁸ valence electron configuration. Based on the d⁸ valence electron configuration, the oxidation state of the respective noble metal M can be identified, so that M is Pd^{II}, Pt^{II}, Rh^{I}, Ir^{I}, Ag^{III} and Au^{III}. Preferably, within the noble metal-oxo clusters according to the present invention each of the z (i.e., 8 to 96) groups (R₂XO₂) has a negative charge of −1, i.e., the noble metal-oxo clusters according to the present invention comprise (R₂XO₂)⁻ anions. Preferably, within the noble metal-oxo clusters according to the present invention each of the x (i.e., 2 to 48) groups (OR′) has a negative charge of −1, i.e., the noble metal-oxo clusters according to the present invention comprise (OR′)⁻ anions. Preferably, within the noble metal-oxo clusters according to the present invention each of the y (i.e., 2 to 48) atoms O has a negative charge of −2, i.e., the noble metal-oxo clusters according to the present invention comprise O²⁻ oxy anions. Preferably, within the noble metal-oxo clusters according to the present invention each of the q (i.e., 0 to 46) anions (X′) is monovalent and has a negative charge of −1, i.e., the noble metal-oxo clusters according to the present invention monovalent (X′)⁻ anions. Taking into account the additional proviso that x+q≤48, the specific numbers z, x, y and q of the (R₂XO₂)⁻ anions, (OR′)⁻ anions, O²⁻ oxy anions and monovalent (X′)⁻ anions, respectively, must be such that for the total positive charge resulting from the number s and the nature of the cationic noble metal M species is compensated for, and, thus, the preferred noble metal-oxo clusters [Mₛ(R₂XO₂)_{z}(OR′)ₓO_{y}X′_{q}] according to the present invention have a net charge of 0.

Preferably, in the noble metal-oxo clusters of the present invention all M have d⁸ valence electron configuration and all M are the same and selected from the group consisting of Pd^{II}, Pt^{II}, Rh^{I}, Ir^{I}, Ag^{III} and Au^{III} preferably Pd^{II}, Pt^{II}, Rh^{I} and Ir^{I}, more preferably Pd^{II}, Pt^{II} and Rh^{I}, most preferably Pd^{II} and Pt^{II}, in particular Pd^{II}. In the alternative, in the noble metal-oxo clusters of the present invention all M have d⁸ valence electron configuration and all M are not the same and selected from the group consisting of Pd^{II}, Pt^{II}, Rh^{I}, Ir^{I}, Ag^{III} and Au^{III} preferably Pd^{II}, Pt^{II}, Rh^{I} and Ir^{I}, more preferably Pd^{II}, Pt^{II} and Rh^{I}, most preferably all M are selected from mixtures of Pd^{II} and Pt^{II}.

Preferably, in the noble metal-oxo clusters of the present invention s is 8 to 96, preferably 10 to 90, more preferably s is 12 to 84, even more preferably s is 14 to 72, and most preferably s is 16 to 54. In the alternative, s is 8 to 96, preferably 24 to 92, more preferably s is 36 to 90, even more preferably s is 54 to 86, and most preferably s is 60 to 82. In particular s is 8, 10, 12, 16, 18, 20, 22, 24, 26, 28, 30, 32, 34, 36, 40, 44, 48, 52, 54, 60, 62, 64, 66, 68, 70, 72, 74, 76, 78, 80, 82, 84, 86, 88, 90, 92, 94 or 96; more particularly s is 12, 16, 18, 20, 24, 28, 32, 36, 40, 44, 48, 54, 60, 66, 72, 84 or 90, more particularly s is 16, 18, 24, 36, 40, 48, 60, 72 or 84, most particularly s is 16, 24 or 40.

Preferably, in the (R₂XO₂) groups of the noble metal-oxo clusters according to the present invention each of the two R (hydrocarbyl bonded by C or hydrogen) and each of the two O atoms are bonded covalently to X (P or As). Preferably, X is a P atom or an As atom in the form of an uncharged neutral atom. Preferably, each R is in the form of a radical, i.e., either an uncharged neutral hydrogen atom or a hydrocarbyl radical wherein the C atom for coordination to X has no charge but is in the form of a radical. In the preferred case, in which the (R₂XO₂) group has a negative charge of −1, i.e., the (R₂XO₂) group is a (R₂XO₂)⁻ anion, the negative charge is delocalized between the two electronegative O atoms in a resonance structure. According the elctronegativity by the Pauling scale (2.20 for H; 2.55 for C; 3.44 for O; 2.19 for P; 2.18 for As) the oxidation state of the X atom in the (R₂XO₂)⁻ anion can be identified, so that X is P^{V} or As^{V}. Preferably, the (R₂XO₂)⁻ anions are present in the noble metal-oxo clusters of the present invention in the form of bidentate ligands, in particular the bidentate (R₂XO₂)⁻ groups are bonded via each of the two oxygen atoms; more preferably, the bidentate (R₂XO₂)⁻ groups are bonded to two different atoms via each of the two oxygen atoms, respectively, i.e., each of the two oxygen atoms of the bidentate (R₂XO₂)⁻ anion is bonded to a different atom.

Preferably, in the noble metal-oxo clusters of the present invention all X are the same. In one preferred embodiment, all X are P. In another preferred embodiment, all X are As. In the alternative, in one particular embodiment all X are selected from mixtures of P and As.

Preferably, in the noble metal-oxo clusters of the present invention all (R₂XO₂) groups are the same. In one preferred embodiment, all (R₂XO₂) groups are the same and each R is independently selected from the group consisting of substituted or unsubstituted hydrocarbyl. In another preferred embodiment, all (R₂XO₂) groups are the same and one R per (R₂XO₂) group is hydrogen while the other R is selected from the group consisting of substituted or unsubstituted hydrocarbyl. In another preferred embodiment, all (R₂XO₂) groups are not the same and each R is independently selected from the group consisting of substituted or unsubstituted hydrocarbyl. In an alternative embodiment, all (R₂XO₂) groups are not the same and in at least one (R₂XO₂) group both R are hydrogen. In another alternative embodiment, all (R₂XO₂) groups are the same and in all (R₂XO₂) groups both R are hydrogen, i.e., in this alternative embodiment all R are hydrogen.

Preferably, in the noble metal-oxo clusters of the present invention each R, that is substituted or unsubstituted hydrocarbyl, i.e., each R that is not hydrogen, is a radical that is selected from the group consisting of unsubstituted or substituted alkyl, unsubstituted or substituted cycloalkyl, unsubstituted or substituted alkenyl, unsubstituted or substituted cycloalkenyl, unsubstituted or substituted alkynyl, and unsubstituted or substituted aryl, preferably unsubstituted or substituted alkyl, unsubstituted or substituted cycloalkyl, and unsubstituted or substituted aryl, more preferably unsubstituted or substituted alkyl and unsubstituted or substituted aryl, more preferably unsubstituted or substituted alkyl, more preferably an unsubstituted or substituted C₁-C₆ alkyl, more preferably an unsubstituted or substituted C₁-C₄ alkyl, most preferably an unsubstituted or substituted alkyl selected from —CH₃, —C₂H₅, -nC₃H₇, -iC₃H₇ and -tC₄H₉. In one preferred embodiment, each R that is not hydrogen is selected from the group consisting of unsubstituted alkyl, unsubstituted cycloalkyl, unsubstituted alkenyl, unsubstituted cycloalkenyl, unsubstituted alkynyl, and unsubstituted aryl, preferably unsubstituted alkyl, unsubstituted cycloalkyl, and unsubstituted aryl, more preferably unsubstituted alkyl and unsubstituted aryl, more preferably unsubstituted alkyl, more preferably an unsubstituted C₁-C₆ alkyl, more preferably an unsubstituted C₁-C₄ alkyl, most preferably an unsubstituted alkyl selected from —CH₃, —C₂H₅, -nC₃H₇, -iC₃H₇ and -tC₄H₉. In another preferred embodiment, all R are the same and selected from the group consisting of unsubstituted or substituted alkyl, unsubstituted or substituted cycloalkyl, unsubstituted or substituted alkenyl, unsubstituted or substituted cycloalkenyl, unsubstituted or substituted alkynyl, and unsubstituted or substituted aryl, preferably unsubstituted or substituted alkyl, unsubstituted or substituted cycloalkyl, and unsubstituted or substituted aryl, more preferably unsubstituted or substituted alkyl and unsubstituted or substituted aryl, more preferably unsubstituted or substituted alkyl, more preferably an unsubstituted or substituted C₁-C₆ alkyl, more preferably an unsubstituted or substituted C₁-C₄ alkyl, most preferably an unsubstituted or substituted alkyl selected from —CH₃, —C₂H₅, -nC₃H₇, -iC₃H₇ and -tC₄H₉. In another preferred embodiment, all R are the same and selected from the group consisting of unsubstituted alkyl, unsubstituted cycloalkyl, unsubstituted alkenyl, unsubstituted cycloalkenyl, unsubstituted alkynyl, and unsubstituted aryl, preferably unsubstituted alkyl, unsubstituted cycloalkyl, and unsubstituted aryl, more preferably unsubstituted alkyl and unsubstituted aryl, more preferably unsubstituted alkyl, more preferably an unsubstituted C₁-C₆ alkyl, more preferably an unsubstituted C₁-C₄ alkyl, most preferably an unsubstituted alkyl selected from —CH₃, —C₂H₅, -nC₃H₇, -iC₃H₇ and -tC₄H₉. Each of said R that is substituted can be substituted with one or more moieties X″ which can be the same or different. In a first aspect, said moieties X″ can be selected from the group consisting of halogens, in particular F, Cl, Br or I, more particularly F or Cl, resulting in groups such as —CF₃ or —CH₂Cl. In a second aspect, said moieties X″ can be selected from the group consisting of —CN, —C(O)OR², —C(O)R², and —C(O)NR²R³, each of R² and R³ being selected from the group consisting of H, alkyl, alkenyl, alkynyl, aryl, heteroaryl, cycloalkyl, and heterocycloalkyl, especially H or C₁-C₆ alkyl, such as H or C₁-C₄ alkyl. In a third aspect, said moieties X″ can be bonded to the radical via an oxygen atom, said moieties X″ being selected from the group consisting of —OR², —O(SO₂)R², —O(SO)R², —O(SO₂)OR², —O(SO)OR², —OS(O₂)NR²R³, —OS(O)NR²R³, —OPO(OR²)₂, —OPO(OR²)OR³, —OPO(R²)OR³, —OC(O)R², —OC(O)NR²R³ and —OC(O)OR²; in particular —OR², —O(SO₂)R², —O(SO₂)OR², —OS(O₂)NR²R³, —OPO(OR²)₂, —OC(O)R², —OC(O)NR²R³ and —OC(O)OR²; more particularly —OR², —O(SO₂)R², —OC(O)R², —OC(O)NR²R³ and —OC(O)OR², wherein R² and R³ are independently selected from the group consisting of H, alkyl, alkenyl, alkynyl, aryl, heteroaryl, cycloalkyl, and heterocycloalkyl, especially H or C₁-C₆ alkyl, such as H or C₁-C₄ alkyl. In a fourth aspect, said moieties X″ can be bonded to the radical via a sulfur atom, said moieties X″ being selected from the group consisting of —SO₃R², —SR², —S(O₂)R², —S(O)R², —S(O)OR², —S(O)NR²R³ and —S(O₂)NR²R³; in particular —SO₃R², —SR², —S(O₂)R² and —S(O₂)NR²R³; more particularly —SR² and —S(O₂)R², wherein R² and R³ are independently selected from the group consisting of H, alkyl, alkenyl, alkynyl, aryl, heteroaryl, cycloalkyl, and heterocycloalkyl, especially H or C₁-C₆ alkyl, such as H or C₁-C₄ alkyl. In a fifth aspect, said moieties X″ can be bonded to the radical via an X atom (i.e., a P or As atom), said moieties X″ being selected from the group consisting of —XOR²R³, —X(R²)S(O₂)R³, —X(R²)S(O₂)XR³R⁴, —X(R²)S(O₂)OR³, —X(R²)S(O)R³, —X(R²)S(O)XR³R⁴, —X(R²)S(O)OR³, —X(R²)XO(OR³)₂, —X(R²)XO(OR³)OR⁴, —X(R²)XO(R³)OR⁴, —X(R²)C(O)R³, —X(R²)C(O)OR³ and —X(R²)C(O)XR³R⁴; in particular —XOR²R³, —X(R²)S(O₂)XR³R⁴, —X(R²)S(O)R³, —X(R²)S(O)OR³, —X(R²)XO(OR³)₂, —X(R²)XO(R³)OR⁴, —X(R²)C(O)R³, —X(R²)C(O)OR³ and —X(R²)C(O)XR³R⁴; more particularly —XOR²R³, —X(R²)S(O)R³, —X(R²)XO(OR³)₂, —X(R²)C(O)R³, and —X(R²)C(O)XR³R⁴, wherein R², R³ and R⁴ are independently selected from the group consisting of H, alkyl, alkenyl, alkynyl, aryl, heteroaryl, cycloalkyl, and heterocycloalkyl, especially H or C₁-C₆ alkyl, such as H or C₁-C₄ alkyl. In particular, in case said moieties X″ are —X(R)O₂-containing moieties one noble metal-oxo clusters of the present invention can be linked to one or more other noble metal-oxo clusters of the present invention through such an additional —X(R)O₂ group, in particular a —(X(R)O₂)⁻ group. In a sixth aspect, said moieties X″ can be bonded to the radical via a nitrogen atom, said moieties X″ being selected from the group consisting of —NR²R³, —N(R²)S(O₂)R³, —N(R²)S(O₂)NR³R⁴, —N(R²)S(O₂)OR³, —N(R²)S(O)R³, —N(R²)S(O)NR³R⁴, —N(R²)S(O)OR³, —N(R²)PO(OR³)₂, —N(R²)PO(OR³)OR⁴, —N(R²)PO(R³)OR⁴, —N(R²)C(O)R³, —N(R²)C(O)OR³, —N(R²)C(O)NR³R⁴ and —NO₂; in particular —NR²R³, —N(R²)S(O₂)R³, —N(R²)S(O₂)NR³R⁴, —N(R²)S(O₂)OR³, —N(R²)PO(OR³)₂, —N(R²)C(O)R³, —N(R²)C(O)OR³, —N(R²)C(O)NR³R⁴ and —NO₂; more particularly —NR²R³, —N(R²)S(O₂)R³, —N(R²)C(O)R³, —N(R²)C(O)OR³ and —N(R²)C(O)NR³R⁴, wherein R², R³ and R⁴ are independently selected from the group consisting of H, alkyl, alkenyl, alkynyl, aryl, heteroaryl, cycloalkyl, and heterocycloalkyl, especially H or C₁-C₆ alkyl, such as H or C₁-C₄ alkyl. If a radical is substituted with more than one moiety X″, said moieties X″ can be the same or different and can be independently selected from the first, second, third, fourth, fifth and sixth aspects as defined above

In a preferred embodiment each R may be the same or different and is selected from the group consisting of a hydrogen atom and alkyl, aryl, heteroaryl, cycloalkyl, heterocycloalkyl, and combinations thereof, preferably alkyl, aryl, and cycloalkyl, wherein preferably no more than one R is hydrogen per (R₂XO₂) group.

In a very preferred embodiment each R may be the same or different and is selected from the group consisting of a hydrogen atom and a radical which is covalently bonded to X of the (R₂XO₂) group, wherein each R that is not hydrogen provides a carbon atom for coordination to X, wherein each R that is not hydrogen is alkyl, and wherein preferably no more than one R is hydrogen per (R₂XO₂) group.

As used herein, “alkyl” represents a straight or branched aliphatic hydrocarbon group with 1 to about 20 carbon atoms. Preferred alkyl groups contain 1 to about 12 carbon atoms. More preferred alkyl groups contain 1 to about 6 carbon atoms such as 1 to about 4 carbon atoms. Non-limiting examples of suitable alkyl groups include methyl, ethyl, n-propyl, isopropyl and t-butyl. “Alkenyl” represents a straight or branched aliphatic hydrocarbon group containing at least one carbon-carbon double bond and having 2 to about 15 carbon atoms. Preferred alkenyl groups have 2 to about 12 carbon atoms; and more preferably 2 to about 4 carbon atoms. Non-limiting examples of suitable alkenyl groups include ethenyl, propenyl and 2-butenyl. “Alkynyl” represents a straight or branched aliphatic hydrocarbon group containing at least one carbon-carbon triple bond and having 2 to about 15 carbon atoms. Preferred alkynyl groups have 2 to about 12 carbon atoms; and more preferably 2 to about 4 carbon atoms. Non-limiting examples of suitable alkynyl groups include ethynyl, propynyl, 2-butynyl and 3-methylbutynyl. “Aryl” represents an aromatic monocyclic or multicyclic ring system comprising about 6 to about 14 carbon atoms, preferably about 6 to about 10 carbon atoms. Non-limiting examples of suitable aryl groups include phenyl and naphthyl. “Heteroaryl” represents an aromatic monocyclic or multicyclic ring system comprising about 5 to about 14 ring atoms, preferably about 5 to about 10 ring atoms, in which one or more of the ring atoms is an element other than carbon, for example, nitrogen, oxygen or sulfur, alone or in combination. Preferred heteroaryls contain about 5 to about 6 ring atoms. Non-limiting examples of suitable heteroaryls include pyridyl, pyrazinyl, furanyl, thienyl, pyrimidinyl, pyridine (including N-substituted pyridones), isoxazolyl, isothiazolyl, oxazolyl, thiazolyl, pyrazolyl, furazanyl, pyrrolyl, pyrazolyl, triazolyl, 1,2,4-thiadiazolyl, pyrazinyl, pyridazinyl, quinoxalinyl, phthalazinyl, oxindolyl, imidazo[1,2-a]pyridinyl, imidazo[2,1-b]thiazolyl, benzo-furazanyl, indolyl, azaindolyl, benzimidazolyl, benzothienyl, quinolinyl, imidazolyl, thieno-pyridyl, quinazolinyl, thienopyrimidyl, pyrrolopyridyl, imidazopyridyl, isoquinolinyl, benzo-azaindolyl, 1,2,4-triazinyl, benzothiazolyl and the like. “Cycloalkyl” represents a non-aromatic mono- or multicyclic ring system comprising 3 to about 10 carbon atoms, preferably about 5 to about 10 carbon atoms. Preferred cycloalkyl rings contain about 5 to about 7 ring atoms. Non-limiting examples of suitable monocyclic cycloalkyls include cyclopropyl, cyclopentyl, cyclohexyl, cycloheptyl and the like. Non-limiting examples of suitable multicyclic cycloalkyls include 1-decalinyl, norbornyl, adamantyl and the like, as well as partially saturated species such as, for example, indanyl, tetrahydronaphthyl and the like. “Heterocycloalkyl” represents a non-aromatic saturated monocyclic or multicyclic ring system comprising 3 to about 10 ring atoms, preferably about 5 to about 10 ring atoms, in which one or more of the atoms in the ring system is an element other than carbon, for example, nitrogen, oxygen or sulfur, alone or in combination. Preferred heterocycloalkyls contain about 5 to about 6 ring atoms. Non-limiting examples of suitable monocyclic heterocycloalkyl rings include piperidyl, pyrrolidinyl, piperazinyl, morpholinyl, thiomorpholinyl, thiazolidinyl, 1,4-dioxanyl, tetrahydrofuranyl, tetrahydrothiophenyl, lactam, lactone, and the like. “Arylalkyl” represents an aryl-alkyl-group in which the aryl and alkyl are as previously described. Non-limiting examples of suitable arylalkyl groups include benzyl, 2-phenethyl and naphthalenylmethyl. In the context of the present invention, when R is arylalkyl, the bond between the arylalkyl radical and the C atom of the carboxylate group COO is through a carbon atom of the alkyl part of the arylalkyl radical. Likewise, when R is selected from “cycloalkylalkyl”, “heterocycloalkylalkyl” and “heteroarylalkyl”, these radicals are bound to the C atom of the carboxylate group COO via a carbon atom of their alkyl part.

In the context of the present invention, R can for instance be selected from H, —CH₃, —C₂H₅, —C₃H₇, —C₄H₉, —C₆H₅, —CH₂COOH, —CH₂NH₂, —CH₂CH₂COOH, —CH₂CH₂Cl, —CH₂CH₂CH(NH₂)COOH, -(p-C₆H₄NH₂), -(p-C₆H₄NO₂), -(p-C₆H₄OH) or 3-nitro-4-hydroxyphenyl. In an especially preferred embodiment, R is selected from the group consisting of H and alkyl groups containing 1 to 6 carbon atoms, preferably from H and alkyl groups containing 1 to 4 carbon atoms, more preferably from H, —CH₃, —C₂H₅, -nC₃H₇, -iC₃H₇ and -tC₄H₉, such as —CH₃.

Preferably, in the noble metal-oxo clusters of the present invention z is 8 to 96, preferably 8 to 90, more preferably z is 8 to 72, more preferably z is 8 to 48, and most preferably z is 8 to 32. In the alternative, z is 8 to 96, preferably 24 to 92, more preferably z is 36 to 90, even more preferably z is 54 to 86, and most preferably z is 60 to 82. In particular z is 8, 10, 12, 16, 18, 20, 22, 24, 26, 28, 30, 32, 34, 36, 40, 44, 48, 52, 54, 60, 62, 64, 66, 68, 70, 72, 74, 76, 78, 80, 82, 84, 86, 88, 90, 92, 94 or 96; more particularly z is 8, 10, 12, 14, 16, 18, 20, 22, 24, 26, 28, 30, 32, 36, 40, 44, 48, 54, 60, 66, 72, 84 or 90, more particularly z is 8, 12, 16, 20, 24, 28, 32, 36, 40 or 48, most particularly z is 8, 16 or 24.

In one embodiment, in the noble metal-oxo clusters of the present invention all (OR′) groups are the same. In one preferred embodiment, all (OR′) groups are the same and each R′ is selected from the group consisting of a proton, monovalent cations of Li, Na, K, Rb and Cs, ammonium, guanidinium, tetraalkylammonium, protonated aliphatic amines and protonated aromatic amines, preferably a proton, monovalent cations of Li, Na, and K, ammonium, tetraalkylammonium, protonated aliphatic amines and protonated aromatic amines, more preferably a proton, monovalent cations of Li, Na and K. In a particularly preferred embodiment, each R′ is a proton, i.e., all (OR′) groups are (OH) groups. In another embodiment, in the noble metal-oxo clusters of the present invention all (OR′) groups are not the same. In one preferred embodiment, all (OR′) groups are not the same and each R′ is independently selected from the group consisting of a proton, monovalent cations of Li, Na, K, Rb and Cs, ammonium, guanidinium, tetraalkylammonium, protonated aliphatic amines and protonated aromatic amines, preferably a proton, monovalent cations of Li, Na, and K, ammonium, tetraalkylammonium, protonated aliphatic amines and protonated aromatic amines, more preferably a proton, monovalent cations of Li, Na and K.

Preferably, in the noble metal-oxo clusters of the present invention x is 2 to 48, preferably x is 4 to 44, more preferably x is 4 to 40, more preferably x is 6 to 36, more preferably x is 6 to 30, and most preferably x is 8 to 24; in particular x is 2, 4, 6, 8, 10, 12, 14, 16, 18, 20, 22, 24, 26, 28, 30, 32, 34, 36, 38, 40, 42, 44, 46 or 48, more particularly x is 2, 4, 6, 8, 10, 12, 14, 16, 18, 20, 22, 24, 26, 28, 30, 32, 36, 40, 44 or 48, more particularly x is 4, 6, 8, 10, 12, 16, 18, 20, 24, 28 or 32, most particularly x is 8, 12 or 16.

Preferably, in the noble metal-oxo clusters of the present invention y is 2 to 48, preferably y is 4 to 44, more preferably y is 4 to 40, more preferably y is 6 to 36, more preferably y is 6 to 30, and most preferably y is 8 to 24; in particular y is 2, 4, 6, 8, 10, 12, 14, 16, 18, 20, 22, 24, 26, 28, 30, 32, 34, 36, 38, 40, 42, 44, 46 or 48, more particularly y is 4, 6, 8, 10, 12, 14, 16, 18, 20, 22, 24, 26, 28, 30, 32, 36, 40, 44 or 48, more particularly y is 6, 8, 12, 16, 18, 20, 24, 32 or 36, most particularly y is 8, 12, 16 or 24.

In a preferred embodiment, q is 0. In another preferred embodiment, in which q is at least 1, with the proviso that x+q≤48, q is a number from 1 to 46, preferably q is a number from 1 to 36, more preferably q is a number from 1 to 24, more preferably q is a number from is 1 to 16, most preferably q is a number from is 1 to 8. In another preferred embodiment, in which q is at least 1, q is 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 34, 36, 38, 40, 42, 44 or 46, in particular q is 1, 2, 3, 4, 5, 6, 7, 8, 9, 10, 11, 12, 14, 16, 18, 20, 22, 24, 26, 28, 30, 32, 34, 36, 38, 40, 42, 44 or 46, more particularly q is 1, 2, 3, 4, 5, 6, 7, 8, 9, 10, 11, 12, 14, 16, 18, 20, 24, 28 or 32, most particularly q is 1, 2, 3, 4, 5, 6, 7 or 8.

In one embodiment, in which q is at least 1, each X′ is independently selected from the group consisting of monovalent anions of F, Cl, Br, I, CN, N₃, CP, FHF, SH, SCN, NCS, SeCN, CNO, NCO and OCN, preferably F, Cl, Br, I, CN, and N₃, more preferably Cl, Br, I and N₃, more preferably Cl, Br and I, most preferably Cl. In one preferred embodiment, in which q is at least 2, all X′ are the same and selected from the group consisting of monovalent anions of F, Cl, Br, I, CN, N₃, CP, FHF, SH, SCN, NCS, SeCN, CNO, NCO and OCN, preferably F, Cl, Br, I, CN, and N₃, more preferably Cl, Br, I and N₃, more preferably Cl, Br and I, most preferably Cl. In another preferred embodiment, in which q is at least 2, all X′ are not the same and selected from the group consisting of monovalent anions of F, Cl, Br, I, CN, N₃, CP, FHF, SH, SCN, NCS, SeCN, CNO, NCO and OCN, preferably F, Cl, Br, I, CN, and N₃, more preferably Cl, Br, I and N₃, more preferably Cl, Br and I, most preferably Cl and Br.

Preferably, in the noble metal-oxo clusters [Mₛ(R₂XO₂)_{z}(OR′)ₓO_{y}X′_{q}] according to the present invention the s M atoms form an Mₛ noble metal core unit, in which the individual M atoms are linked by the x (i.e., 2 to 48) groups (OR′), preferably the x (i.e., 2 to 48) (OR′)⁻ anions, they (i.e., 2 to 48) atoms O, preferably they (i.e., 2 to 48) O²⁻ oxy anions, and the q (i.e., 0 to 46) anions (X′), preferably the q (i.e., 0 to 46) monovalent (X′)⁻ anions. The peripheral noble metal atoms M of the Mₛ noble metal core unit are preferably capped by the z (i.e., 8 to 96) groups (R₂XO₂), preferably the z (i.e., 8 to 96) bidentate (R₂XO₂)⁻ anions. The preferred bidentate (R₂XO₂)⁻ capping groups are bonded to the peripheral noble metal atoms M of the Mₛ noble metal core unit via each of their two oxygen atoms, i.e., the two oxygen atoms of the bidentate (R₂XO₂)⁻ capping groups are directed towards the Mₛ noble metal core unit while the two R groups point from the Mₛ noble metal core unit. Thus, in other words, the R groups of the (R₂XO₂) capping groups, preferably the bidentate (R₂XO₂)⁻ capping groups, define the outside margin (outside surface) of the noble metal-oxo clusters [Mₛ(R₂XO₂)_{z}(OR′)ₓO_{y}X′_{q}] according to the present invention.

The noble metal-oxo clusters of the present invention are neutral irrespective of whether they are protonated or deprotonated, i.e., partially deprotonated or fully deprotonated. In the protonated state in the noble metal-oxo cluster [Mₛ(R₂XO₂)_{z}(OR′)ₓO_{y}X′_{q}] each R′ is a proton ([Mₛ(R₂XO₂)_{z}(OH′)ₓO_{y}X′_{q}]), i.e., with regard to the above-discussed preferred variants each of the (μ₂-OR′)⁻ anions is a (μ₂-OH)⁻ hydroxyl anion. In the fully deprotonated state in the noble metal-oxo cluster [Mₛ(R₂XO₂)_{z}(OR′)ₓO_{y}X′_{q}] each R′ is a monovalent cation and not a proton, i.e., with regard to the above-discussed preferred variants none of the (μ₂-OR′)⁻ anions contains a proton as all R′ are monovalent cations (R′)⁺. In the partially deprotonated state in the noble metal-oxo cluster [Mₛ(R₂XO₂)_{z}(OR′)ₓO_{y}X′_{q}] at least one 1st R′ is a proton and at least one 2^{nd} R′ is a monovalent cation and not a proton, i.e., with regard to the above-discussed preferred variants at least one 1^{st} (μ₂-OR′)⁻ anion is a (μ₂-OH)⁻ hydroxyl anion and at least one 2^{nd} (μ₂-OR′)⁻ anion does not contain a proton but a monovalent cation (R′)⁺. The present inventors found that the preferred noble metal-oxo clusters [Mₛ(R₂XO₂)_{z}(OR′)ₓO_{y}X′_{q}] according to the present invention may be converted from the protonated state via the partially deprotonated state to the fully deprotonated and vice versa by changing the pH of the surrounding medium, i.e., protonation may be affected by decreasing the pH while deprotonation may be affected by increasing the pH. Depending on the nature of the individual R′ moieties, the distance between the O and the R′ in the (OR′) moieties may vary. In some cases the distance between the O and the R′ in the (OR′) moieties is larger than the calculated distance based on the known standard bond length and/or ionic radius data. However, as described above, the O atoms of the (OR′) moieties are preferably located within the Mₛ noble metal core unit and all individual R′ moieties are located within the boundaries of the noble metal-oxo clusters [Mₛ(R₂XO₂)_{z}(OR′)ₓO_{y}X′_{q}] according to the present invention as defined by the R groups as described above, too, such that the noble metal-oxo clusters of the present invention are neutral overall.

Thus, in a preferred embodiment, the invention relates to a noble metal-oxo cluster [Mₛ(R₂XO₂)_{z}(OR′)ₓO_{y}X′_{q}], wherein all M are independently selected from the group consisting of Pd and Pt, all X are independently selected from the group consisting of P and As, all R are independently selected from the group consisting of unsubstituted or substituted alkyl and unsubstituted or substituted aryl, each R′ is independently selected from the group consisting of a proton and a monovalent cation of Li, Na and K, and all X′ are independently selected from the group consisting of monovalent anions of Cl, Br, I and N₃, wherein s is 12 to 84, z is 8 to 72, y is 6 to 36, x is 6 to 36 and q is 0 to 24.

Thus, in a preferred embodiment, the invention relates to a noble metal-oxo cluster [Mₛ(R₂XO₂)_{z}(OR′)ₓO_{y}X′_{q}], wherein all M are the same and selected from the group consisting of Pd and Pt.

Thus, in a preferred embodiment, the invention relates to a noble metal-oxo cluster [Mₛ(R₂XO₂)_{z}(OR′)ₓO_{y}X′_{q}], wherein all M are not the same and selected from the group consisting of Pd and Pt.

Thus, in a preferred embodiment, the invention relates to a noble metal-oxo cluster [Mₛ(R₂XO₂)_{z}(OR′)ₓO_{y}X′_{q}], wherein all M are Pd.

Thus, in a preferred embodiment, the invention relates to a noble metal-oxo cluster [Mₛ(R₂XO₂)_{z}(OR′)ₓO_{y}X′_{q}], wherein all X are As.

Thus, in a preferred embodiment, the invention relates to a noble metal-oxo cluster [Mₛ(R₂XO₂)_{z}(OR′)ₓO_{y}X′_{q}], wherein all M are Pd and all X are As.

Thus, in a preferred embodiment, the invention relates to a noble metal-oxo cluster [Mₛ(R₂XO₂)_{z}(OR′)ₓO_{y}X′_{q}], wherein all R are independently selected from the group consisting of unsubstituted or substituted C₁-C₄ alkyl.

Thus, in a preferred embodiment, the invention relates to a noble metal-oxo cluster [Mₛ(R₂XO₂)_{z}(OR′)ₓO_{y}X′_{q}], wherein all R are the same and selected from the group consisting of unsubstituted or substituted C₁-C₄ alkyl.

Thus, in a preferred embodiment, the invention relates to a noble metal-oxo cluster [Mₛ(R₂XO₂)_{z}(OR′)ₓO_{y}X′_{q}], wherein all M are Pd, all X are As and all R are independently selected from the group consisting of unsubstituted or substituted C₁-C₄ alkyl.

Thus, in a preferred embodiment, the invention relates to a noble metal-oxo cluster [Mₛ(R₂XO₂)_{z}(OR′)ₓO_{y}X′_{q}], wherein all X are As and all R are independently selected from the group consisting of unsubstituted or substituted C₁-C₄ alkyl.

Thus, in a preferred embodiment, the invention relates to a noble metal-oxo cluster [Mₛ(R₂XO₂)_{z}(OR′)ₓO_{y}X′_{q}], wherein all M are Pd, all X are As and all R are independently selected from the group consisting of unsubstituted or substituted C₁-C₄ alkyl.

Thus, in a preferred embodiment, the invention relates to a noble metal-oxo cluster [Mₛ(R₂XO₂)_{z}(OR′)ₓO_{y}X′_{q}], wherein all M are the same and selected from the group consisting of Pd and Pt, all X are the same and selected from the group consisting of P and As, all R are the same and selected from the group consisting of unsubstituted or substituted alkyl and unsubstituted or substituted aryl, each R′ is independently selected from the group consisting of a proton and a monovalent cation of Li, Na and K, and all X′ are the same and selected from the group consisting of monovalent anions of Cl, Br, I and N₃, wherein s is 12 to 84, z is 8 to 72, y is 6 to 36, x is 6 to 36 and q is 0 to 24.

Thus, in a preferred embodiment, the invention relates to a noble metal-oxo cluster [Mₛ(R₂XO₂)_{z}(OR′)ₓO_{y}X′_{q}], wherein all M are Pd, all X are As, all R are the same and selected from the group consisting of unsubstituted or substituted alkyl, each R′ is a proton, and all X′ are monovalent anions of Cl, wherein s is 8 to 48, z is 8 to 72, y is 6 to 30, x is 6 to 30 and q is 0 to 16.

Thus, in a preferred embodiment, the invention relates to a noble metal-oxo cluster [Mₛ(R₂XO₂)_{z}(OR′)ₓO_{y}X′_{q}], wherein all M are Pd, all X are As, all R are the same and selected from the group consisting of unsubstituted or substituted C₁-C₆ alkyl, and each R′ is a proton, wherein s is 8 to 48, z is 8 to 72, y is 6 to 30, x is 6 to 30 and q is 0.

Thus, in a preferred embodiment, the invention relates to a noble metal-oxo cluster [Mₛ(R₂XO₂)_{z}(OR′)ₓO_{y}X′_{q}], wherein all M are the same and selected from the group consisting of Pd and Pt, all X are the same and selected from the group consisting of P and As, all R are the same and selected from the group consisting of unsubstituted or substituted alkyl and unsubstituted or substituted aryl, and each R′ is independently selected from the group consisting of a proton and a monovalent cation of Li, Na and K, wherein s is 12 to 84, z is 8 to 72, y is 6 to 36, x is 6 to 36 and q is 0.

Thus, in a preferred embodiment, the invention relates to a noble metal-oxo cluster [Mₛ(R₂XO₂)_{z}(OR′)ₓO_{y}X′_{q}], wherein all M are Pd, all X are As, all R are the same and selected from the group consisting of unsubstituted or substituted alkyl, and each R′ is a proton, wherein s is 8 to 48, z is 8 to 72, y is 6 to 30, x is 6 to 30 and q is 0.

Thus, in a preferred embodiment, the invention relates to a noble metal-oxo cluster [Mₛ(R₂XO₂)_{z}(OR′)ₓO_{y}X′_{q}], wherein all M are Pd, all X are As, all R are the same and selected from the group consisting of unsubstituted or substituted C₁-C₄ alkyl, and each R′ is a proton, wherein s is 16 to 54, z is 8 to 32, y is 8 to 24, x is 8 to 24 and q is 0.

Suitable examples of noble metal-oxo clusters according to the invention are represented by the formulae

[Mₛ(R₂XO₂)_{z}(OR′)ₓO_{y}X′_{q}], e.g.,

[Pdₛ(R₂XO₂)_{z}(OR′)ₓO_{y}X′_{q}], such as

[Pdₛ(R₂XO₂)_{z}(OR′)ₓO_{y}],

[Pdₛ(R₂AsO₂)_{z}(OR′)ₓO_{y}X′_{q}],

[Pdₛ(R₂PO₂)_{z}(OR′)ₓO_{y}X′_{q}],

[Pd₁₆(R₂XO₂)_{z}(OR′)ₓO_{y}X′_{q}],

[Pdₛ(R₂XO₂)_{z}(OH)ₓO_{y}X′_{q}],

[Pdₛ(R₂XO₂)₁₆(OR′)ₓO_{y}X′_{q}],

[Mₛ(R₂AsO₂)_{z}(OR′)ₓO_{y}X′_{q}], such as

[Mₛ(R₂AsO₂)_{z}(OR′)ₓO_{y}],

[Pdₛ(R₂AsO₂)_{z}(OR′)ₓO_{y}X′_{q}],

[M₂₄(R₂AsO₂)_{z}(OR′)ₓO_{y}X′_{q}],

[Mₛ(R₂AsO₂)_{z}(OH)ₓO_{y}X′_{q}],

[Ptₛ(R₂AsO₂)_{z}(OR′)ₓO_{y}X′_{q}],

[Mₛ(R₂AsO₂)_{z}(OR′)ₓO₂₄X′_{q}],

[Mₛ(R₂XO₂)_{z}(OH)ₓO_{y}X′_{q}], such as

[Mₛ(R₂XO₂)_{z}(OH)ₓO_{y}],

[Mₛ(R₂XO₂)_{z}(OH)₈O_{y}X′_{q}],

[Mₛ(R₂XO₂)₁₆(OH)ₓO_{y}X′_{q}],

[Pdₛ(R₂XO₂)_{z}(OH)ₓO_{y}X′_{q}],

[Mₛ(R₂PO₂)_{z}(OH)ₓO_{y}X′_{q}],

[Irₛ(R₂XO₂)_{z}(OH)ₓO_{y}X′_{q}],

[Ptₛ(R₂XO₂)_{z}(OR′)ₓO_{y}X′_{q}], such as

[Ptₛ(R₂XO₂)_{z}(OR′)ₓO_{y}],

[Ptₛ(R₂AsO₂)_{z}(OR′)ₓO_{y}X′_{q}],

[Ptₛ(R₂XO₂)_{z}(OH)ₓO_{y}X′_{q}],

[Ptₛ(R₂XO₂)₈(OR′)ₓO_{y}X′_{q}],

[Ptₛ(R₂XO₂)₁₆(OR′)ₓO_{y}X′_{q}],

[Ptₛ(R₂XO₂)_{z}(OR′)₁₆O_{y}X′_{q}],

[Mₛ(R₂PO₂)_{z}(OR′)ₓO_{y}X′_{q}], such as

[Mₛ(R₂PO₂)_{z}(OR′)ₓO_{y}],

[Pdₛ(R₂PO₂)_{z}(OR′)ₓO_{y}X′_{q}],

[Mₛ(R₂PO₂)_{z}(OH)ₓO_{y}X′_{q}],

[Mₛ(R₂PO₂)_{z}(OR′)ₓO₂₄X′_{q}],

[Mₛ(R₂PO₂)₁₆(OR′)ₓO_{y}X′_{q}],

[Mₛ(R₂PO₂)₈(OR′)ₓO_{y}X′_{q}],

[Mₛ((CH₃)₂XO₂)_{z}(OR′)ₓO_{y}X′_{q}], such as

[Mₛ((CH₃)₂XO₂)_{z}(OR′)ₓO_{y}],

[Pdₛ((CH₃)₂XO₂)_{z}(OR′)ₓO_{y}X′_{q}],

[Rhₛ((CH₃)₂XO₂)_{z}(OR′)ₓO_{y}X′_{q}],

[Mₛ((CH₃)₂XO₂)₈(OR′)ₓO_{y}X′_{q}],

[Mₛ((CH₃)₂XO₂)₁₆(OR′)ₓO_{y}X′_{q}],

[M₂₄((CH₃)₂XO₂)_{z}(OR′)ₓO_{y}X′_{q}],

[Mₛ(Ph₂XO₂)_{z}(OR′)ₓO_{y}X′_{q}], such as

[Mₛ(Ph₂XO₂)_{z}(OR′)ₓO_{y}],

[Mₛ(Ph₂XO₂)₈(OR′)ₓO_{y}X′_{q}],

[Mₛ(Ph₂XO₂)_{z}(OR′)₈O_{y}X′_{q}],

[Mₛ(Ph₂XO₂)_{z}(OR′)ₓO₂₄X′_{q}],

[Pdₛ(Ph₂XO₂)_{z}(OR′)ₓO_{y}X′_{q}],

[Ptₛ(Ph₂XO₂)_{z}(OR′)ₓO_{y}X′_{q}],

[Mₛ(R₂XO₂)_{z}(OR′)ₓO_{y}Cl_{q}], such as

[Pdₛ(R₂XO₂)_{z}(OR′)ₓO_{y}Cl_{q}],

[Mₛ(R₂AsO₂)_{z}(OR′)ₓO_{y}Cl_{q}],

[Mₛ(R₂PO₂)_{z}(OR′)ₓO_{y}Cl_{q}],

[Mₛ(R₂XO₂)ₓ(OH)ₓO_{y}Cl_{q}],

[Mₛ(R₂XO₂)_{z}(OR′)ₓO₈Cl_{q}],

[Mₛ(R₂XO₂)_{z}(OR′)ₓO₁₂Cl_{q}],

[M₁₆(R₂XO₂)_{z}(OR′)ₓO_{y}X′_{q}], such as

[M₁₆(R₂XO₂)_{z}(OR′)ₓO_{y}],

[M₁₆(R₂XO₂)_{z}(OR′)ₓO₁₂X′_{q}],

[Pd₁₆(R₂XO₂)_{z}(OR′)ₓO_{y}X′_{q}],

[Pt₁₆(R₂XO₂)_{z}(OR′)ₓO_{y}X′_{q}],

[M₁₆(R₂AsO₂)_{z}(OR′)ₓO_{y}X′_{q}],

[M₁₆(R₂XO₂)ₓ(OH)ₓO_{y}X′_{q}],

[M₂₄(R₂XO₂)_{z}(OR′)ₓO_{y}X′_{q}], such as

[M₂₄(R₂XO₂)_{z}(OR′)ₓO_{y}],

[M₂₄(R₂XO₂)_{z}(OR′)ₓO_{y}X′₃],

[M₂₄(R₂XO₂)_{z}(OR′)ₓO_{y}Cl_{q}],

[M₂₄(R₂XO₂)_{z}(OH)ₓO_{y}X′_{q}],

[M₂₄(R₂AsO₂)_{z}(OR′)ₓO_{y}X′_{q}],

[M₂₄(R₂XO₂)_{z}(OR′)ₓO_{y}(N₃)_{q}],

[M₄₀(R₂XO₂)_{z}(OR′)ₓO_{y}X′_{q}], such as

[M₄₀(R₂XO₂)_{z}(OR′)ₓO_{y}],

[M₄₀(R₂AsO₂)_{z}(OR′)ₓO_{y}X′_{q}],

[Pd₄₀(R₂XO₂)_{z}(OR′)ₓO_{y}X′_{q}],

[Ag₄₀(R₂XO₂)_{z}(OR′)ₓO_{y}X′_{q}],

[M₄₀(R₂PO₂)_{z}(OR′)ₓO_{y}X′_{q}],

[M₄₀(R₂XO₂)_{z}(OR′)₁₆O_{y}X′_{q}].

The invention also includes solvates of the present noble metal-oxo clusters. A solvate is an association of solvent molecules with a noble metal-oxo cluster. Preferably, water is associated with the noble metal-oxo clusters and thus, the noble metal-oxo clusters according to the invention can in particular be represented by the formulae

[Mₛ(R₂XO₂)_{z}(OR′)ₓO_{y}X′_{q}]·w(H₂O), e.g.

[Mₛ(R₂XO₂)_{z}(OR′)ₓO_{y}]·w(H₂O),

wherein
M, R, X, R′, X′, q, s, x, y and z are the same as defined above, and
w represents the number of attracted water molecules per noble metal-oxo cluster [Mₛ(R₂XO₂)_{z}(OR′)ₓO_{y}X′_{q}], and ranges from 1 to 240, preferably from 8 to 200, more preferably from 10 to 180, most preferably from 12 to 150.

Preferably, the w H₂O molecules are positioned outside of the noble metal-oxo cluster. However, it is also possible that some of the w H₂O molecules are located within the noble metal-oxo cluster.

Suitable examples of the noble metal-oxo cluster solvates according to the invention are represented by the formulae

[Mₛ(R₂XO₂)_{z}(OR′)ₓO_{y}X′_{q}]·w(H₂O), e.g.,

[Pdₛ(R₂XO₂)_{z}(OR′)ₓO_{y}X′_{q}]·w(H₂O), such as

[Pdₛ(R₂XO₂)_{z}(OR′)ₓO_{y}]·w(H₂O),

[Pdₛ(R₂AsO₂)_{z}(OR′)ₓO_{y}X′_{q}]·w(H₂O),

[Pdₛ(R₂PO₂)_{z}(OR′)ₓO_{y}X′_{q}]·w(H₂O),

[Pd₁₆(R₂XO₂)_{z}(OR′)ₓO_{y}X′_{q}]·w(H₂O),

[Pdₛ(R₂XO₂)_{z}(OH)ₓO_{y}X′_{q}]·w(H₂O),

[Pdₛ(R₂XO₂)₁₆(OR′)ₓO_{y}X′_{q}]·w(H₂O),

[Mₛ(R₂AsO₂)_{z}(OR′)ₓO_{y}X′_{q}]·w(H₂O), such as

[Mₛ(R₂AsO₂)_{z}(OR′)ₓO_{y}]·w(H₂O),

[Pdₛ(R₂AsO₂)_{z}(OR′)ₓO_{y}X′_{q}]·w(H₂O),

[M₂₄(R₂AsO₂)_{z}(OR′)ₓO_{y}X′_{q}]·w(H₂O),

[Mₛ(R₂AsO₂)_{z}(OH)ₓO_{y}X′_{q}]·w(H₂O),

[Ptₛ(R₂AsO₂)_{z}(OR′)ₓO_{y}X′_{q}]·w(H₂O),

[Mₛ(R₂AsO₂)_{z}(OR′)ₓO₂₄X′_{q}]·w(H₂O),

[Mₛ(R₂XO₂)_{z}(OH)ₓO_{y}X′_{q}]·w(H₂O), such as

[Mₛ(R₂XO₂)_{z}(OH)ₓO_{y}]·w(H₂O),

[Mₛ(R₂XO₂)_{z}(OH)₈O_{y}X′_{q}]·w(H₂O),

[Mₛ(R₂XO₂)₁₆(OH)ₓO_{y}X′_{q}]·w(H₂O),

[Pdₛ(R₂XO₂)_{z}(OH)ₓO_{y}X′_{q}]·w(H₂O),

[Mₛ(R₂PO₂)_{z}(OH)ₓO_{y}X′_{q}]·w(H₂O),

[Irₛ(R₂XO₂)_{z}(OH)ₓO_{y}X′_{q}]·w(H₂O),

[Ptₛ(R₂XO₂)_{z}(OR′)ₓO_{y}X′_{q}]·w(H₂O), such as

[Ptₛ(R₂XO₂)_{z}(OR′)ₓO_{y}]·w(H₂O),

[Ptₛ(R₂AsO₂)_{z}(OR′)ₓO_{y}X′_{q}]·w(H₂O),

[Ptₛ(R₂XO₂)_{z}(OH)ₓO_{y}X′_{q}]·w(H₂O),

[Ptₛ(R₂XO₂)₈(OR′)ₓO_{y}X′_{q}]·w(H₂O),

[Ptₛ(R₂XO₂)₁₆(OR′)ₓO_{y}X′_{q}]·w(H₂O),

[Ptₛ(R₂XO₂)_{z}(OR′)₁₆O_{y}X′_{q}]·w(H₂O),

[Mₛ(R₂PO₂)_{z}(OR′)ₓO_{y}X′_{q}]·w(H₂O), such as

[Mₛ(R₂PO₂)_{z}(OR′)ₓO_{y}]·w(H₂O),

[Pdₛ(R₂PO₂)_{z}(OR′)ₓO_{y}X′_{q}]·w(H₂O),

[Mₛ(R₂PO₂)_{z}(OH)ₓO_{y}X′_{q}]·w(H₂O),

[Mₛ(R₂PO₂)_{z}(OR′)ₓO₂₄X′_{q}]·w(H₂O),

[Mₛ(R₂PO₂)₁₆(OR′)ₓO_{y}X′_{q}]·w(H₂O),

[Mₛ(R₂PO₂)₈(OR′)ₓO_{y}X′_{q}]·w(H₂O),

[Mₛ((CH₃)₂XO₂)_{z}(OR′)ₓO_{y}X′_{q}]·w(H₂O), such as

[Mₛ((CH₃)₂XO₂)_{z}(OR′)ₓO_{y}]·w(H₂O),

[Pdₛ((CH₃)₂XO₂)_{z}(OR′)ₓO_{y}X′_{q}]·w(H₂O),

[Rhₛ((CH₃)₂XO₂)_{z}(OR′)ₓO_{y}X′_{q}]·w(H₂O),

[Mₛ((CH₃)₂XO₂)₈(OR′)ₓO_{y}X′_{q}]·w(H₂O),

[Mₛ((CH₃)₂XO₂)₁₆(OR′)ₓO_{y}X′_{q}]·w(H₂O),

[M₂₄((CH₃)₂XO₂)_{z}(OR′)ₓO_{y}X′_{q}]·w(H₂O),

[Mₛ(Ph₂XO₂)_{z}(OR′)ₓO_{y}X′_{q}]·w(H₂O), such as

[Mₛ(Ph₂XO₂)_{z}(OR′)ₓO_{y}]·w(H₂O),

[Mₛ(Ph₂XO₂)₈(OR′)ₓO_{y}X′_{q}]·w(H₂O),

[Mₛ(Ph₂XO₂)_{z}(OR′)₈O_{y}X′_{q}]·w(H₂O),

[Mₛ(Ph₂XO₂)_{z}(OR′)ₓO₂₄X′_{q}]·w(H₂O),

[Pdₛ(Ph₂XO₂)_{z}(OR′)ₓO_{y}X′_{q}]·w(H₂O),

[Ptₛ(Ph₂XO₂)_{z}(OR′)ₓO_{y}X′_{q}]·w(H₂O),

[Mₛ(R₂XO₂)_{z}(OR′)ₓO_{y}Cl_{q}]·w(H₂O), such as

[Pdₛ(R₂XO₂)_{z}(OR′)ₓO_{y}Cl_{q}]·w(H₂O),

[Mₛ(R₂AsO₂)_{z}(OR′)ₓO_{y}Cl_{q}]·w(H₂O),

[Mₛ(R₂PO₂)_{z}(OR′)ₓO_{y}Cl_{q}]·w(H₂O),

[Mₛ(R₂XO₂)_{z}(OH)ₓO_{y}Cl_{q}]·w(H₂O),

[Mₛ(R₂XO₂)_{z}(OR′)ₓO₈Cl_{q}]·w(H₂O),

[Mₛ(R₂XO₂)_{z}(OR′)ₓO₁₂Cl_{q}]·w(H₂O),

[M₁₆(R₂XO₂)OR′)ₓO_{y}X′_{q}]·w(H₂O), such as

[M₁₆(R₂XO₂)OR′)ₓO_{y}]·w(H₂O),

[M₁₆(R₂XO₂)OR′)ₓO₁₂X′_{q}]·w(H₂O),

[Pd₁₆(R₂XO₂)_{z}(OR′)ₓO_{y}X′_{q}]·w(H₂O),

[Pt₁₆(R₂XO₂)_{z}(OR′)ₓO_{y}X′_{q}]·w(H₂O),

[M₁₆(R₂AsO₂)_{z}(OR′)ₓO_{y}X′_{q}]·w(H₂O),

[M₁₆(R₂XO₂)_{z}(OH)ₓO_{y}X′_{q}]·w(H₂O),

[M₂₄(R₂XO₂)OR′)ₓO_{y}X′_{q}]·w(H₂O), such as

[M₂₄(R₂XO₂)_{z}(OR′)ₓO_{y}]·w(H₂O),

[M₂₄(R₂XO₂)_{z}(OR′)ₓO_{y}X′_{q}]·w(H₂O),

[M₂₄(R₂XO₂)_{z}(OR′)ₓO_{y}Cl_{q}]·w(H₂O),

[M₂₄(R₂XO₂)_{z}(OH)ₓO_{y}X′_{q}]·w(H₂O),

[M₂₄(R₂AsO₂)OR′)ₓO_{y}X′_{q}]·w(H₂O),

[M₂₄(R₂XO₂)_{z}(OR′)ₓO_{y}(N₃)_{q}]·w(H₂O),

[M₄₀(R₂XO₂)OR′)ₓO_{y}X′_{q}]·w(H₂O), such as

[M₄₀(R₂XO₂)_{z}(OR′)ₓO_{y}]·w(H₂O),

[M₄₀(R₂AsO₂)_{z}(OR′)ₓO_{y}X′_{q}]·w(H₂O),

[Pd₄₀(R₂XO₂)_{z}(OR′)ₓO_{y}X′_{q}]·w(H₂O),

[Ag₄₀(R₂XO₂)_{z}(OR′)ₓO_{y}X′_{q}]·w(H₂O),

[M₄₀(R₂PO₂)OR′)ₓO_{y}X′_{q}]·w(H₂O),

[M₄₀(R₂XO₂)OR′)₁₆O_{y}X′_{q}]·w(H₂O).

The invention also includes aggregates of the present noble metal-oxo clusters. An aggregate is an association of additional chemical entities with a noble metal-oxo cluster. Preferably, the additional chemical entities associated with the noble metal-oxo clusters are selected from the group of neutral entities A and thus, the noble metal-oxo clusters according to the invention can in particular be represented by the formulae

[Mₛ(R₂XO₂)_{z}(OR′)ₓO_{y}X′_{q}]·w′(A), e.g.

[Mₛ(R₂XO₂)_{z}(OR′)ₓO_{y}]·w′(A),

wherein
M, R, X, R′, X′, q, s, x, y and z are the same as defined above,
each A is a neutral entity that is attracted to the noble metal-oxo cluster [Mₛ(R₂XO₂)_{z}(OR′)ₓO_{y}X′_{q}], in particular the structure and composition of the neutral entities A is such that they are capable of linking individual noble metal-oxo clusters [Mₛ(R₂XO₂)_{z}(OR′)ₓO_{y}X′_{q}] to each other in the solid state, and
w represents the number of attracted water molecules per noble metal-oxo cluster [Mₛ(R₂XO₂)_{z}(OR′)ₓO_{y}X′_{q}], and ranges from 1 to 240, preferably from 8 to 200, more preferably from 10 to 180, most preferably from 12 to 150.

In general, the neutral entities A may be selected from a broad range of chemical compounds. The chemical structure of the neutral entities A is such that they can interact with present noble metal-oxo clusters. Preferably, this interaction is such that the neutral entities A link individual noble metal-oxo clusters [Mₛ(R₂XO₂)_{z}(OR′)ₓO_{y}X′_{q}] to each other, in particular in the solid state. The interaction can for example be of covalent, ionic, coordinative, dipole-dipole, H-bonding, π-bonding or van der Waals nature. Preferably, the neutral entities A are not commonly used as solvent. Preferably, the neutral entities A are in the solid form as pure material under standard conditions (temperature of 273.15 K (0° C., 32° F.) and an absolute pressure of exactly 10⁵ Pa (100 kPa, 1 bar)). Non-limiting examples of suitable neutral entities A are organic acids and derivatives including carboxylic acids and derivatives thereof, such as carboxylic acid esters and carboxylic acid salts, like Na(CH₃COO), organophosphorus and organoarsenic compounds including phosphinic and arsinic acids and derivatives thereof, like Na(CH₃)₂PO₂ and Na(CH₃)₂AsO₂, and Si-containing compounds including silicates such as tungstosilicates, like Na₄(SiW₁₂O₄₀). In particular, the noble metal-oxo cluster aggregates according to the invention may contain one or more neutral entities A, i.e., all A may be the same or all A may be selected individually. In particular, the noble metal-oxo cluster aggregates according to the invention may be obtained by co-crystallization of the noble metal-oxo clusters and neutral entities A.

Suitable examples of the noble metal-oxo cluster aggregates according to the invention are represented by the formulae

[Mₛ(R₂XO₂)_{z}(OR′)ₓO_{y}X′_{q}]·w′(A), e.g.,

[Pdₛ(R₂XO₂)_{z}(OR′)ₓO_{y}X′_{q}]·w′(A), such as

[Pdₛ(R₂XO₂)_{z}(OR′)ₓO_{y}]·w′(Na(CH₃)₂AsO₂),

[Pdₛ(R₂AsO₂)_{z}(OR′)ₓO_{y}X′_{q}]·w′(A),

[Pdₛ(R₂PO₂)_{z}(OR′)ₓO_{y}X′_{q}]·w′(A),

[Pd₁₆(R₂XO₂)_{z}(OR′)ₓO_{y}X′_{q}]·w′(Na(CH₃)₂AsO₂),

[Pdₛ(R₂XO₂)_{z}(OH)ₓO_{y}X′_{q}]·w′(A),

[Pdₛ(R₂XO₂)₁₆(OR′)ₓO_{y}X′_{q}]·w′(A),

[Mₛ(R₂AsO₂)_{z}(OR′)ₓO_{y}X′_{q}]·w′(A), such as

[Mₛ(R₂AsO₂)_{z}(OR′)ₓO_{y}]·w′(Na(CH₃)₂AsO₂),

[Pdₛ(R₂AsO₂)_{z}(OR′)ₓO_{y}X′_{q}]·w′(A),

[M₂₄(R₂AsO₂)_{z}(OR′)ₓO_{y}X′_{q}]·w′(Na(CH₃COO)),

[Mₛ(R₂AsO₂)_{z}(OH)ₓO_{y}X′_{q}]·w′(A),

[Ptₛ(R₂AsO₂)_{z}(OR′)ₓO_{y}X′_{q}]·w′(Na(CH₃)₂AsO₂),

[Mₛ(R₂AsO₂)_{z}(OR′)ₓO₂₄X′_{q}]·w′(A),

[Mₛ(R₂XO₂)_{z}(OH)ₓO_{y}X′_{q}]·w′(A), such as

[Mₛ(R₂XO₂)_{z}(OH)ₓO_{y}]·w′(A),

[Mₛ(R₂XO₂)_{z}(OH)₈O_{y}X′_{q}]·w′(A),

[Mₛ(R₂XO₂)₁₆(OH)ₓO_{y}X′_{q}]·w′(Na(CH₃COO)),

[Pdₛ(R₂XO₂)_{z}(OH)ₓO_{y}X′_{q}]·w′(A),

[Mₛ(R₂PO₂)_{z}(OF)ₓO_{y}X′_{q}]·w′(Na(CH₃)₂AsO₂),

[Irₛ(R₂XO₂)_{z}(OH)ₓO_{y}X′_{q}]·w′(Na₄(SiW₁₂O₄₀))

[Ptₛ(R₂XO₂)_{z}(OR′)ₓO_{y}X′_{q}]·w′(A), such as

[Ptₛ(R₂XO₂)_{z}(OR′)ₓO_{y}]·w′(A),

[Ptₛ(R₂AsO₂)_{z}(OR′)ₓO_{y}X′_{q}]·w′(A),

[Ptₛ(R₂XO₂)_{z}(OH)ₓO_{y}X′_{q}]·w′(A),

[Ptₛ(R₂XO₂)₈(OR′)ₓO_{y}X′_{q}]·w′(Na₄(SiW₁₂O₄₀)),

[Ptₛ(R₂XO₂)₁₆(OR′)ₓO_{y}X′_{q}]·w′(A),

[Ptₛ(R₂XO₂)_{z}(OR′)₁₆O_{y}X′_{q}]·w′(A),

[Mₛ(R₂PO₂)_{z}(OR′)ₓO_{y}X′_{q}]·w′(A), such as

[Mₛ(R₂PO₂)_{z}(OR′)ₓO_{y}]·w′(Na(CH₃)₂AsO₂),

[Pdₛ(R₂PO₂)_{z}(OR′)ₓO_{y}X′_{q}]·w′(A),

[Mₛ(R₂PO₂)_{z}(OF)ₓO_{y}X′_{q}]·w′(Na(CH₃)₂AsO₂),

[Mₛ(R₂PO₂)_{z}(OR′)ₓO₂₄X′_{q}]·w′(Na(CH₃COO)),

[Mₛ(R₂PO₂)₁₆(OR′)ₓO_{y}X′_{q}]·w′(A),

[Mₛ(R₂PO₂)₈(OR′)ₓO_{y}X′_{q}]·w′(A),

[Mₛ((CH₃)₂XO₂)_{z}(OR′)ₓO_{y}X′_{q}]·w′(A), such as

[Mₛ((CH₃)₂XO₂)_{z}(OR′)ₓO_{y}]·w′(A),

[Pdₛ((CH₃)₂XO₂)_{z}(OR′)ₓO_{y}X′_{q}]·w′(Na₄(SiW₁₂O₄₀)),

[Rhₛ((CH₃)₂XO₂)_{z}(OR′)ₓO_{y}X′_{q}]·w′(A),

[Mₛ((CH₃)₂XO₂)₈(OR′)ₓO_{y}X′_{q}]·w′(Na(CH₃COO)),

[Mₛ((CH₃)₂XO₂)₁₆(OR′)ₓO_{y}X′_{q}]·w′(A),

[M₂₄((CH₃)₂XO₂)_{z}(OR′)ₓO_{y}X′_{q}]·w′(A),

[Mₛ(Ph₂XO₂)_{z}(OR′)ₓO_{y}X′_{q}]·w′(A), such as

[Mₛ(Ph₂XO₂)_{z}(OR′)ₓO_{y}]·w′(A),

[Mₛ(Ph₂XO₂)₈(OR′)ₓO_{y}X′_{q}]·w′(Na₄(SiW₁₂O₄₀))

[Mₛ(Ph₂XO₂)_{z}(OR′)₈O_{y}X′_{q}]·w′(A),

[Mₛ(Ph₂XO₂)_{z}(OR′)ₓO₂₄X′_{q}]·w′(Na₄(SiW₁₂O₄₀)),

[Pdₛ(Ph₂XO₂)_{z}(OR′)ₓO_{y}X′_{q}]·w′(A),

[Ptₛ(Ph₂XO₂)_{z}(OR′)ₓO_{y}X′_{q}]·w′(A),

[Mₛ(R₂XO₂)_{z}(OR′)ₓO_{y}Cl_{q}]·w′(A), such as

[Pdₛ(R₂XO₂)_{z}(OR′)ₓO_{y}Cl_{q}]·w′(A),

[Mₛ(R₂AsO₂)_{z}(OR′)ₓO_{y}Cl_{q}]·w′(Na(CH₃)₂AsO₂),

[Mₛ(R₂PO₂)_{z}(OR′)ₓO_{y}Cl_{q}]·w′(A),

[Mₛ(R₂XO₂)_{z}(OH)ₓO_{y}Cl_{q}]·w′(Na(CH₃COO)),

[Mₛ(R₂XO₂)_{z}(OR′)ₓO₈Cl_{q}]·w′(A),

[Mₛ(R₂XO₂)_{z}(OR′)ₓO₁₂Cl_{q}]·w′(A),

[M₁₆(R₂XO₂)_{z}(OR′)ₓO_{y}X′_{q}]·w′(A), such as

[M₁₆(R₂XO₂)_{z}(OR′)ₓO_{y}]·w′(A),

[M₁₆(R₂XO₂)_{z}(OR′)ₓO₁₂X′_{q}]·w′(Na(CH₃)₂AsO₂),

[Pd₁₆(R₂XO₂)_{z}(OR′)ₓO_{y}X′_{q}]·w′(A),

[Pt₁₆(R₂XO₂)_{z}(OR′)ₓO_{y}X′_{q}]·w′(Na₄(SiW₁₂O₄₀)),

[M₁₆(R₂AsO₂)_{z}(OR′)ₓO_{y}X′_{q}]·w′(A),

[M₁₆(R₂XO₂)_{z}(OH)ₓO_{y}X′_{q}]·w′(A),

[M₂₄(R₂XO₂)_{z}(OR′)ₓO_{y}X′_{q}]·w′(A), such as

[M₂₄(R₂XO₂)_{z}(OR′)ₓO_{y}]·w′(A),

[M₂₄(R₂XO₂)_{z}(OR′)ₓO_{y}X′₃]·w′(A),

[M₂₄(R₂XO₂)_{z}(OR′)ₓO_{y}Cl_{q}]·w′(Na₄(SiW₁₂O₄₀)),

[M₂₄(R₂XO₂)_{z}(OH)ₓO_{y}X′_{q}]·w′(Na(CH₃)₂AsO₂),

[M₂₄(R₂AsO₂)_{z}(OR′)ₓO_{y}X′_{q}]·w′(A),

[M₂₄(R₂XO₂)_{z}(OR′)ₓO_{y}(N₃)_{q}]·w′(A),

[M₄₀(R₂XO₂)_{z}(OR′)ₓO_{y}X′_{q}]·w′(A), such as

[M₄₀(R₂XO₂)_{z}(OR′)ₓO_{y}]·w′(A),

[M₄₀(R₂AsO₂)_{z}(OR′)ₓO_{y}X′_{q}]·w′(A),

[Pd₄₀(R₂XO₂)_{z}(OR′)ₓO_{y}X′_{q}]·w′(Na(CH₃COO)),

[Ag₄₀(R₂XO₂)_{z}(OR′)ₓO_{y}X′_{q}]·w′(A),

[M₄₀(R₂PO₂)_{z}(OR′)ₓO_{y}X′_{q}]·w′(Na₄(SiW₁₂O₄₀)

[M₄₀(R₂XO₂)_{z}(OR′)₁₆O_{y}X′_{q}]·w′(A).

The invention also includes solvates of the aggregates of the present noble metal-oxo clusters. A solvate is an association of solvent molecules with an aggregate of a present noble metal-oxo cluster. Preferably, water is associated with the aggregate of the noble metal-oxo cluster and thus, the aggregate of the noble metal-oxo cluster according to the invention can in particular be represented by the formulae

[Mₛ(R₂XO₂)_{z}(OR′)ₓO_{y}X′_{q}]·w(H₂O)·w′(A), e.g.

[Mₛ(R₂XO₂)_{z}(OR′)ₓO_{y}]·w(H₂O)·w′(A),

wherein
M, R, X, R′, X′, A, q, s, w, w′, x, y and z are the same as defined above.

In a preferred embodiment, a proportion of the w water molecules, if present at all, is not directly attached to the noble metal-oxo cluster by coordination but rather indirectly by hydrogen-bonding as water of crystallization. Thus, in a preferred embodiment, the attracted w water molecules, if present at all, possibly exhibit weak interactions by hydrogen bonding to protons and/or cations (R′)⁺ of the noble metal-oxo cluster and/or the attracted water molecules, if present at all, are water of crystallization and/or are coordinated to M cations and/or are coordinated to A entities, if present at all.

In an especially preferred embodiment, the noble metal-oxo clusters provided by the present invention are in a solution-stable form. The noble metal-oxo clusters of the present invention can also be in the form crystals, e.g., in the form of primary and/or secondary particles. In an especially preferred embodiment, the noble metal-oxo clusters provided by the present invention are mainly in the form of primary particles (i.e., non-agglomerated primary particles), that is at least 90 wt % of the noble metal-oxo clusters are in the form of primary particles, preferably at least 95 wt %, more preferably at least 99 wt %, in particular substantially all the noble metal-oxo clusters particles are in the form of primary particles.

The noble metal atoms M in the noble metal core unit cannot be replaced or removed without destroying the structural framework of the noble metal-containing oxo cluster of the present invention, once the noble metal core unit framework is formed.

The diameter of the noble metal-oxo cluster primary particles of the present invention has been found to be about 1.5 nm to 2 nm as determined by single-crystal X-ray diffraction analysis.

Specific examples of structures of specific noble metal-oxo clusters of the present invention are also illustrated in FIGS. 3, 6, 9 to 12 and 15.

In comparison to most known noble metal-containing oxo clusters, the present noble metal-oxo clusters are characterized in that at least a significant proportion of the metal atom positions of the oxo clusters is occupied by noble metal atoms selected from Rh, Ir, Pd, Pt, Ag, Au, and mixtures thereof. This is surprising as noble-metal-containing oxo clusters are notoriously difficult to prepare. Firstly, 4d and 5d transition metals, like noble metals, are generally less reactive than 3d transition metals. Secondly, late transition metals, like noble metals, are generally less oxophilic than early transition metals. The latter aspect is already evident from the respective assignment of the chemical elements in question within the Pearson acid-base concept (also known as HSAB concept). Negatively charged oxygen forms hard bases, whereas the noble metals as late 4d and 5d transition metals constitute soft acids when being positively charged. In contrast, positively charged early transition metals, in particular early 3d transition metals, are hard acids and, thus, react faster and form stronger bonds with the hard base oxygen, i.e., are highly oxophilic as opposed to noble metals. For this reason many, if not most, of the known oxo clusters contain early transition metals, in particular early 3d transition metals, contrary to the present oxo clusters.

Furthermore, in contrast to commonly used noble metal catalysts, including the few known metal-containing oxo clusters, the present noble metal-oxo clusters are further characterized in that they show a unique combination of (i) exceptionally high catalytic activity and the (ii) exceptionally high versatility.

While the inventors do not wish to be bound by any particular theory, it is believed that the exceptionally high catalytic activity of the present noble metal-oxo clusters resides in their unique structure. More specifically, it is believed that the exceptionally high catalytic activity of the noble metal-oxo clusters of the present invention is linked to their increased nuclearity, as compared to the few known metal-containing oxo clusters, in combination with their high content of noble metal atoms, based on the overall metal content. In this context, it is believed that primarily due to the presence of the noble metal species used therein, noble metal-containing metal-oxo clusters show catalytic activity, i.e., the catalytic activity is imparted to the noble metal-containing metal-oxo clusters by the noble metal species. Thus, in order to obtain suitable activities it may be desirable to have a high number of noble metal species per noble metal-containing metal-oxo cluster. However, despite the recent developments as summarized above most of the few known noble metal-containing metal-oxo clusters have low noble metal contents and/or show low nuclearity. In comparison, the noble metal-oxo clusters of the present invention have increased nuclearity in combination with a high content of noble metal atoms based on the overall metal content, i.e., the noble metal-oxo clusters of the present invention have a high number of noble metal atoms per cluster. Thus, without wishing to be bound by any theory, the present inventors believe that the exceptionally high catalytic activity of the present noble metal-oxo clusters is linked to the exceptionally high number of noble metal atoms per cluster according to the present invention.

As to the exceptionally high nuclearity of the present noble metal-oxo clusters, without wishing to be bound by any theory, the present inventors believe that the higher nuclearity is linked to the unique bidentate (R₂XO₂) capping groups used in the present noble metal-oxo clusters. Most of the known metal-containing oxo clusters use tridentate capping groups, in particular of the (XO₄) or (RXO₃) type. While the inventors do not wish to be bound by any particular theory, it is believed that reducing the denticity of the capping groups from tridentate to bidentate increases the propensity of incorporating increased numbers of bridging hydroxy anions (μ₂-OH)⁻ and oxy anions (μ₄-O)²⁻ to occupy the metal binding sites no longer occupied by the capping group. Furthermore, typically the negative charge of the tridentate capping groups used in most of the known metal-containing oxo clusters is higher than the negative charge of the bidentate (R₂XO₂) capping groups used in the present noble metal-oxo clusters. Thus, in using bidentate (R₂XO₂) capping groups instead of the conventional tridentate capping groups the overall negative charge of the capping groups per cluster is reduced. In order to compensate for the reduced negative charge of the capping groups, the propensity of incorporating increased numbers of negatively charged bridging hydroxy groups (μ₂-OH)⁻ and oxy groups (μ₄-O)²⁻ is further enhanced for the present noble metal-oxo clusters. Thus, without wishing to be bound by any theory it is believed that the use of the bidentate (R₂XO₂) capping groups results in increased numbers of bridging hydroxy anions (μ₂-OH)⁻ and oxy anions (μ₄-O)²⁻ which in turn allow for higher numbers of metal centers to be linked per cluster and, thus, the present noble metal-oxo clusters have exceptionally high nuclearity.

Only very few of the known noble metal-containing oxo clusters have one or more bidentate capping group. Such bidentate capping groups are of the carboxylate type (RCO₂). These carboxylate (RCO₂) capped oxo clusters have been found to be far less stable than the noble metal-oxo clusters of the present invention. While the inventors do not wish to be bound by any particular theory, it is believed that the enhanced stability of the present clusters resides in a stronger bond between the metal centers and the bidentate (R₂XO₂) capping groups as compared with the carboxylate (RCO₂) capping groups. The unique bidentate (R₂XO₂) capping groups used in the present noble metal-oxo clusters have significantly higher pKa values as compared to carboxylate (RCO₂) capping groups. For example, the pKa of dimethylarsinic acid (cacodylic acid) is 6.2, whereas the pKa of benzoic acid is 4.2 and that of acetic acid is 4.75. This means that cacodylate anions are stronger bases and will hence bind more strongly to the metal cations than benzoates or acetates. This results in more stable bond between metal centers and capping groups and, thus, enhanced cluster stability. In particular, higher nuclearity carboxylate (RCO₂) capped oxo clusters have been found rather labile and only obtainable in very yield. The enhanced stability of the noble metal-oxo clusters of the present invention allows for them to be used under a larger number of different conditions rendering the present clusters highly versatile. The present invention therefore further relates to the use of bidentate (R₂XO₂) capping groups as defined above, for instance cacodylate capping groups, for the preparation of noble metal-oxo clusters and metal cluster units, in particular for the preparation of noble metal-oxo clusters and metal cluster units as defined herewith.

In general, the present noble metal-oxo clusters have exceptionally high versatility. In particular, the noble metal-oxo clusters according to the present invention are not only exceptionally stable and broadly applicable under various conditions but their specific properties may be fine-tuned for various specific applications. While the inventors do not wish to be bound by any particular theory, it is believed that this exceptionally high versatility of the present noble metal-oxo clusters resides in their unique structure. More specifically, it is believed that this exceptionally high versatility is linked at least in part to the neutral nature of the noble metal-oxo clusters of the present invention, i.e., the noble metal-oxo clusters of the present invention have an overall neutral charge state as they are neither positively nor negatively charged. As is evident from the above summary of the prior art, known noble metal-containing oxo clusters belong to the class of POMs, i.e., a molecular entity or framework bearing a negative charge which is balanced by cations that are external to the entity or framework. The negative charge largely determines the properties of the known noble metal-containing POMs. This may be beneficial for some applications, such as applications in aqueous solution as the negative charge most likely increases the solubility of the known noble metal-containing metal-oxo clusters in polar solvents like water. However, the noble metal-oxo clusters of the present invention show significantly enhanced solubility in less polar and apolar solvents as compared to known noble metal-containing POMs. Thus, the enhanced solubility of the noble metal-oxo clusters of the present invention makes entirely new applications accessible, i.e., the scope of the applicable solvents and, thus, the polarity of the environment is significantly enhanced. While the inventors do not wish to be bound by any particular theory, it is believed that the enhanced solubility is imparted to the noble metal-oxo clusters of the present invention by their neutral charge state. Furthermore, beyond their low solubility in nonpolar organic solvents, the known noble metal-containing POMs are rather unstable or prone to deactivation under specific conditions. In particular, under these conditions degradation and/or deactivation of the noble metal-oxo clusters of the present invention is less commonly observed. Without wishing to be bound by any theory, it is believed that the improved performance of the noble metal-oxo clusters of the present invention under various conditions is again attributable at least in part to their neutral charge state. The negatively charged known noble metal-containing POMs show high affinity to positively charged entities. The later aspect might lead to increased degradation by reactive positively charged or polar entities or enhanced shielding of active sites by positively charged or polar entities. Thus, the enhanced activity and stability of the noble metal-oxo clusters of the present invention under a larger variety of conditions may be due to the fact that the present neutral clusters are less susceptible to degradation and/or deactivation by charged and/or polar compounds. Thus, in using the noble metal-oxo clusters of the present invention entirely new applications are accessible, i.e., the scope of the applicable conditions is significantly enhanced.

Furthermore, the present inventors observed that the specific properties of the present noble metal-oxo clusters may be fine-tuned for various specific applications which further contributes to their exceptionally high versatility. In particular, the catalytic performance of the present noble metal-oxo clusters may be fine-tuned be adjusting the nature and number of noble metal centers per cluster. Further properties, such as stability, size and solubility, may be fine-tuned by individually adjusting the nature of each R of the unique bidentate (R₂XO₂) capping groups used in the present noble metal-oxo clusters. The nature of the R groups defines the peripheral properties of the present clusters and, thus, determines the interactions of the cluster with its environment. Fine-tuning the cluster properties by carefully selecting each R is particularly efficient when using the bidentate (R₂XO₂) capping groups of the present noble metal-oxo clusters as each capping group contains two R whereas the (RXO₃) type capping group used in most of the known metal-containing oxo clusters as well as carboxylate (RCO₂) capping groups contain only one R per capping group. Group R covalently bonded to X of the bidentate (R₂XO₂) capping group allows for inter alia tuning of (i) the steric and electrostatic parameters on the surface of the noble metal-oxo cluster, and (ii) the solubility properties of the noble metal-oxo cluster ranging from hydrophilic to hydrophobic. Furthermore, if group R is a radical bonded to the X of the bidentate (R₂XO₂) capping group via a carbon atom of said radical and if said radical is further substituted by one or more additional moieties comprising, e.g., a —XRO₂ containing group, a noble metal-oxo cluster can be linked via such a moiety to one or more other the noble metal-oxo clusters, thus, forming chains or networks of the noble metal-oxo clusters.

In another embodiment, the noble metal-oxo clusters of the present invention may be further calcined at a temperature not exceeding the transformation temperature of the noble metal-oxo clusters, i.e. the temperature at which the noble metal-oxo clusters have been proven to be stable (usually at least about 200° C. for the present noble metal-oxo according to their corresponding TGA). Thus, in a preferred embodiment the noble metal-oxo clusters of the present invention are thermally stable up to temperatures of at least about 200° C. For the calcination, common equipment may be used, that is commercially available. Calcination of the noble metal-oxo clusters of the present invention may be conducted under an oxygen containing gas such as air, under vacuum, under hydrogen or under an inert gas such as argon or nitrogen, more preferably under inert gas, most preferably under nitrogen. Calcination may help to activate a noble metal-oxo cluster pre-catalyst by forming active sites. Upon heating, noble metal-oxo clusters loose water molecules (of water of crystallization) before they start to transform/decompose, e.g. by oxidation. TGA can be used to study the weight loss of the noble metal-oxo clusters of the present invention, and Differential Scanning calorimetry (DSC) indicates whether each step is endo- or exothermic. Such measurements may be carried out e.g. under nitrogen gas, air, oxygen or hydrogen.

In many cases, however, and in particular if the noble metal-oxo cluster of the present invention is used as a catalyst or pre-catalyst under reductive conditions, drying of the noble metal-oxo cluster of the present invention without calcination may be sufficient. In other cases calcination might significantly improve the catalytic performance of the noble metal-oxo clusters according the present invention.

In a further embodiment, the noble metal-oxo clusters may be calcined at a temperature exceeding the transformation temperature of the noble metal-oxo cluster, i.e., the temperature at which decomposition of the noble metal-oxo cluster starts to take place (usually about 200° C. for the present noble metal-oxo clusters according to their corresponding TGA). Without being bound by any theory, it is believed that calcination of the noble metal-oxo clusters according to the present invention at a temperature exceeding the transformation temperature of the noble metal-oxo cluster, i.e., above 200° C., and below 800° C. is accompanied by the loss of (R₂XO₂)-based capping groups, as is evident from their corresponding TGA. The removal of (R₂XO₂)-based capping groups from the noble metal-oxo clusters of the present invention increases the accessibility of the noble metal atoms and thus is in many cases a suitable measure to specifically enhance or enable their catalytic activity.

The invention is further directed to a process for preparing noble metal-oxo clusters according to the invention. A process for the preparation of the noble metal-oxo cluster of the invention comprises:
(a) reacting at least one source of M and at least one source of R₂XO₂ and optionally at least one source of X′ to form a noble metal-oxo cluster [Mₛ(R₂XO₂)_{z}(OR′)ₓO_{y}X′_{q}] or a solvate thereof,
(b) optionally adding at least one source of A to the reaction mixture of step (a) to form a noble metal-oxo cluster [Mₛ(R₂XO₂)_{z}(OR′)ₓO_{y}X′_{q}] or a solvate thereof with neutral entities A being attracted to the noble metal-oxo cluster [Mₛ(R₂XO₂)_{z}(OR′)ₓO_{y}X′_{q}] or a solvate thereof, and
(c) recovering the noble metal-oxo cluster or solvate thereof,
wherein M, R, X, R′, X′, q, s, x, y and z are the same as defined above.

In step (a) of said process at least one source of M is used, especially one source of M. Generally, in a preferred embodiment the at least one source of M is a water-soluble salt.

In a preferred embodiment of the present invention as source for the noble metal M atoms can be used Pd^{II} salts such as palladium chloride (PdCl₂), palladium nitrate (Pd(NO₃)₂), palladium acetate (Pd(CH₃COO)₂) and palladium sulphate (PdSO₄); Pt^{II} salts such as potassium tetrachloroplatinate (K₂PtCl₄) and platinum chloride (PtCl₂); Rh^{I} salts such as [(C₆H₅)₃]₂RhCl(CO) and [Rh(CO)₂Cl]₂; Ir^{I} salts such as [(C₆H₅)₃P]₂IrCl(CO), Au^{III} salts such as gold chloride (AuCl₃), or Au sources such as gold hydroxide (Au(OH)₃) and chloroauric acid (HAuCl₄·aq); and API salts preferably generated with oxidizing reagents from Ag^{I} salts such as silver nitrate (AgNO₃), silver fluoride (AgF) and silver chloride (AgCl). More preferably, the Pd source is PdCl₂ or Pd(CH₃COO)₂; the Pt source is K₂PtCl₄.

In a preferred embodiment, in step (a) in the at least one source of M all M are the same, preferably all M are Pd or Pt or Ir or Rh, more preferably all M are Pd or Pt, most preferably all M are Pd.

In a preferred embodiment, in step (a) the at least one source of M comprises at least two different M selected from Pd, Pt, Rh, Ir, Ag and Au, preferably selected from Pd, Pt, Ir and Rh, more preferably selected from Pd, Pt and Rh, most preferably Pd and Pt.

In a preferred embodiment, M is Pt and in step (a) of said process the at least one source of M is K₂PtCl₄.

In a preferred embodiment, M is Pd and in step (a) of said process the at least one source of M is PdCl₂ or Pd(CH₃COO)₂.

In a preferred embodiment, M is Pd and in step (a) of said process the at least one source of M is a mixture of PdCl₂ and Pd(CH₃COO)₂.

In a preferred embodiment, M is a mixture of Pt and Pd and in step (a) of said process the at least one source of M is a mixture of PdCl₂ and K₂PtCl₄ or Pd(CH₃COO)₂ and K₂PtCl₄.

In step (a) of said process the metal source or metal sources are reacted with at least one source of R₂XO₂. For instance, a water-soluble phosphinic acid or arsinic acid or preferably a salt thereof may be used as source of R₂XO₂. It is also possible to use a water-soluble phosphinic acid or arsinic acid ester which hydrolyses under the reaction conditions. In one embodiment of the present invention, suitable examples of sources of R₂XO₂ include R₂PO₂H or R₂AsO₂H or a salt thereof, wherein each R is independently selected from the group consisting of hydrogen and substituted or unsubstituted hydrocarbyl, wherein each hydrocarbyl provides a carbon atom for coordination to X and wherein preferably no more than one R is hydrogen per R₂PO₂H or R₂AsO₂H or salt thereof. In particular, each R, which is substituted or unsubstituted hydrocarbyl, is selected from the group consisting of unsubstituted or substituted alkyl, unsubstituted or substituted cycloalkyl, unsubstituted or substituted alkenyl, unsubstituted or substituted cycloalkenyl, unsubstituted or substituted alkynyl, and unsubstituted or substituted aryl, preferably unsubstituted or substituted alkyl, unsubstituted or substituted cycloalkyl, and unsubstituted or substituted aryl, more preferably unsubstituted or substituted alkyl and unsubstituted or substituted aryl, more preferably unsubstituted or substituted alkyl, more preferably an unsubstituted or substituted C1-C6 alkyl, more preferably an unsubstituted or substituted C1-C4 alkyl, most preferably an unsubstituted or substituted alkyl selected from —CH3, —C2H5, -nC3H7, -iC3H7 and -tC4H9; in particular wherein each R is selected from the group consisting of unsubstituted alkyl, unsubstituted cycloalkyl, unsubstituted alkenyl, unsubstituted cycloalkenyl, unsubstituted alkynyl, and unsubstituted aryl, preferably unsubstituted alkyl, unsubstituted cycloalkyl, and unsubstituted aryl, more preferably unsubstituted alkyl and unsubstituted aryl, more preferably unsubstituted alkyl, more preferably an unsubstituted C1-C6 alkyl, more preferably an unsubstituted C1-C4 alkyl, most preferably an unsubstituted alkyl selected from —CH3, —C2H5, -nC3H7, -iC3H7 and -tC4H9; in particular wherein all R are the same.

In a preferred embodiment, in step (a) the of said process, wherein the solvent contains water, the at least one source of R₂XO₂ is water-soluble, preferably wherein X is P, dimethylphosphinic acid (Me₂PO₂H) or suitable salts thereof, such as Me₂PO₂Li, Me₂PO₂Na, and Me₂PO₂K, diethylphosphinic acid (Et₂PO₂H) or suitable salts thereof, such as Et₂PO₂Li, Et₂PO₂Na, and Et₂PO₂K, diphenylphosphinic acid (Ph₂PO₂H) or suitable salts thereof, such as Ph₂PO₂Li, Ph₂PO₂Na, and Ph₂PO₂K, phenylphosphinic acid (PhHPO₂H) or suitable salts thereof, such as PhHPO₂Li, PhHPO₂Na, PhHPO₂K, bis(trifluoromethyl)phosphinic acid [(CF₃)₂PO₂H] or suitable salts thereof, such as (CF₃)₂PO₂Li, (CF₃)₂PO₂Na, (CF₃)₂PO₂K, dibutylphosphinic acid (Bu₂PO₂H) or suitable salts thereof, such as Bu₂PO₂Li, Bu₂PO₂Na, Bu₂PO₂K, butylmethylphosphinic acid (BuMePO₂H) or suitable salts thereof, such as BuMePO₂Li, BuMePO₂Na, BuMePO₂K, methylphenylphosphinic acid (MePhPO₂H) or suitable salts thereof, such as MePhPO₂Li, MePhPO₂Na, MePhPO₂K, or diarylphosphinic acid (Ar₂PO₂H) or suitable salts thereof, such as Ar₂PO₂Li, Ar₂PO₂Na Ar₂PO₂K, wherein Ar is selected independently from the group consisting of aminophenyl, nitrophenyl or tolyl; and wherein X is As, dimethylarsinic acid (Me₂AsO₂H) or suitable salts thereof, such as Me₂AsO₂Li, Me₂AsO₂Na, and Me₂AsO₂K, diethylarsinic acid (Et₂AsO₂H) or suitable salts thereof, such as Et₂AsO₂Li, Et₂AsO₂Na, and Et₂AsO₂K, diphenylarsinic acid (Ph₂AsO₂H) or suitable salts thereof, such as Ph₂AsO₂Li, Ph₂AsO₂Na, and Ph₂AsO₂K, phenylarsinic acid (PhHAsO₂H) or suitable salts thereof, such as PhHAsO₂Li, PhHAsO₂Na, PhHAsO₂K, bis(trifluoromethyl)arsinic acid [(CF₃)₂AsO₂H] or suitable salts thereof, such as (CF₃)₂AsO₂Li, (CF₃)₂AsO₂Na, (CF₃)₂AsO₂K, dibutylarsinic acid (Bu₂AsO₂H) or suitable salts thereof, such as Bu₂AsO₂Li, Bu₂AsO₂Na, Bu₂AsO₂K, butylmethylarsinic acid (BuMeAsO₂H) or suitable salts thereof, such as BuMeAsO₂Li, BuMeAsO₂Na, BuMeAsO₂K, methylphenylarsinic acid (MePhAsO₂H) or suitable salts thereof, such as MePhAsO₂Li, MePhAsO₂Na, MePhAsO₂K, or diarylarsinic acid (Ar₂AsO₂H) or suitable salts thereof, such as Ar₂AsO₂Li, Ar₂AsO₂Na Ar₂AsO₂K, wherein Ar is selected independently from the group consisting of aminophenyl, nitrophenyl or tolyl.

In an especially preferred embodiment, M is Pd and in step (a) of said process the at least one source of M is PdCl₂ or Pd(CH₃COO)₂. and the at least one source of R₂XO₂ is R₂PO₂H or R₂AsO₂H or a salt thereof.

In an especially preferred embodiment, M is Pd and in step (a) of said process the at least one source of M is PdCl₂ or Pd(CH₃COO)₂. and the at least one source of R₂XO₂ is Me₂PO₂H or Me₂AsO₂H or a salt thereof.

A very preferred embodiment of the present invention is said process, wherein in step (a) the at least one source of R₂XO₂ already comprises one or more of the R′ groups. In particular, the at least one source of R₂XO₂ comprises at least one R₂XO₂R′ species such that the at least one source of R₂XO₂ is capable of contributing to the formation of the (OR′) groups for the noble metal-oxo cluster [Mₛ(R₂XO₂)_{z}(OR′)ₓO_{y}X′_{q}] or a solvate thereof. In particular, each R′ in the at least one R₂XO₂R′ species is independently selected from the group consisting of a proton, monovalent cations of Li, Na or K, ammonium, tetraalkylammonium, protonated aliphatic amines and protonated aromatic amines, more preferably a proton or monovalent cations of Li, Na or K, most preferably a proton. By using a source of R₂XO₂, which comprises R′, the number of reagents and substrates required in the preparation of the respective noble metal-oxo clusters is reduced and thus the synthesis is rendered more efficient and less expensive.

In a preferred embodiment, step (a) of said process is carried out in an aqueous solution. In particular, if any of the starting materials has only a low solubility in water, in particular, if the at least one source of R₂XO₂ has only a low solubility in water (for example, because of the nature of the group R), it is possible to dissolve the at least one source of R₂XO₂ in a small volume of organic solvent and then adding this solution to an aqueous solution of the source of M or vice versa. Examples of suitable organic solvents include, but are not limited to acetonitrile, acetone, toluene, DMF, DMSO, ethanol, methanol, n-butanol, sec-butanol, isobutanol and mixtures thereof. It is also possible to use emulsifying agents to allow the reagents of step (a) of said process to undergo a reaction. In a preferred embodiment, minor amounts of organic solvent, such as, 40 to 0.01 vol % based on the total volume of the reaction mixture, preferably 30 to 0.05 vol %, 20 to 0.1 vol %, 10 to 0.2 vol %, 5 to 0.5 vol % or 3 to 1 vol %, may be added to the aqueous solution.

Furthermore, in a preferred embodiment, the pH of the aqueous solution in step (a) of said process ranges from 3 to 11, preferably from 3.5 to 10.5, more preferably from 4 to 10, and more preferably from 5 to 9. Most preferably, the pH is from about 6 to about 8, for instance from about 6.5 to about 8.0. Generally, in a preferred embodiment of the present invention a buffer solution can be used for maintaining the pH value in a certain range.

In a preferred embodiment of the present invention the buffer is a R₂XO₂-based or at least a R₂XO₂-containing buffer, i.e., a R₂XO₂-containing buffer, preferably from a R₂XO₂-containing starting material, e.g., preferably wherein X is P, dimethylphosphinic acid (Me₂PO₂H) or suitable salts thereof, such as Me₂PO₂Li, Me₂PO₂Na, and Me₂PO₂K, diethylphosphinic acid (Et₂PO₂H) or suitable salts thereof, such as Et₂PO₂Li, Et₂PO₂Na, and Et₂PO₂K, diphenylphosphinic acid (Ph₂PO₂H) or suitable salts thereof, such as Ph₂PO₂Li, Ph₂PO₂Na, and Ph₂PO₂K, phenylphosphinic acid (PhHPO₂H) or suitable salts thereof, such as PhHPO₂Li, PhHPO₂Na, PhHPO₂K, bis(trifluoromethyl)phosphinic acid [(CF₃)₂PO₂H] or suitable salts thereof, such as (CF)₃)₂PO₂Li, (CF₃)₂PO₂Na, (CF₃)₂PO₂K, dibutylphosphinic acid (Bu₂PO₂H) or suitable salts thereof, such as Bu₂PO₂Li, Bu₂PO₂Na, Bu₂PO₂K, butylmethylphosphinic acid (BuMePO₂H) or suitable salts thereof, such as BuMePO₂Li, BuMePO₂Na, BuMePO₂K, methylphenylphosphinic acid (MePhPO₂H) or suitable salts thereof, such as MePhPO₂Li, MePhPO₂Na, MePhPO₂K, or diarylphosphinic acid (Ar₂PO₂H) or suitable salts thereof, such as Ar₂PO₂Li, Ar₂PO₂Na Ar₂PO₂K, wherein Ar is selected independently from the group consisting of aminophenyl, nitrophenyl or tolyl; and wherein X is As, dimethylarsinic acid (Me₂AsO₂H) or suitable salts thereof, such as Me₂AsO₂Li, Me₂AsO₂Na, and Me₂AsO₂K, diethylarsinic acid (Et₂AsO₂H) or suitable salts thereof, such as Et₂AsO₂Li, Et₂AsO₂Na, and Et₂AsO₂K, diphenylarsinic acid (Ph₂AsO₂H) or suitable salts thereof, such as Ph₂AsO₂Li, Ph₂AsO₂Na, and Ph₂AsO₂K, phenylarsinic acid (PhHAsO₂H) or suitable salts thereof, such as PhHAsO₂Li, PhHAsO₂Na, PhHAsO₂K, bis(trifluoromethyl)arsinic acid [(CF₃)₂AsO₂H] or suitable salts thereof, such as (CF₃)₂AsO₂Li, (CF₃)₂AsO₂Na, (CF₃)₂AsO₂K, dibutylarsinic acid (Bu₂AsO₂H) or suitable salts thereof, such as Bu₂AsO₂Li, Bu₂AsO₂Na, Bu₂AsO₂K, butylmethylarsinic acid (BuMeAsO₂H) or suitable salts thereof, such as BuMeAsO₂Li, BuMeAsO₂Na, BuMeAsO₂K, methylphenylarsinic acid (MePhAsO₂H) or suitable salts thereof, such as MePhAsO₂Li, MePhAsO₂Na, MePhAsO₂K, or diarylarsinic acid (Ar₂AsO₂H) or suitable salts thereof, such as Ar₂AsO₂Li, Ar₂AsO₂Na Ar₂AsO₂K, wherein Ar is selected independently from the group consisting of aminophenyl, nitrophenyl or tolyl.

In an especially preferred embodiment, the R₂XO₂-containing buffer comprises the at least one source of R₂XO₂.

A very preferred embodiment of the present invention is said process, wherein in step (a) the buffer already comprises the at least one source of R₂XO and no other at least one source of R₂XO than the buffer is used in step (a). By using a buffer, which comprises the at least one source of R₂XO, the number of reagents and substrates required in the preparation of the respective noble metal-oxo clusters is reduced and thus the synthesis is rendered more efficient and less expensive.

In an especially preferred embodiment, the R₂XO₂-containing buffer comprises the at least one source of R₂XO₂ and the at least one source of R₂XO₂ is R₂PO₂H or R₂AsO₂H or a salt thereof.

In an especially preferred embodiment, the R₂XO₂-containing buffer comprises the at least one source of R₂XO₂ and the at least one source of R₂XO₂ is Me₂PO₂H or Me₂AsO₂H or a salt thereof.

In another embodiment of the present invention the buffer is a carboxylate-based or at least a carboxylate-containing buffer, i.e., a buffer based on a carboxylate-containing material, e.g., HCOOH or a salt thereof such as Na(HCOO) or K(HCOO); or alkyl-COOH or a salt thereof, in particular a C₁-C₆ alkyl-COOH or a salt thereof, more particularly a C₁-C₄ alkyl-COOH or a salt thereof, such as H₃CCOOH, H₃C(H₂C)COOH, H₃C(H₂C)₂COOH, H₃C(H₂C)₃COOH, (H₃C)₂(HC)COOH, (H₃C)₃CCOOH, or a salt thereof. In a preferred embodiment of the present invention the carboxylate-based buffer is a hydrocarbyl-COO-containing buffer derived from hydrocarbyl-COOH, a salt thereof or mixtures thereof. In a more preferred embodiment of the present invention the carboxylate-based buffer is a hydrocarbyl-COO-containing buffer derived from Na(hydrocarbyl-COO) or K(hydrocarbyl-COO), such as Na(CH₃COO) or K(CH₃COO), Na(H₃C(H₂C)COO) or K(H₃C(H₂C)COO), Na(H₃C(H₂C)₂COO) or K(H₃C(H₂C)₂COO), Na(H₃C(H₂C)₃COO) or K(H₃C(H₂C)₃COO), Na((H₃C)₂(HC)COO) or K((H₃C)₂(HC)COO), and Na((H₃C)₃CCOO) or K((H₃C)₃CCOO). In a preferred embodiment of the present invention the carboxylate-based buffer is an acetate buffer derived from any salt or derivative of H₃CCOO⁻, such as Li(H₃CCOO), Na(H₃CCOO), K(H₃CCOO), Mg(H₃CCOO)₂ or mixtures thereof, preferably Li(H₃CCOO), Na(H₃CCOO), K(H₃CCOO), or mixtures thereof, and most preferably Na(H₃CCOO), K(H₃CCOO), or mixtures thereof, in particular K(H₃CCOO)

In another embodiment of the present invention the buffer is a phosphate or acetate buffer or a mixture thereof and preferably said phosphate or acetate buffer is derived from H₃PO₄, NaH₂PO₄, Na₂HPO₄, Na₃PO₄, KH₂PO₄, K₂HPO₄, K₃PO₄, NaKHPO₄, NaK₂PO₄, Na₂KPO₄, Na(CH₃CO₂), K(CH₃CO₂), Mg(CH₃CO₂)₂, Ca(CH₃CO₂)₂, CH₃CO₂H or mixtures thereof, preferably H₃PO₄, NaH₂PO₄, Na₂HPO₄, Na₃PO₄, Na(CH₃CO₂), K(CH₃CO₂), CH₃CO₂H or mixtures thereof, and most preferably NaH₂PO₄, Na₂HPO₄, Na(CH₃CO₂), Li(CH₃CO₂) or mixtures thereof, in particular NaH₂PO₄, Na(CH₃CO₂) or mixtures thereof. It is more preferred to have either a phosphate or an acetate buffer, whereas it is less preferred to have a mixture of phosphate and acetate buffer. In a preferred embodiment of the present invention said phosphate buffer is preferably derived from NaH₂PO₄, whereas said acetate buffer is preferably derived from Li(CH₃CO₂), Na(CH₃CO₂) or mixtures thereof. In a very preferred embodiment of the present invention the buffer is an acetate buffer and is preferably derived from Li(CH₃CO₂), Na(CH₃CO₂) or mixtures thereof is a phosphate buffer, preferably derived from H₃PO₄, NaH₂PO₄, Na₂HPO₄, Na₃PO₄, KH₂PO₄, K₂HPO₄, K₃PO₄, NaKHPO₄, NaK₂PO₄, Na₂KPO₄ or mixtures thereof, preferably H₃PO₄, NaH₂PO₄, Na₂HPO₄, Na₃PO₄ or mixtures thereof, and most preferably NaH₂PO₄, Na₂HPO₄ or mixtures thereof, in particular NaH₂PO₄. It is preferred to have either a phosphate or an acetate buffer, whereas it is less preferred to have a mixture of phosphate and acetate buffer. In a preferred embodiment of the present invention said phosphate buffer is preferably derived from NaH₂PO₄, whereas said acetate buffer is preferably derived from K(CH₃COO).

A very preferred embodiment of the present invention is said process, wherein in step (a) the buffer already comprises one or more of the R′ groups such that the a buffer is capable of contributing to the formation of the (OR′) groups for the noble metal-oxo cluster [Mₛ(R₂XO₂)_{z}(OR′)ₓO_{y}X′_{q}] or a solvate thereof. In particular, the buffer provides a proton, monovalent cations of Li, Na or K, ammonium, tetraalkylammonium, protonated aliphatic amines and protonated aromatic amines, more preferably a proton or monovalent cations of Li, Na or K, most preferably a proton. By using a buffer, which comprises R′, the number of reagents and substrates required in the preparation of the respective noble metal-oxo clusters is reduced and thus the synthesis is rendered more efficient and less expensive.

Generally, in a preferred embodiment of the present invention, additional base solution or acid solution can be used for adjusting the pH to a certain value. It is particularly preferred to use aqueous sodium hydroxide or H₂SO₄ solution having a concentration of 6 M. In another embodiment, the concentration of the aqueous base or acid solution (preferably aqueous sodium hydroxide or H₂SO₄ solution) is from 0.1 to 12 M, preferably 0.2 to 8 M, more preferably from 0.5 to 9 M, most preferably about 1 M. Generally, in a very preferred embodiment of the present invention additional base solution can be used for adjusting the pH to a certain pH value. It is particularly preferred to use aqueous sodium hydroxide solution having a concentration of 6 M. In another embodiment, the concentration of the aqueous base solution (preferably aqueous sodium hydroxide solution) is from 0.1 to 12 M, preferably 0.2 to 9 M, more preferably from 0.5 to 8 M, most preferably about 6 M.

In the context of the present invention the pH of the aqueous solution in step (a) of said process refers to the pH as measured at the end of the reaction. In the preferred embodiment where, e.g., an aqueous sodium hydroxide solution is used for adjusting the pH-value, the pH is measured after the adjustment at the end of the reaction. pH values are at 20° C., and are determined to an accuracy of ±0.05 in accordance with the IUPAC Recommendations 2002 (R. P. Buck et al., Pure Appl. Chem., Vol. 74, No. 11, pp. 2169-2200, 2002).

A suitable and commercially available instrument for pH measurement is the Mettler Toledo FE20 pH meter. The pH calibration is carried out as 2-point calibration using a pH=4.01 standard buffer solution and a pH=7.00 standard buffer solution. The resolutions are: 0.01 pH; 1 mV; and 0.1° C. The limits of error are: ±0.01 pH; ±1 mV; and ±0.5° C.

A very preferred embodiment of the present invention is said process, wherein in step (a) the at least one source of M and at least one source of R₂XO₂ and optionally at least one source of X′ are dissolved in a solution of buffer, preferably an a 0.10 to 5.0 M solution of a buffer, more preferably a 0.12 to 3.0 M solution of a buffer, more preferably a 0.15 to 2.5 M solution of a buffer, and most preferably a 0.20 to 1.5 M solution of a buffer.

In step (a) of said process optionally at least one source of X′ is used, especially one source of X′. Generally, in a preferred embodiment of the present invention, salts of the monovalent anions selected from the group consisting of monovalent anions of F, Cl, Br, I, CN, N₃, CP, FHF, SH, SCN, NCS, SeCN, CNO, NCO and OCN, more preferably F, Cl, Br, I, CN, and N₃, more preferably Cl, Br, I and N₃, most preferably Cl, Br and I, in particular Cl. Preferably the following cations may be used in the salts: Li, Na, K, Rb, Cs, Mg, Ca, Sr, Ba, Sc, Ti, V, Cr, Mn, Fe, Co, Ni, Cu, Zn, Y, Zr, Nb, Mo, Ru, Rh, Pd, Ag, Cd, Hf, Re, Os, Ir, Pt, Au, Hg, lanthanide metal, actinide metal, Al, Ga, In, Tl, Sn, Pb, Sb, Bi, phosphonium, ammonium, guanidinium, tetraalkylammonium, protonated aliphatic amines, protonated aromatic amines or combinations thereof. More preferably lithium, potassium or sodium, in particular NaCl, LiCl, NaBr, KBr and NaI may be used.

A very preferred embodiment of the present invention is said process, wherein in step (a) the at least one source of M already comprises the optional at least one source of X′. It is preferred that the at least one source of M is a water-soluble salt that comprises the metal atoms M in form of cations and as anions monovalent anions X′, in particular monovalent anions of F, Cl, Br, I, CN, N₃, CP, FHF, SH, SCN, NCS, SeCN, CNO, NCO and OCN, more preferably F, Cl, Br, I, CN, and N₃, more preferably Cl, Br, I and N₃, most preferably Cl, Br and I, in particular Cl. By using an at least one source of M, which comprises the optional at least one source of X′, the number of reagents and substrates required in the preparation of the respective noble metal-oxo clusters is reduced and thus the synthesis is rendered more efficient and less expensive.

Another very preferred embodiment of the present invention is said process, wherein in step (a) a buffer is present and the buffer already comprises the optional at least one source of X′, in particular the buffer solution comprises monovalent anions of F, Cl, Br, I, CN, N₃, CP, FHF, SH, SCN, NCS, SeCN, CNO, NCO and OCN, more preferably F, Cl, Br, I, CN, and N₃, more preferably Cl, Br, I and N₃, most preferably Cl, Br and I, in particular Cl. By using a buffer, which comprises the optional at least one source of X′, the number of reagents and substrates required in the preparation of the respective noble metal-oxo clusters is reduced and thus the synthesis is rendered more efficient and less expensive.

In step (a) of the process of the present invention, the reaction mixture is typically kept at a temperature of from 5° C. to 60° C., preferably from 10° C. to 50° C., more preferably from 11° C. to 45° C., more preferably from 12° C. to 40° C., most preferably 15° C. to 30° C.

In step (a) of the process of the present invention, the reaction mixture is typically kept for about 10 min to about 5 days, more preferably for about 30 min to 3 days, most preferably for about 2 days. Further, it is preferred that the reaction mixture is stirred during step (a). The above-indicated preferred reaction times for step (a) and the preference for stirring in step (a) apply from the beginning of step to the beginning of step (c) irrespective of whether or not the optional step (b) is present, i.e., irrespective of whether or not the optional at least one source of A is added.

In step (b) of said process optionally at least one source of A is added to the reaction mixture of step (a). Non-limiting examples of suitable neutral entities A are organic acids and derivatives including carboxylic acids and derivatives thereof, such as carboxylic acid esters and carboxylic acid salts, like Na(CH₃COO), organophosphorus and organoarsenic compounds including phosphinic and arsinic acids and derivatives thereof, like Na(CH₃)₂PO₂ and Na(CH₃)₂AsO₂, and Si-containing compounds including silicates such as tungstosilicates, like Na₄(SiW₁₂O₄₀). In an embodiment of the process of the present invention, A is already present in step (a) as a is comprised by any of components reacted in step (a), e.g., A may be comprised in a buffer used in step (a). Preferably, A is already present during step (a) of the process, thus, that there is no optional addition of extra A necessary.

A preferred embodiment of the present invention is such a process wherein the at least one source of M, the at least one source of R₂XO₂, the solvent in step (a), optionally the at least one source of X′, optionally the buffer or any combination thereof provides and/or forms neutral entities A being attracted to the noble metal-oxo cluster [Mₛ(R₂XO₂)_{z}(OR′)ₓO_{y}X′_{q}] or a solvate thereof.

Furthermore, in a preferred embodiment of the present invention, in step (a) of said process, the concentration of the noble metal ions originating from the at least one source of M ranges from 0.001 to 1 mole/l, preferably from 0.01 to 0.8 mole/l, more preferably from 0.05 to 0.5 mole/l.

Furthermore, in a preferred embodiment of the present invention, in step (a) of said process, the concentration of the R₂XO₂ anions originating from the source of R₂XO₂ ranges from 0.01 to 5.0 mole/l, preferably from 0.02 to 3.0 mole/l, more preferably from 0.05 to 2.0 mole/l.

Furthermore, in a preferred embodiment of the present invention, in step (a) of said process, optionally the concentration of the X′ ions originating from the source of X′ ranges from 0.001 to 1 mole/l, preferably from 0.01 to 0.8 mole/l, more preferably from 0.05 to 0.5 mole/l.

Furthermore, in a preferred embodiment of the present invention, in step (b) of said process, optionally the concentration of the neutral entities A originating from the at least one source of A ranges from 0.001 to 5 mole/l, preferably from 0.005 to 3.0 mole/l, more preferably from 0.01 to 1.0 mole/l.

With regard to the present invention the term crude mixture relates to an unpurified mixture after a reaction step and is thereby used synonymously with reaction mixture of the preceding reaction step.

In an embodiment of the process of the present invention, between step (a) and (c), the crude mixture is filtered. Preferably, the crude mixture is filtered immediately after the end of step (a) irrespective of whether or not the optional step (b) is present. For example, the crude mixture is filtered immediately after the stirring is turned off, and is then optionally cooled. Alternatively, if applicable the crude mixture is cooled first, and subsequently filtered. The purpose of this filtration is to remove solid impurities after step (a). Thus, the product of step (a) remains in the filtrate.

In a preferred embodiment, in case A is not present in the crude mixture or filtrate already, or the concentration of A in the crude mixture or filtrate should be increased, in step (b) of the process, A can be added to the reaction mixture of step (a) before or after filtration.

Another very preferred embodiment of the present invention is said process, wherein in step (a) the buffer already comprises the at least one source of A. A further even more preferred embodiment of the present invention is said process, wherein in step (a) the buffer already comprises the at least one source of R₂XO₂ and the at least one source of A.

By using a buffer, which comprises the at least one source of R₂XO₂ and/or the at least one source of A, the number of reagents and substrates required in the preparation of the respective noble metal-oxo clusters is reduced and thus the synthesis is rendered more efficient and less expensive.

In step (c) of the process of the present invention, the noble metal-oxo clusters according to the invention or solvate thereof, formed in step (a) or (b) of said process, are recovered. For example, isolation of the noble metal-oxo clusters or solvate thereof can be effected by common techniques including bulk precipitation or crystallization. In a preferred embodiment of the present invention the noble metal-oxo clusters are isolated as crystalline or amorphous solids, preferably as crystalline solids. Crystallization or precipitation can be effected by common techniques such as evaporation or partial evaporation of the solvent, cooling, change of solvent, solvents or solvent mixtures, addition of crystallization seeds, etc. In a preferred embodiment the addition A in step (b) of the process can induce crystallization or precipitation of the desired noble metal-oxo cluster, wherein fractional crystallization is preferable. In a preferred embodiment, fractional crystallization might be accomplished by the slow addition of a specific amount of A to the reaction mixture of step (a) of the process or to its corresponding filtrates which might be beneficial for product purity and yield.

A preferred embodiment of the present invention is such a process, wherein water is used as solvent and the at least one source of M is a water-soluble salt of Ir, Rh, Pt or Pd.

A preferred embodiment of the present invention is such a process wherein water is used as solvent; the at least one source of M is a water-soluble salt of Pt^{II} or Pd^{II}, preferably selected from PtCl₂, Pd(CH₃COO)₂, PdCl₂, Pd(NO₃)₂ or PdSO₄, in particular a salt of Pd^{II} selected from Pd(CH₃COO)₂, PdCl₂, Pd(NO₃)₂ or PdSO₄, such as Pd(CH₃COO)₂ or PdCl₂; and the at least one source of R₂XO₂ is a water-soluble phosphinic acid or arsinic acid or preferably a salt thereof.

A preferred embodiment of the present invention is such a process wherein water is used as solvent and a buffer is used comprising a water-soluble phosphinic acid or arsinic acid, and the at least one source of M is a water-soluble salt of Pt^{II} or Pd^{II}, preferably selected from PtCl₂, Pd(CH₃COO)₂, PdCl₂, Pd(NO₃)₂ or PdSO₄, in particular a salt of Pd^{II} selected from Pd(CH₃COO)₂, PdCl₂, Pd(NO₃)₂ or PdSO₄, such as Pd(CH₃COO)₂ or PdCl₂.

A very preferred embodiment of the present invention is such a process wherein water is used as solvent and a buffer is used comprising a water-soluble phosphinic acid or arsinic acid, and the at least one source of M is a water-soluble salt of Pd^{II}, preferably palladium nitrate, palladium sulfate, palladium chloride or palladium acetate, in particular palladium chloride or palladium acetate.

According to one embodiment, the present noble metal-oxo clusters can be immobilized on a solid support. The present invention thus also relates to supported noble metal-oxo clusters comprising the noble metal-oxo clusters of the present invention or prepared by the process of the present invention on a solid support. Suitable supports include but are not limited to materials having a high surface area and/or a pore size which is sufficient to allow the noble metal-oxo clusters to be loaded, e.g., polymers, graphite, carbon nanotubes, electrode surfaces, aluminum oxide and aerogels of aluminum oxide and magnesium oxide, titanium oxide, zirconium oxide, cerium oxide, silicon dioxide, silicates, active carbon, mesoporous materials, like mesoporous silica, such as SBA-15 and MCM-41, zeolites, aluminophosphates (ALPOs), silicoaluminophosphates (SAPOs), metal organic frameworks (MOFs), zeolitic imidazolate frameworks (ZIFs), periodic mesoporous organosilicas (PMOs), and mixtures thereof and modified compounds thereof. Preferred supports are, for instance, mesoporous silica, more preferably SBA-15 or MCM-41, most preferably SBA-15. A variety of such solid supports is commercially available or can be prepared by common techniques. Furthermore, there are various common techniques to modify or functionalize solid supports, for example with regard to the size and shape of the surface or the atoms or groups available for bonding on the surface.

In a preferred embodiment of the present invention the immobilization of the noble metal-oxo clusters to the surface of the solid support is accomplished by means of adsorption, including physisorption and chemisorption, preferably physisorption. The adsorption is based on interactions between the noble metal-oxo clusters and the surface of the solid support such as van-der-Waals interactions, hydrogen-bonding interactions, ionic interactions, etc.

In a preferred embodiment the negatively charged atoms and/or groups of the overall neutral noble metal-oxo clusters are adsorbed predominantly based on ionic interactions. Therefore, a solid support bearing positively charged groups is preferably used, in particular a solid support bearing groups that can be positively charged by protonation. A variety of such solid supports is commercially available or can be prepared by common techniques. In one embodiment the solid support is functionalized with positively charged groups, preferably groups that are positively charged by protonation, and the negatively charged atoms and/or groups of the overall neutral noble metal-oxo clusters are linked to said positively charged groups by electrostatic interactions. In a preferred embodiment the solid support, preferably mesoporous silica, more preferably SBA-15 or MCM-41, most preferably SBA-15, is functionalized with moieties bearing positively charged groups, preferably tetrahydrocarbyl ammonium groups, more preferably groups that can be positively charged by protonation, most preferably mono-functionalized amino groups —NH₂. Preferably said groups are attached to the surface of the solid support by covalent bonds, preferably via a linker that comprises one or more, preferably one, of said groups, preferably an alkyl, aryl, alkenyl, alkynyl, hetero-alkyl, hetero-cycloalkyl, hetero-alkenyl, hetero-cycloalkenyl, hetero-alkynyl, hetero-aryl or cycloalkyl linker, more preferably an alkyl, aryl, hetero-alkyl or hetero-aryl linker, more preferably an alkyl linker, most preferably a methylene, ethylene, n-propylene, n-butylene, n-pentylene, n-hexylene linker, in particular a n-propylene linker. Preferably said linkers are bonded to any suitable functional group present on the surface of the solid support, such as to hydroxyl groups. Preferably said linkers are bonded to said functional groups present on the surface of the solid support either directly or via another group or atom, most preferably via another group or atom, preferably a silicon-based group, most preferably a silicon atom. In a most preferred embodiment of the present invention the noble metal-oxo clusters are supported on (3-aminopropyl)triethoxysilane (apts)-modified SBA-15

In the supported noble metal-oxo clusters of the present invention, the noble metal-oxo clusters that are immobilized on the solid support are in the form of primary and/or secondary particles. In an especially preferred embodiment, the immobilized noble metal-oxo clusters particles are mainly in the form of primary particles (i.e. non-agglomerated primary particles), that is at least 90 wt % of the immobilized noble metal-oxo clusters particles are in the form of primary particles, preferably at least 95 wt %, more preferably at least 99 wt %, in particular substantially all the immobilized noble metal-oxo clusters particles are in the form of primary particles.

The invention is further directed to processes for preparing supported noble metal-oxo clusters according to the invention. Solid supports used in the context of this invention are as defined above. In a preferred embodiment of the present invention the surface of the solid supports is modified with positively charged groups, more preferably groups that can be positively charged by protonation. Those charged solid supports can be prepared by techniques well established in the art, for example by surface modification of a mesoporous silica, such as SBA-15, with a suitable reagent bearing a positively charged group or a group that can be positively charged by protonation, such as 3-aminopropyltriethoxysilane (apts), is conducted by heating, preferably under reflux, under inert gas atmosphere, such as argon or nitrogen, in an inert solvent with a suitable boiling point, such as hexane, heptane or toluene, for a suitable time, such as 4-8 hours, and finally the modified solid support is isolated, preferably by filtration, purified, preferably by washing, and dried, preferably under vacuum by heating, most preferably under vacuum by heating at about 100° C.

The optionally treated support may be further calcined at a temperature of 500° C. to 800° C. For the calcination, common equipment may be used, that is commercially available. Calcination of the optionally treated support may for instance be conducted under an oxygen containing gas such as air, under vacuum, under hydrogen or under an inert gas such as argon or nitrogen, more preferably under inert gas, most preferably under nitrogen.

The noble metal-oxo clusters according to the present invention or prepared by the process of the present invention can be immobilized on the surface of the solid support by contacting said noble metal-oxo clusters with the solid support. The present invention therefore also relates to a process for the preparation of supported noble metal-oxo clusters, comprising the step of contacting the noble metal-oxo clusters provided by the present invention or prepared according to the present invention with the solid support, thereby immobilizing at least part of the noble metal-oxo clusters onto the support; and optionally isolating the resulting supported noble metal-oxo clusters.

Said contacting may be conducted employing common techniques in the art, such as blending both the solid support and the noble metal-oxo cluster in the solid form. In a preferred embodiment the noble metal-oxo cluster is mixed with a suitable solvent, preferably water or an aqueous solvent, and the solid support is added to this mixture. In a more preferred embodiment the solid support is mixed with a suitable solvent, preferably water or an aqueous solvent, and the noble metal-oxo cluster is added to this mixture. In case a solid support with groups that can be positively charged by protonation is used, the mixture is preferably acidified, for instance by addition of H₂SO₄, HNO₃ or HCl, most preferably by addition of H₂SO₄ or HNO₃, so that the pH value of the mixture ranges from 0.1 to 6, preferably from 1 to 4 and more preferably from 1.5 to 3, most preferably about 2. The mixture comprising noble metal-oxo cluster, solid support and solvent is preferably stirred, typically for 1 min to 24 h, more preferably for 30 min to 15 h, more preferably for 1 h to 12 h, most preferably for 6 h to 10 h, in particular about 8 h. While stirring, the mixture may be at a temperature of from 20° C. to 100° C., preferably from 20° C. to 80° C., preferably from 20° C. to 60° C., preferably from 20° C. to 40° C., and most preferably about 25° C. Afterwards, the supported noble metal-oxo cluster can be kept in the solvent as suspension or can be isolated. Isolation of the supported noble metal-oxo cluster from the solvent may be performed by any suitable method in the art, such as by filtration, evaporation of the solvent, centrifugation or decantation, preferably by filtration or removal of the solvent in vacuum, more preferably by filtration. The isolated supported noble metal-oxo clusters may then be washed with a suitable solvent, preferably water or an aqueous solvent, and dried. Supported noble metal-oxo clusters may be dried in an oven at a temperature of e.g. about 100° C.

In another embodiment, the supported noble metal-oxo clusters may be further calcined at a temperature not exceeding the transformation temperature of the noble metal-oxo cluster, i.e., the temperature at which the noble metal-oxo clusters have been proven to be stable (usually about 200° C. for the present noble metal-oxo clusters according to their corresponding TGA). Thus, in a preferred embodiment the noble metal-oxo clusters of the present invention are thermally stable up to temperatures of about 200° C. For the calcination, common equipment may be used, that is commercially available. Calcination of the supported noble metal-oxo clusters may for instance be conducted under an oxygen containing gas such as air, under vacuum, under hydrogen or under an inert gas such as argon or nitrogen, more preferably under inert gas, most preferably under nitrogen.

In many cases, however, and in particular if the supported noble metal-oxo cluster is used as a catalyst or pre-catalyst under reductive conditions, drying of the supported noble metal-oxo cluster without calcination may be sufficient. In other cases calcination might significantly improve the catalytic performance of the supported noble metal-oxo clusters according the present invention.

In a further embodiment, the supported noble metal-oxo clusters may be calcined at a temperature exceeding the transformation temperature of the noble metal-oxo cluster, i.e., the temperature at which decomposition of the noble metal-oxo cluster starts to take place (usually about 200° C. for the present noble metal-oxo cluster s according to their corresponding TGA), wherein the same considerations and conclusions apply as for the calcination of non-supported noble metal-oxo clusters at a temperature exceeding the transformation temperature of the noble metal-oxo cluster. A higher temperature may be used to carefully remove certain capping groups, at least partially.

In supported noble metal-oxo clusters, the noble metal-oxo cluster loading levels on the solid support may be up to 30 wt % or even more but are preferably up to 10 wt %, for instance up to 5 wt % or even up to 2 wt %. Accordingly, the noble metal-oxo cluster loading level on the solid support is typically 0.01 to 30 wt %, particularly 0.05 to 20 wt %, more particularly 0.1 to 10 wt %, often 0.2-6 wt %, more often 0.3-5 wt %, and most often 0.5-2 wt %. noble metal-oxo cluster loading levels on the solid support can be determined by elemental analysis such as Inductively Coupled Plasma Mass Spectrometry (ICP-MS) analysis, for instance using a Varian Vista MPX.

According to one embodiment, the present invention also relates to a metal cluster unit of the formula

[M⁰ₛ],

wherein
each M⁰ is independently selected from the group consisting of Pd⁰, NO, Rh⁰, Ir⁰, Ag⁰, and Au⁰, and
s is a number from 8 to 96.

Preferably, all M⁰ in the metal cluster unit [M⁰ₛ] are the same; preferably wherein all M⁰ are the same and are selected from Pd⁰, Pt⁰, Rh⁰, and Ir⁰, more preferably Pd⁰, Pt⁰ and Rh⁰, most preferably Pd⁰ and Pt⁰, in particular Pd⁰. In the alternative, all M are selected from mixtures of Pd⁰ and Pt⁰.

Preferably, in the metal cluster unit [M⁰ₛ] s is 8 to 96, preferably 10 to 90, more preferably s is 12 to 84, even more preferably s is 14 to 72, and most preferably s is 16 to 54. In the alternative, s is 8 to 96, preferably 24 to 92, more preferably s is 36 to 90, even more preferably s is 54 to 86, and most preferably s is 60 to 82. In particulars is 8, 10, 12, 16, 18, 20, 22, 24, 26, 28, 30, 32, 34, 36, 40, 44, 48, 52, 54, 60, 62, 64, 66, 68, 70, 72, 74, 76, 78, 80, 82, 84, 86, 88, 90, 92, 94 or 96; more particularly s is 12, 16, 18, 20, 24, 28, 32, 36, 40, 44, 48, 54, 60, 66, 72, 84 or 90, more particularly s is 16, 18, 24, 36, 40, 48, 60, 72 or 84, most particularly s is 16, 24 or 40.

Thus, in a preferred embodiment, the invention relates to a metal cluster unit [M⁰ₛ], wherein all M⁰ are Pd⁰ and wherein s is 14 to 72.

Thus, in a preferred embodiment, the invention relates to a metal cluster unit [M⁰ₛ], wherein all M⁰ are Pt⁰ and wherein s is 14 to 72.

Thus, in a preferred embodiment, the invention relates to a metal cluster unit [M⁰ₛ], wherein all M⁰ are Ir⁰ and wherein s is 14 to 72.

Thus, in a preferred embodiment, the invention relates to a metal cluster unit [M⁰ₛ], wherein all M⁰ are Rh⁰ and wherein s is 14 to 72.

Thus, in a preferred embodiment, the invention relates to a metal cluster unit [M⁰ₛ], wherein all M⁰ are Au⁰ and wherein s is 14 to 72.

Thus, in a preferred embodiment, the invention relates to a metal cluster unit [M⁰ₛ], wherein all M⁰ are Ag⁰ and wherein s is 14 to 72.

Thus, in a preferred embodiment, the invention relates to a metal cluster unit [M⁰ₛ], wherein all M⁰ are Pd⁰ and wherein s is 16 to 54.

Thus, in a preferred embodiment, the invention relates to a metal cluster unit [M⁰ₛ], wherein all M⁰ are Pd⁰ and wherein s is 16, 18, 24, 36, 40, 48, 60, 72 or 84.

In a further embodiment, the metal clusters units of the present invention also include any metal cluster unit of the formula [M⁰ₛ] obtainable by reduction of any of the noble metal-oxo clusters of the present invention or prepared by the process of the present invention.

The metal clusters units of the present invention are in the form of primary and/or secondary particles. In an especially preferred embodiment, the metal cluster units provided by the present invention are mainly in the form of primary particles (i.e., non-agglomerated primary particles), that is at least 90 wt % of the metal cluster units are in the form of primary particles, preferably at least 95 wt %, more preferably at least 99 wt %, in particular substantially all the metal cluster units are in the form of primary particles. This includes metal cluster units dispersed in liquid carrier media. The metal cluster units of the present invention preferably have a primary particle size of about 1.0-2.0 nm, for instance about 1.5 nm.

In a further embodiment, the metal cluster units are dispersed in a liquid carrier medium, thereby forming a dispersion of metal cluster units. In one embodiment of the present invention the liquid carrier medium is an organic solvent, optionally combined with one or more dispersing agents. The organic solvent is preferably capable of dissolving the noble metal-oxo clusters used as starting material for the preparation of the metal cluster units, for instance liquid n-alkanes, e.g., hexane or heptane.

The dispersing agent (or surfactant) is added to the liquid carrier medium to prevent agglomeration of the primary particles of metal cluster unit. Preferably, the dispersing agent is present during formation of the primary particles of metal cluster unit. An example of a surfactant useful as dispersing agent is citric acid or citrate. The dispersing agent preferably forms micelles, each micelle containing one primary particle of metal cluster unit thereby separating the primary particles from each other and preventing agglomeration thereof.

In another further embodiment, the metal cluster units can be immobilized on a solid support thereby forming supported metal cluster units. Suitable supports include but are not limited to materials having a high surface area and/or a pore size which is sufficient to allow the metal cluster units to be loaded, e.g., polymers, graphite, carbon nanotubes, electrode surfaces, aluminum oxide and aerogels of aluminum oxide and magnesium oxide, titanium oxide, zirconium oxide, cerium oxide, silicon dioxide, silicates, active carbon, mesoporous materials, like mesoporous silica, such as SBA-15 and MCM-41, zeolites, aluminophosphates (ALPOs), silicoaluminophosphates (SAPOs), metal organic frameworks (MOFs), zeolitic imidazolate frameworks (ZIFs), periodic mesoporous organosilicas (PMOs), and mixtures thereof and modified compounds thereof. Preferred supports are, for instance, mesoporous silica, more preferably SBA-15 or MCM-41, most preferably SBA-15.

A variety of such solid supports is commercially available or can be prepared by common techniques. Furthermore, there are various common techniques to modify or functionalize solid supports, for example with regard to the size and shape of the surface or the atoms or groups available for bonding on the surface. In a preferred embodiment of the present invention the immobilization of the metal cluster units to the surface of the solid support is accomplished by means of adsorption, including physisorption and chemisorption, preferably physisorption. The adsorption is based on interactions between the metal cluster units and the surface of the solid support, such as van-der-Waals interactions.

In the supported metal cluster units of the present invention, the metal cluster units that are immobilized on the solid support are in the form of primary and/or secondary particles. In an especially preferred embodiment, the immobilized metal cluster unit particles are mainly in the form of primary particles (i.e., non-agglomerated primary particles), that is at least 90 wt % of the immobilized metal cluster unit particles are in the form of primary particles, preferably at least 95 wt %, more preferably at least 99 wt %, in particular substantially all the immobilized metal cluster unit particles are in the form of primary particles.

In the supported metal cluster units of the present invention, the metal cluster unit loading levels on the solid support may be up to 30 wt % or even more, but are preferably up to 10 wt %, for instance up to 5 wt % or even up to 2 wt %. Accordingly, the metal cluster unit loading level on the solid support is typically of 0.01 to 30 wt %, particularly 0.05 to 20 wt %, more particularly 0.1 to 10 wt %, often 0.2-6 wt %, more often 0.3-5 wt %, and most often 0.5-2 wt %. Metal cluster unit loading levels on the solid support can be determined by elemental analysis such as Inductively Coupled Plasma Mass Spectrometry (ICP-MS) analysis, for instance using a Varian Vista MPX.

The invention is further directed to processes for preparing metal cluster units according to the invention. Among the preferred processes for preparing any one of the metal cluster units of the present invention is a process for the preparation of a dispersion of said metal cluster units dispersed in liquid carrier media. Said process comprises:
(a) dissolving any one of the noble metal-oxo clusters provided by the present invention or prepared according to the present invention in a liquid carrier medium,
(b) optionally providing additive means to prevent agglomeration of the metal cluster unit to be prepared, preferably adding compounds capable of preventing agglomeration of metal cluster units to be prepared, more preferably adding surfactants to enable micelle formation, and
(c) subjecting the dissolved noble metal-oxo cluster to chemical or electrochemical reducing conditions sufficient to at least partially reduce said noble metal-oxo cluster into corresponding metal cluster units.

In a preferred embodiment in step (a), the liquid carrier medium capable of dissolving the noble metal-oxo cluster used for the preparation of the metal cluster units is an organic solvent, such as liquid n-alkanes, e.g., hexane or heptane.

In a preferred embodiment in step (b), classical coordinating groups such as diverse types of inorganic and organic anions, such as carboxylates, e.g., citrate, may be used to prevent agglomeration of the metal cluster units to be prepared.

In a preferred embodiment in step (c), the chemical reducing conditions comprise the use of a reducing agent selected from organic and inorganic materials which are oxidizable by Pd^{II} and Pd^{IV}, Pt^{II} and Pt^{IV}, Rh^{I} and Rh^{III}, Ir^{I} and Ir^{III}, Ag^{I} and Ag^{III} and Au^{I} and Au^{III}. Such a chemical reduction can for example be effected by using borohydrides, aluminohydrides, hydrazine, CO or hydrogen, preferably hydrogen, more preferably hydrogen at elevated temperature and pressure, preferably by using hydrogen. In the alternative, the noble metal-oxo cluster in step (c) is reduced electrochemically using a common electrochemical cell.

The metal cluster units of the present invention can be immobilized on the surface of a solid support. The present invention therefore also relates to processes for the preparation of supported metal cluster units according to the present invention. A first process for the preparation of supported metal cluster units comprises contacting the dispersion of metal cluster units provided by the present invention or prepared according to the present invention with a solid support, thereby immobilizing at least part of the dispersed metal cluster units onto the support; and optionally isolating the supported metal cluster units.

In a preferred embodiment, the solid support is added to the dispersion of metal cluster units. The resulting mixture is preferably stirred, typically for 1 min to 24 h, more preferably for 30 min to 15 h, more preferably for 1 h to 12 h, most preferably for 6 h to 10 h, in particular about 8 h. While stirring, preferably the mixture is heated to a temperature of from 20° C. to 100° C., preferably from 20° C. to 80° C., preferably from 20° C. to 60° C. preferably from 20° C. to 40° C., and most preferably about 25° C. Afterwards, the supported metal cluster units are preferably isolated. Isolation of the supported metal cluster units from the solvent may be performed by any suitable method in the art, such as by filtration, evaporation of the solvent, centrifugation or decantation, preferably by filtration or removal of the solvent in vacuum, more preferably by filtration. The isolated supported metal cluster units may then be washed with a suitable solvent, preferably water or an aqueous solvent, and dried, for instance by heating under vacuum.

Another suitable process for the preparation of supported metal cluster units according to the present invention comprises: subjecting supported noble metal-oxo cluster provided by the present invention or prepared according to the present invention to chemical or electrochemical reducing conditions sufficient to at least partially reduce said noble metal-oxo cluster into corresponding metal cluster units; and optionally isolating the supported metal cluster units.

In a preferred embodiment, the chemical reducing conditions comprise the use of a reducing agent selected from organic and inorganic materials which are oxidizable by Pd^{II} and Pd^{IV}, Pt^{II} and Pt^{IV}, Rh^{I} and Rh^{III}, Ir^{I} and Ir^{III}, Ag^{I} and Ag^{III}, and Au^{I} and Au^{III}. Such a chemical reduction can for example be effected by using borohydrides, aluminohydrides, hydrazine, CO or hydrogen, preferably hydrogen, more preferably hydrogen at elevated temperature and pressure. In the alternative, the noble metal-oxo cluster is reduced electrochemically using a common electrochemical cell.

The invention is also directed to the use of optionally supported noble metal-oxo clusters provided by the present invention or prepared according to the present invention and/or optionally supported or dispersed metal cluster units provided by the present invention or prepared according to the present invention, for catalyzing homogeneous and heterogeneous conversion of organic substrates.

In a preferred embodiment, conversion may refer to homogeneous or heterogeneous reduction and/or hydroprocessing and/or hydrocracking and/or (hydro)desulfurization and/or oxidation of organic substrate.

In a preferred embodiment the process for the homogeneous or heterogeneous conversion of organic substrate comprises contacting said organic substrate with the optionally supported noble metal-oxo clusters provided by the present invention or prepared according to the present invention and/or optionally supported or dispersed metal cluster units provided by the present invention or prepared according to the present invention.

Since the M metal atoms are not fully sterically shielded by the noble metal-oxo cluster framework, various noble metal coordination sites are easily accessible to the organic substrate and therefore high catalytic activities are achieved. Further, the thermal stability of the optionally supported noble metal-oxo clusters of the present invention permits their use under a variety of reaction conditions.

It is contemplated that the optionally supported noble metal-oxo clusters of the present invention can be activated by any process described herein or any process known in the art, preferably by increasing the accessibility to their noble metal atoms M. Thus, it might be possible that the optionally supported noble metal-oxo clusters are reductively converted into metal cluster unit-like structures or even into metal cluster units under the conversion reaction conditions and it might be possible that said metal cluster unit-like structures or said metal cluster units are in fact the catalytically active species. Nevertheless, the optionally supported noble metal-oxo clusters of the present invention give excellent results in homogeneous and heterogeneous conversion of organic substrates, regardless of the specific nature of the actually catalytically active species.

Another useful aspect of this invention is that the optionally supported noble metal-oxo clusters and optionally supported or dispersed metal cluster units of the present invention can be recycled and used multiple times for the conversion of organic molecules, i.e., without significant loss of the expensive noble metals.

In a preferred embodiment this invention thus also relates to a process for converting organic substrates comprising the steps:
(a) contacting a first organic substrate with one or more optionally supported noble metal-oxo clusters and/or one or more supported metal cluster units,
(b) recovering the one or more optionally supported noble metal-oxo clusters and/or one or more supported metal cluster units;
(c) contacting the one or more optionally supported noble metal-oxo clusters and/or one or more supported metal cluster units with a solvent at a temperature of 50° C. or more, and/or hydrogen stripping the one or more optionally supported noble metal-oxo clusters and/or the one or more supported metal cluster units at elevated temperature, and/or calcining the one or more optionally supported noble metal-oxo clusters and/or the one or more supported metal cluster units at elevated temperature under an oxygen containing gas, e.g. air, or under an inert gas, e.g. nitrogen or argon, to obtain a recycled one or more optionally supported noble metal-oxo clusters and/or one or more supported metal cluster units;
(d) contacting the recycled one or more optionally supported noble metal-oxo clusters and/or one or more supported metal cluster units with a second organic substrate which may be the same as or different from the first organic substrate; and
(e) optionally repeating steps (b) to (d).

The contacting of organic substrate with optionally supported noble metal-oxo cluster and/or supported metal cluster unit in step (a) may, e.g., be carried out in a continuously stirred tank reactor (CSTR), a fixed bed reactor, a fluidized bed reactor or a moving bed reactor.

Thus, e.g., the optionally supported noble metal-oxo clusters and/or supported metal cluster units of the present invention can be collected after a conversion reaction, washed with a polar or non-polar solvent such as acetone and then dried under heat (typically 50° C. or more, alternately 75° C. or more, alternately 100° C. or more, alternately 125° C. or more) for 30 minutes to 48 hours, typically for 1 to 24 hours, more typically for 2 to 10 hours, more typically for 3 to 5 hours.

Alternatively, to or in addition to the washing, the optionally supported noble metal-oxo clusters and/or supported metal cluster units may be subjected to hydrogen stripping at elevated temperature. Preferably, the hydrogen stripping is carried out at a temperature of 50° C. or higher, more preferably at a temperature of 75° C. or higher and most preferably at a temperature of 100° C. or higher.

Alternatively, to or in addition to the washing and/or hydrogen stripping, the optionally supported noble metal-oxo clusters and/or supported metal cluster units may be calcined at elevated temperature under an oxygen containing gas, e.g., air, or under an inert gas, e.g., nitrogen or argon. Preferably, the calcination is carried out at a temperature in the range from 75° C. to 150° C., such as from 90° C. to 120° C. or from 120° C. to 150° C.

The washing and/or hydrogen stripping and/or calcining has/have the effect of regenerating the optionally supported noble metal-oxo clusters and/or supported metal cluster units for recycling.

The recycled optionally supported noble metal-oxo clusters and/or supported metal cluster units of the present invention may be used on fresh organic molecules, or on recycled organic molecules from a recycle stream.

It is preferred to use supported noble metal-oxo clusters and/or supported metal cluster units of the present invention as catalysts with regard to recovery and recycling of the catalyst in the conversion processes described herein. Advantageously, the supported noble metal-oxo clusters and/or supported metal cluster units of the present invention may be recycled and used again under the same or different reaction conditions. Typically the supported noble metal-oxo clusters and/or supported metal cluster units are recycled at least 1 time, preferably at least 4 times, preferably at least 8 times, preferably at least 12 times, preferably at least 100 times.

Thus, this invention also relates to a process for converting organic substrates which process comprises contacting a first organic substrate with one or more supported noble metal-oxo clusters and/or supported metal cluster units of the present invention, thereafter recovering the supported noble metal-oxo clusters and/or supported metal cluster units of the present invention, contacting the supported noble metal-oxo clusters and/or supported metal cluster units of the present invention with a solvent (such as acetone) at a temperature of 50° C. or more, and/or hydrogen stripping the supported noble metal-oxo clusters and/or supported metal cluster units at elevated temperature, and/or calcining the supported noble metal-oxo clusters and/or supported metal cluster units to obtain recycled supported noble metal-oxo clusters and/or supported metal cluster units of the present invention, thereafter contacting the recycled supported noble metal-oxo clusters and/or supported metal cluster units of the present invention with a second organic substrate, which may be the same as or different from the first organic substrate, this process may be repeated many times, preferably at least 4 times, preferably at least 8 times, preferably at least 12 times, preferably at least 100 times.

Due to the definite stoichiometry of noble metal-oxo clusters, the optionally supported noble metal-oxo clusters of the present invention can also be used as a precursor for mixed metal-oxide catalysts.

Metal cluster units of the present invention, optionally supported or dispersed in a liquid carrier medium, can be described as nanocatalysts of M at the atomic or molecular level, i.e., particles of M having an average diameter of about 1.5-2.5 nm, for instance about 2.0 nm, obtained by reduction of the noble metal-oxo clusters. In the case of the preferred embodiment, wherein all M are the same, nanocatalysts with at least one noble atom species are obtained. In another embodiment in which at least one or more M are different among each other, nanocatalysts with more than one noble atom species, such as 2 to 6 noble atom species, preferably 2, 3 or 4, more preferably 2 or 3, most preferably 2, are obtained. Thus, the bottom-up approach of the present invention allows for the preparation of noble metal-rich customized nanocatalysts of very well defined size and shape, in which two or more than two metal species can be selected individually from groups that contain or consist of the noble metal elements Rh, Ir, Pd, Pt, Ag, and Au.

The obtained metal cluster units can be used for a wide range of catalytic applications such as in fuel cells, for detection of organic substrates, selective hydrogenation, reforming, hydrocracking, hydrogenolysis and oligomerization. Besides immobilizing the present noble metal-oxo clusters on a matrix surface and subsequently reducing them, the deposition of the noble metal-oxo clusters on a surface matrix and their reduction can also be carried out simultaneously.

In addition, e.g., the noble metal-oxo clusters according to the invention can be used to produce modified electrodes by electrochemical deposition of the noble metal-oxo cluster on an electrode surface such as a glassy carbon (GC) electrode surface. The obtained deposits contain predominantly M⁰ such as Rh⁰, Pd⁰, Pt⁰, Ag⁰, Au⁰, and preferably mixtures thereof with very small amounts Mχ⁺ such as Pd^{II} and Pd^{IV}, Pt^{II} and Pt^{IV}, Rh^{I} and Rh^{III}, Ir^{I} and Ir^{III}, Ag^{I} and Ag^{III}, and Au^{I} and Au^{III} and mixtures thereof, preferably Pd^{II}, Pt^{II}, Rh^{I} Ir^{I}, Ag^{I}, and Au^{I}. In a preferred embodiment, the obtained deposits provide improved electrochemical behaviors like improved kinetics of electrocatalytic processes compared to a film deposited using a conventional precursor of M. For example, electrodes modified with a deposit of the present noble metal-oxo clusters can be used for the electrochemical reduction of organic substrates. It has been found that such modified electrodes show a very small overpotential and a remarkably high shelf life.

### EXAMPLES

The invention is further illustrated by the following examples.

### Example 1: Synthesis of “Pd₁₆ {(CH₃)₂AsO₂}₈”, i.e., Noble Metal-Oxo-Cluster [Pd₁₆{(CH₃)₂AsO₂}₈(μ₂-OH)₈(μ₄-O)₈]{Na(CH₃)₂AsO₂}·0.25{Na(CH₃COO)}·19H₂O

Pd(CH₃COO)₂ (0.126 g, 0.56 mmol) was dissolved in 4 mL of a sodium cacodylate buffer solution (0.37 M, pH=7). The solution was stirred at 20° C. for 2 days. The resulting dark red solution was filtered and kept for crystallization in an open vial. Thin red crystals were formed after 1 to 2 weeks, which were collected by filtration, washed with acetonitrile and air dried. Yield: 0.004 g (3% based on Pd). This product was analyzed by XRD, IR, elemental analysis, and TGA and was identified as [Pd₁₆{(CH₃)₂AsO₂}₈(μ₂-OH)₈(μ₄-O)₈] cluster isolated in hydrated form and co-crystallized with sodium salts, i.e., isolated as [Pd₁₆{(CH₃)₂AsO₂}₈(μ₂-OH)₈(μ₄-O)₈]{Na(CH₃)₂AsO₂}·0.25 {Na(CH₃COO)}·19H₂O (“Pd₁₆ {(CH₃)₂AsO₂}₈”).

### Example 2: Analysis of “Pd₁₆{(CH₃)₂AsO₂}₈”

The IR spectrum with 4 cm⁻¹ resolution was recorded on a Nicolet Avatar 370 FT-IR spectrophotometer on KBr pellet sample (peak intensities: w=weak; m=medium; s=strong). The characteristic region of the noble metal-oxo cluster is the fingerprint region or the region between 1000-400 cm⁻¹ due to metal-oxygen stretching and bending vibrations: 3600-3300 (s) [υ(O—H) of H₂O and hydroxyl], 3000-2920 (w) [υ(C—H) of methyl groups of cacodylate and acetate], 1641 (m) [H₂O bending fundamental mode δ], 1566 (m) [υ(OCO) of acetate], 1410 (m) [δ(C—H) of the methyl groups of cacodylate], 1271 (m) [δᵢₙ₋ₚₗₐₙₑ(O—H)], 906-888 (w) [δ_{out-of-plane}(O—H)], 829-586 (s) [υ(Pd—O)], 545-452 (m) [υ(As—C)]. The FT-IR spectrum is shown in FIG. 1.

Elemental analysis for “Pd₁₆{(CH₃)₂AsO₂}₈” calculated (found): C, 6.19 (6.83), H, 2.83 (2.76), As, 18.81 (18.94), Na, 0.8 (0.75), Pd, 47.49 (47.77).

Thermogravimetric analysis (TGA) was performed on a SDT Q 600 device from TA Instruments with 10-30 mg samples in 100 μL alumina pans, under a 100 mL/min N₂ flow with a heating rate of 5° C./min between 20° C. and 800° C. (FIG. 2). The TGA data indicates that the lattice water molecules of the supramolecular framework structure gets removed in the temperature range of 20° C. to 100° C. (˜10% weight loss). This result is in good agreement with that obtained by elemental analysis to determine the amount of water of crystallization present in the noble metal-oxo cluster. The TGA data indicates that the compound is stable up to ˜200° C.

### Example 3: Single Crystal X-Ray Diffraction (XRD) Data and Analysis of “Pd₁₆{(CH₃)₂AsO₂}₈”

Besides IR, elemental analysis and TGA the product was also characterized by single-crystal XRD. The crystal was mounted in Hampton cryoloop at 100 K using light oil for data collection. The XRD data was collected at 100 K. Indexing and data collection were carried on a Bruker Kappa X8 APEX II CCD single crystal diffractometer with κ geometry and Mo Kα radiation (λ=0.71073 Å). The SHELX software package (Bruker) was used to solve and refine the structure. An empirical absorption correction was applied using the SADABS program as disclosed in G. M. Sheldrick, SADABS, Program for empirical X-ray absorption correction, Bruker-Nonius: Madison, Wis. (1990). The structure was solved by direct method and refined by the full-matrix least squares method (Σw(|Fₒ|²−|F_{c}|²)²) with anisotropic thermal parameters for all heavy atoms included in the model. The H atoms were not located. Also, it was not possible to locate the {Na(CH₃)₂AsO₂} units, {Na(CH₃COO)} units, and crystal water molecules by XRD, due to crystallographic disorder. Their exact numbers in the “Pd₁₆{(CH₃)₂AsO₂}₈” were thus based on elemental analysis and TGA. Compound “Pd₁₆{(CH₃)₂AsO₂}₈” crystallizes in the triclinic space group P-1. Crystallographic data are detailed in Table 1.

TABLE 1
Crystal data for “Pd₁₆{(CH₃)₂AsO₂}₈”

| Empirical formula | C_{18.5}H_{100.75}As₉Na_{1.25}Pd₁₆O_{53.5} |
|---|---|
| Formula weight, g/mol | 3585.46 |
| Crystal system | Triclinic |
| Space group | P-1 |
| a, Å | 16.2542(18) |
| b, Å | 19.544(2) |
| c, Å | 27.843(3) |
| α, ° | 83.863(3) |
| β, ° | 85.326(3) |
| γ, ° | 85.591(3) |
| Volume, Å³ | 8744.0(17) |
| Z | 2 |
| D_{calc}, g/cm³ | 2.452 |
| Absorption coefficient, mm⁻¹ | 6.458 |
| F(000) | 5936 |
| Theta range for data collection, ° | 1.412 to 25.027 |
| Completeness to Θₘₐₓ % | 99.8% |
| Index ranges | −19 <= h <= 19, |
| | −23 <= k <= 23, |
| | −32 <= l <= 33 |
| Reflections collected | 140091 |
| Independent reflections | 30847 |
| R(int) | 0.0932 |
| Data/restraints/parameters | 30847/704/1486 |
| Goodness-of-fit on F² | 1.023 |
| R₁^{[a]} (I > 2σ(I)) | 0.0962 |
| wR₂^{[b]} (all data) | 0.1504 |

^{[a]}R₁=Σ[|Fₒ|−|Fₒ|]/Σ|Fₒ|. ^{[b]}wR₂=[Σw(Fₒ²−Fₒ²)²/Σw(F_{c}²)²]^{1/2}

### Example 4: Structure of the [Pd₁₆{(CH₃)₂AsO₂}₈(μ₂-OH)₈(μ₄-O)₈]Cluster

The structure of the [Pd₁₆{(CH₃)₂AsO₂}₈(μ₂-OH)₈(μ₄-O)₈] cluster is displayed in FIG. 3. The 8 square planar Pd²⁺ ions are capped by the 8 cacodylate anions and are interconnected by (μ₄-O)²⁻ ions. The Pd₈ planar ring is further connected through (μ₄-O)²⁻ ions to two Pd₄(μ₂-OH)₄, one above and one below the planar ring.

### Example 5: Synthesis of “Pd₂₄{(CH₃)₂AsO₂}₁₆”, i.e., Noble Metal-Oxo-Cluster [Pd₂₄ {(CH₃)₂AsO₂}₁₆(μ₂-OH)₈(μ₄-O)₁₂]·₃{Na(CH₃)₂AsO₂}·2{Na(CH₃COO)}·35H₂O

Pd(CH₃COO)₂ (0.224 g, 1.00 mmol) was dissolved in 3 mL of a sodium cacodylate buffer solution (1 M, pH=7). The solution was stirred at 20° C. for 2 days. The pH of the resulting light red solution was then adjusted to ˜7 with 6 M aq. NaOH solution and the solution was stirred further for 1 day. The resulting dark red solution was filtered and kept for crystallization in an open vial. Thin red crystals were formed after 1 to 2 weeks, which were collected by filtration, washed with acetonitrile and air dried. Yield: 0.04 g (15% based on Pd). This product was analyzed by XRD, IR, elemental analysis, and TGA and was identified as [Pd₂₄{(CH₃)₂AsO₂}₁₆(μ₂-OH)₈(μ₄-O)₁₂] cluster isolated in hydrated form and coordinated by sodium salts, i.e., isolated as [Pd₂₄ {(CH₃)₂AsO₂}₁₆(μ₂-OH)₈(μ₄-O)₁₂]·3{Na(CH₃)₂AsO₂}·2{Na(CH₃COO)}·35H₂O (“Pd₂₄{(CH₃)₂AsO₂}₁₆”).

### Example 6: Analysis of “Pd₂₄{(CH₃)₂AsO₂}₁₆”

The IR spectrum with 4 cm⁻¹ resolution was recorded on a Nicolet Avatar 370 FT-IR spectrophotometer on KBr pellet sample (peak intensities: w=weak; m=medium; s=strong). The characteristic region of the noble metal-oxo cluster is the fingerprint region or the region between 1000-400 cm⁻¹ due to metal-oxygen stretching and bending vibrations: 3600-3300 (s) [υ(O—H) of H₂O and hydroxyl], 3000-2920 (w) [υ(C—H) of methyl groups of cacodylate and acetate], 1638 (m) [H₂O bending fundamental mode δ], 1572 (m) [υ(OCO) of acetate], 1410-1384 (m) [δ(C—H) of the methyl groups of cacodylate], 1265 (m) [δᵢₙ₋ₚₗₐₙₑ(O—H)], 908 (w) [δ_{out-of-plane}(O—H)], 811-580 (s) [υ(Pd—O)], 509-460 (m) [υ(As—C)]. The FT-IR spectrum is shown in FIG. 4.

Elemental analysis for “Pd₂₄{(CH₃)₂AsO₂}₁₆” calculated (found): C, 7.95 (7.98), H, 3.14 (3.10), As, 22.4 (21.98), Na, 1.81 (1.82), Pd, 40.2 (39.83).

Thermogravimetric analysis (TGA) was performed on a SDT Q 600 device from TA Instruments with 10-30 mg samples in 100 μL alumina pans, under a 100 mL/min N₂ flow with a heating rate of 5° C./min between 20° C. and 800° C. (FIG. 5). The TGA data indicates that the lattice water molecules of the supramolecular framework structure gets removed in the temperature range of 20° C. to 100° C. (˜10% weight loss). This result is in good agreement with that obtained by elemental analysis to determine the amount of water of crystallization present in the noble metal-oxo cluster. The TGA data indicates that the compound is stable up to ˜200° C.

### Example 7: Single Crystal X-Ray Diffraction (XRD) Data and Analysis of “Pd₂₄{(CH₃)₂AsO₂}₁₆”

Besides IR, elemental analysis and TGA the product was also characterized by single-crystal XRD. The crystal was mounted in Hampton cryoloop at 100 K using light oil for data collection. The XRD data was collected at 100 K. Indexing and data collection were carried on a Bruker Kappa X8 APEX II CCD single crystal diffractometer with κ geometry and Mo Kα radiation (λ=0.71073 Å). The SHELX software package (Bruker) was used to solve and refine the structure. An empirical absorption correction was applied using the SADABS program as disclosed in G. M. Sheldrick, SADABS, Program for empirical X-ray absorption correction, Bruker-Nonius: Madison, Wis. (1990). The structure was solved by direct method and refined by the full-matrix least squares method (Σw(|Fₒ|²−|F_{c}|²)²) with anisotropic thermal parameters for all heavy atoms included in the model. The H atoms were not located. Also, it was not possible to locate the {Na(CH₃)₂AsO₂} units, {Na(CH₃COO)} units, and crystal water molecules by XRD, due to crystallographic disorder. Their exact numbers in the “Pd₂₄{(CH₃)₂AsO₂}₁₆” were thus based on elemental analysis and TGA. Compound “Pd₂₄{(CH₃)₂AsO₂}₁₆” crystallizes in the triclinic space group P-1. Crystallographic data are detailed in Table 2.

TABLE 2
Crystal data for “Pd₂₄{(CH₃)₂AsO₂}₁₆”

| Empirical formula | C₄₂H₁₉₈As₁₉Na₅Pd₂₄O₉₇ |
|---|---|
| Formula weight, g/mol | 6348.5 |
| Crystal system | Triclinic |
| Space group | P-1 |
| a, Å | 18.2513(12) |
| b, Å | 19.4251(13) |
| c, Å | 24.7402(17) |
| α, ° | 98.230(2) |
| β, ° | 103.164(2) |
| γ, ° | 111.163(2) |
| Volume, Å³ | 7715.5(9) |
| Z | 2 |
| D_{calc}, g/cm³ | 2.180 |
| Absorption coefficient, mm⁻¹ | 6.177 |
| F(000) | 4672 |
| Theta range for data collection, ° | 1.732 to 25.027 |
| Completeness to Θₘₐₓ % | 99.8% |
| Index ranges | −21 <= h <= 21, |
| | −23 <= k <= 23, |
| | −29 <= l <= 29 |
| Reflections collected | 163432 |
| Independent reflections | 27191 |
| R(int) | 0.0997 |
| Data/restraints/parameters | 27191/511/1117 |
| Goodness-of-fit on F² | 1.012 |
| R₁^{[a]} (I > 2σ(I)) | 0.1371 |
| wR₂^{[b]} (all data) | 0.2423 |

^{[a]}R₁=Σ[|Fₒ|−|Fₒ|]/Σ|Fₒ|. ^{[b]}wR₂=[Σw(Fₒ²−Fₒ²)²/Σw(F_{c}²)²]^{1/2}

### Example 8: Structure of the [Pd₂₄{(CH₃)₂AsO₂}₁₆(μ₂-OH)₈(μ₄-O)₁₂] Cluster

The structure of the [Pd₂₄{(CH₃)₂AsO₂}₁₆(μ₂-OH)₈(μ₄-O)₁₂] cluster is displayed in FIG. 6. The 16 square planar Pd²⁺ ions form one ring as was found for the compound Pd₁₆{(CH₃)₂AsO₂}₈. In addition, the Pd₁₆ ring is connected to two Pd₄{(CH₃)₂AsO₂}₄ units through (μ₄-O)²⁻ ions on the top and bottom of the ring.

### Example 9: Synthesis of “Pd₄₀{(CH₃)₂AsO₂}₁₆—SiW₁₂O₄₀”, i.e., Noble Metal-Oxo-Cluster [Pd₄₀{(CH₃)₂AsO₂}₁₆(μ₂-OH)₈(μ₂-ONa)₈(μ₄-O)₂₄]·1.5{Na₄(SiW₁₂O₄₀)}·2{Na(CH₃)₂AsO₂}·2{Na(CH₃COO)}·135H₂O

Pd(CH₃COO)₂ (0.224 g, 1.00 mmol) was dissolved in 6 mL of a sodium dimethylarsinate (or sodium cacodylate) buffer solution (1 M, pH=7). Then 0.2 mmol of Na₁₀[α-SiW₉O₃₄]·22H₂O were added to the solution, which was subsequently stirred at 20° C. for 2 days. The pH of the resulting light red solution was then adjusted to ˜8 with 6 M aq. NaOH solution and the solution was stirred further for 1 day. The resulting dark red solution was filtered and kept for crystallization in an open vial. Cubic shaped crystals were formed after 4 to 5 days, which were collected by filtration, washed with acetonitrile and air dried. Yield: 0.091 g (25% based on Pd). This product was analyzed by XRD, IR, elemental analysis, and TGA and was identified as [Pd₄₀{(CH₃)₂AsO₂}₁₆(μ₂-OH)₈(μ₂-ONa)₈(μ₄-O)₂₄] cluster isolated in hydrated form and coordinated by sodium salts including inter alia Na₄(SiW₁₂O₄₀) i.e., isolated as [Pd₄₀{(CH₃)₂AsO₂}₁₆(μ₂-OH)₈(μ₂-ONa)₈(μ₄-O)₂₄]·1.5{Na₄(SiW₁₂O₄₀)}·2{Na(CH₃)₂AsO₂}·2{Na(CH₃COO)}·135H₂O (“Pd₄₀{(CH₃)₂AsO₂}₁₆—SiW₁₂O₄₀”).

### Example 10: Analysis of “Pd₄₀{(CH₃)₂AsO₂}₁₆—SiW₁₂O₄₀”

The IR spectrum with 4 cm⁻¹ resolution was recorded on a Nicolet Avatar 370 FT-IR spectrophotometer on KBr pellet sample (peak intensities: w=weak; m=medium; s=strong). The characteristic region of the noble metal-oxo cluster is the fingerprint region or the region between 1000-400 cm⁻¹ due to metal-oxygen stretching and bending vibrations: 3600-3200 (s), 3000 (s), 2925 (w), 1631 (s), 1559 (w), 1404 (m), 1381 (m), 1271 (m), 994 (m), 889 (s), 828 (s), 800 (s), 722 (w), 667 (w), 652 (m), 584 (m), 501 (m), 455 (w). The FT-IR spectrum is shown in FIG. 7. The absorption band near 1631 cm⁻¹ belongs to asymmetric vibrations of the crystal waters.

Elemental analysis for “Pd₄₀{(CH₃)₂AsO₂}₁₆—SiW₁₂O₄₀” calculated (found): C, 3.28 (3.49), H, 2.69 (1.57), As, 9.2 (9.16), Na, 2.82 (2.81), Pd, 29.06 (27.7), W, 22.59 (22.69), Si, 0.29 (0.35).

Thermogravimetric analysis (TGA) was performed on a SDT Q 600 device from TA Instruments with 10-30 mg samples in 100 μL alumina pans, under a 100 mL/min N₂ flow with a heating rate of 5° C./min between 20° C. and 800° C. (FIG. 8). The TGA data indicates that the lattice water molecules of the supramolecular framework structure gets removed in the temperature range of 20° C. to 100° C. (˜15-16% weight loss). This result is in good agreement with that obtained by elemental analysis to determine the amount of water of crystallization present in the noble metal-oxo cluster. The TGA data indicates that the compound is stable up to −200° C.

### Example 11: Single Crystal X-Ray Diffraction (XRD) Data and Analysis of “Pd₄₀{(CH₃)₂AsO₂}₁₆—SiW₁₂O₄₀”

Besides IR, elemental analysis and TGA the product was also characterized by single-crystal XRD. The crystal was mounted in Hampton cryoloop at 100 K using light oil for data collection. The XRD data was collected at 100 K. Indexing and data collection were carried on a Bruker Kappa X8 APEX II CCD single crystal diffractometer with κ geometry and Mo Kα radiation (λ=0.71073 Å). The SHELX software package (Bruker) was used to solve and refine the structure. An empirical absorption correction was applied using the SADABS program as disclosed in G. M. Sheldrick, SADABS, Program for empirical X-ray absorption correction, Bruker-Nonius: Madison, Wis. (1990). The structure was solved by direct method and refined by the full-matrix least squares method (Σw(|Fₒ|²−|F_{c}|²)²) with anisotropic thermal parameters for all heavy atoms included in the model. The H atoms were not located. Also, it was not possible to locate the Na ions of the Na₄(SiW₁₂O₄₀) units, the {Na(CH₃)₂AsO₂} units, {Na(CH₃COO)} units, and crystal water molecules by XRD, due to crystallographic disorder. Their exact numbers in the “Pd₄₀{(CH₃)₂AsO₂}₁₆—SiW₁₂O₄₀” were thus based on elemental analysis and TGA. Compound “Pd₄₀{(CH₃)₂AsO₂}₁₆—SiW₁₂O₄₀” crystallizes in the cubic space group Im-3m. Crystallographic data are detailed in Table 3.

TABLE 3
Crystal data for “Pd₄₀{(CH₃)₂AsO₂}₁₆—SiW₁₂O₄₀”

| Empirical formula | C₄₀H₃₉₂As₁₈Na₁₈Pd₄₀O₂₇₅Si_{1.5}W₁₈ |
|---|---|
| Formula weight, g/mol | 14645.8 |
| Crystal system | Cubic |
| Space group | Im 3m |
| a, Å | 49.286(3) |
| b, Å | 49.286(3) |
| c, Å | 49.286(3) |
| α, ° | 90 |
| β, ° | 90 |
| γ, ° | 90 |
| Volume, Å³ | 119723(19) |
| Z | 24 |
| D_{calc}, g/cm³ | 4.575 |
| Absorption coefficient, mm⁻¹ | 26.516 |
| F(000) | 140800 |
| Theta range for data collection, ° | 1.431 to 23.286 |
| Completeness to Θₘₐₓ % | 99.9% |
| Index ranges | −52 <= h <= 54, |
| | −54 <= k <= 33, |
| | −46 <= l <= 50 |
| Reflections collected | 203268 |
| Independent reflections | 7934 |
| R(int) | 0.2023 |
| Data/restraints/parameters | 7934/2/167 |
| Goodness-of-fit on F² | 1.123 |
| R₁^{[a]} (I > 2σ(I)) | 0.1926 |
| wR₂^{[b]} (all data) | 0.4438 |

^{[a]}R₁=Σ[|Fₒ|−|Fₒ|]/Σ|Fₒ|. ^{[b]}wR₂=[Σw(Fₒ²−Fₒ²)²/Σw(F_{c}²)²]^{1/2}

### Example 12: Structure of the [Pd₄₀{(CH₃)₂AsO₂}₁₆(μ₂-OH)₈(μ₂-ONa)₈(μ₄-O)₂₄] Cluster in “Pd₄₀{(CH₃)₂AsO₂}₁₆—SiW₁₂O₄₀”

The structure of the [Pd₄₀{(CH₃)₂AsO₂}₁₆(μ₂-OH)₈(μ₂-ONa)₈(μ₄-O)₂₄] cluster is displayed in FIG. 9. The 40 square planar Pd²⁺ ions form one ring containing 8 Pd²⁺ ions surrounded by one ring containing 24 Pd²⁺ ions and two rings containing 4 Pd²⁺ ions each.

A first H-bonded supramolecular octahedral assembly of the [Pd₄₀{(CH₃)₂AsO₂}₁₆(μ₂-OH)₈(μ₂-ONa)₈(μ₄-O)₂₄] clusters and [SiW₁₂O₄₀]⁴⁻ anions is displayed in FIG. 10. The [Pd₄₀{(CH₃)₂AsO₂}₁₆(μ₂-OH)₈(μ₂-ONa)₈(μ₄-O)₂₄] clusters occupy the axial positions and the [SiW₁₂O₄₀]⁴⁻ anions occupy the equatorial positions.

A second H-bonded supramolecular octahedral assembly of the [Pd₄₀{(CH₃)₂AsO₂}₁₆(μ₂-OH)₈(μ₂-ONa)₈(μ₄-O)₂₄] clusters and [SiW₁₂O₄₀]⁴⁻ anions is displayed in FIG. 11. The [Pd₄₀{(CH₃)₂AsO₂}₁₆(μ₂-OH)₈(μ₂-ONa)₈(μ₄-O)₂₄] clusters occupy the corner positions and the [SiW₁₂O₄₀]⁴⁻ anions occupy the face positions.

The all-inorganic H-bonded supramolecular framework formed by the first [Pd₄₀{(CH₃)₂AsO₂}₁₆(μ₂-OH)₈(μ₂-ONa)₈(μ₄-O)₂₄] clusters and [SiW₁₂O₄₀]⁴⁻ anions is displayed in FIG. 12. The open spaces are filled with Na⁺-cations, sodium salts and water molecules.

### Example 13: Synthesis of “Pd₁₆{(CH₃)₂AsO₂}₈Cl₃”, i.e., Noble Metal-Oxo-Cluster [Pd₆{(CH₃)₂AsO₂}₈(μ₂-OH)₃(μ₂-ONa)₂(μ₄-O)₈Cl₃]·0.25{Na(CH₃)₂AsO₂}·17H₂O

PdCl₂ (0.097 g, 0.55 mmol) was dissolved in 4 mL of a sodium cacodylate buffer solution (0.37 M, pH=7). The solution was stirred at 20° C. for 2 days. The resulting dark red solution was filtered and kept for crystallization in an open vial. Thin red crystals were formed after 1 to 2 weeks, which were collected by filtration, washed with acetonitrile and air dried. Yield: 0.03 g (25% based on Pd). This product was analyzed by XRD, IR, elemental analysis, and TGA and was identified as [Pd₁₆{(CH₃)₂AsO₂}₈(μ₂-OH)₃(μ₂-ONa)₂(μ₄-O)₈Cl₃] cluster isolated in hydrated form and coordinated by sodium salts, i.e., isolated as [Pd₁₆{(CH₃)₂AsO₂}₈(μ₂-OH)₃(μ₂-ONa)₂(μ₄-O)₈Cl₃]·0.25{Na(CH₃)₂AsO₂}·17H₂O (“Pd₁₆ {(CH₃)₂AsO₂}₈Cl₃”).

### Example 14: Analysis of “Pd₁₆{(CH₃)₂AsO₂}₈Cl₃”

The IR spectrum with 4 cm⁻¹ resolution was recorded on a Nicolet Avatar 370 FT-IR spectrophotometer on KBr pellet sample (peak intensities: w=weak; m=medium; s=strong). The characteristic region of the noble metal-oxo cluster is the fingerprint region or the region between 1000-400 cm⁻¹ due to metal-oxygen stretching and bending vibrations: 3600-3300 (s) [υ(O—H) of H₂O and hydroxyl], 3000-2920 (w) [υ(C—H) of methyl groups of cacodylate and acetate], 1635 (m) [H₂O bending fundamental mode δ], 1410 (m) [δ(C—H) of the methyl groups of cacodylate], 1271 (m) [δᵢₙ₋ₚₗₐₙₑ(O—H)], 906-888 (w) [δ_{out-of-plane}(O—H)], 829-576 (s) [υ(Pd—O)], 543-464 (m) [υ(As—C)]. The FT-IR spectrum is shown in FIG. 13.

Elemental analysis for “Pd₁₆{(CH₃)₂AsO₂}₈Cl₃” calculated (found): C, 5.65 (5.98), H, 2.49 (2.68), As, 17.62 (17.89), Na, 1.47 (1.43), Cl, 3.03 (3.08), Pd, 48.54 (48.9).

Thermogravimetric analysis (TGA) was performed on a SDT Q 600 device from TA Instruments with 10-30 mg samples in 100 μL alumina pans, under a 100 mL/min N₂ flow with a heating rate of 5° C./min between 20° C. and 600° C. (FIG. 14). The TGA data indicates that the lattice water molecules of the supramolecular framework structure gets removed in the temperature range of 20° C. to 100° C. (˜10% weight loss). This result is in good agreement with that obtained by elemental analysis to determine the amount of water of crystallization present in the noble metal-oxo cluster. The TGA data indicates that the compound is stable up to ˜200° C.

### Example 15: Single Crystal X-Ray Diffraction (XRD) Data and Analysis of “Pd₁₆{(CH₃)₂AsO₂}₈Cl₃”

Besides IR, elemental analysis and TGA the product was also characterized by single-crystal XRD. The crystal was mounted in Hampton cryoloop at 100 K using light oil for data collection. The XRD data was collected at 100 K. Indexing and data collection were carried on a Bruker Kappa X8 APEX II CCD single crystal diffractometer with κ geometry and Mo Kα radiation (λ=0.71073 Å). The SHELX software package (Bruker) was used to solve and refine the structure. An empirical absorption correction was applied using the SADABS program as disclosed in G. M. Sheldrick, SADABS, Program for empirical X-ray absorption correction, Bruker-Nonius: Madison, Wis. (1990). The structure was solved by direct method and refined by the full-matrix least squares method (Σw(|Fₒ|²−|F_{c}|²)²) with anisotropic thermal parameters for all heavy atoms included in the model. The H atoms were not located. Also, it was not possible to locate the {Na(CH₃)₂AsO₂} units and crystal water molecules by XRD, due to crystallographic disorder. Their exact numbers in the “Pd₁₆{(CH₃)₂AsO₂}₈Cl₃” were thus based on elemental analysis and TGA. Compound “Pd₁₆{(CH₃)₂AsO₂}₈Cl₃” crystallizes in the triclinic space group P-1. Crystallographic data are detailed in Table 4.

TABLE 4
Crystal data for “Pd₁₆{(CH₃)₂AsO₂}₈Cl₃”

| Empirical formula | C₁₆H₄₈As₈Cl₃Pd₁₆O_{37.67} |
|---|---|
| Formula weight, g/mol | 3251.7 |
| Crystal system | Trigonal |
| Space group | P-3c1 |
| a, Å | 34.202(3) |
| b, Å | 34.202(3) |
| c, Å | 12.9075(10) |
| α, ° | 90 |
| β, ° | 90 |
| γ, ° | 120 |
| Volume, A³ | 13076(2) |
| Z | 2 |
| D_{calc}, g/cm³ | 2.477 |
| Absorption coefficient, mm⁻¹ | 6.378 |
| F(000) | 8978 |
| Theta range for data collection, ° | 1.375 to 25.038 |
| Completeness to Θₘₐₓ % | 99.9% |
| Index ranges | −40 <= h <= 40, |
| | −40 <= k <= 40, |
| | −15 <= l <= 15 |
| Reflections collected | 153789 |
| Independent reflections | 7717 |
| R(int) | 0.1580 |
| Data/restraints/parameters | 7717/180/360 |
| Goodness-of-fit on F² | 1.030 |
| R₁^{[a]} (I > 2σ(I)) | 0.1051 |
| wR₂^{[b]} (all data) | 0.2109 |

^{[a]}R₁=Σ[|Fₒ|−|Fₒ|]/Σ|Fₒ|. ^{[b]}wR₂=[Σw(Fₒ²−Fₒ²)²/Σw(F_{c}²)²]^{1/2}

### Example 16: Structure of the [Pd₁₆{(CH₃)₂AsO₂}₈(μ₂-OH)₃(μ₂-ONa)₂(μ₄-O)₈Cl₃] Cluster

The structure of the [Pd₁₆{(CH₃)₂AsO₂}₈(μ₂-OH)₃(μ₂-ONa)₂(μ₄-O)₈Cl₃] cluster is displayed in FIG. 15. The 8 square planar Pd²⁺ ions are capped by the 8 cacodylate anions and are interconnected by (μ₄-O)²⁻ ions. The Pd₈ planar ring is further connected through (μ₄-O)²⁻ ions to two Pd₄(μ₂-OH)₄, one above and one below the planar ring. 3 (μ₂-OH)⁻ groups are partially replaced by 3 Cl⁻.

### Example 17: Synthesis of “Pd₄₀{(CH₃)₂AsO₂}₁₆—GeW₁₂O₄₀”, i.e., Noble Metal-Oxo-Cluster [Pd₄₀ {(CH₃)₂AsO₂}₁₆(μ₂-OH)₁₆(μ₄-O)₂₄]·2.5{Na₄(GeW₁₂O₄₀)}·4{Na(CH₃)₂AsO₂}·110H₂O

A mixture of Pd(CH₃COO)₂ (0.254 g, 1.10 mmol) and Na₁₀[A-α-GeW₉O₃₄]·18H₂O (0.565 g, 0.2 mmol) was dissolved in 6 mL of a sodium dimethylarsinate (or sodium cacodylate) buffer solution (1 M, pH=7), and stirred at room temperature (20° C.) for 2 days. The pH of the solution which was found to be ˜6.6 was then adjusted to ˜8.0 by the addition of 6 M aq. NaOH solution and the resulting deep red solution was stirred further for 1 day at room temperature. The solution was filtered and kept for crystallization in an open vial at room temperature. Deep red cube-shaped crystals were obtained within a week, which were collected by filtration, washed with acetonitrile and air dried. Yield: 20% based on Pd. This product was analyzed by XRD, IR, elemental analysis, and TGA and was identified as [Pd₄₀{(CH₃)₂AsO₂}₁₆(μ₂-OH)₁₆(μ₄-O)₂₄] cluster isolated in hydrated form and coordinated by germanium salts including inter alia Na₄(GeW₁₂O₄₀) i.e., isolated as [Pd₄₀ {(CH₃)₂AsO₂}₁₆(μ₂-OH)₁₆(μ₄-O)₂₄]·2.5{Na₄(GeW₁₂O₄₀)}·4{Na(CH₃)₂AsO₂}·110H₂O (“Pd₄₀{(CH₃)₂AsO₂}₁₆—GeW₁₂O₄₀”).

### Example 18: Analysis of “Pd₄₀{(CH₃)₂AsO₂}₁₆—GeW₁₂O₄₀”

The IR spectrum with 4 cm⁻¹ resolution was recorded on a Nicolet Avatar 370 FT-IR spectrophotometer on KBr pellet sample (peak intensities: w=weak; m=medium; s=strong). The characteristic region of the noble metal-oxo cluster is the fingerprint region or the region between 1000-400 cm⁻¹ due to metal-oxygen stretching and bending vibrations: 3600-3200 (s), 3100-2900 (w), 1628 (s), 1550 (w), 1405 (m), 1265 (m), 990 (w), 945 (w), 720 (w), 595 (w), 825 (s), 805 (s), 660 (m), 585 (m). The FT-IR spectrum is shown in FIG. 16.

Elemental analysis for “Pd₄₀{(CH₃)₂AsO₂}₁₆—GeW₁₂O₄₀” calculated (found): C, 2.83 (3.10), H, 2.11 (1.93), As, 8.84 (8.69), Na, 1.9 (2.10), Pd, 25.13 (25.8), Ge, 1.07 (1.07), W, 32.5 (30.39).

Thermogravimetric analysis (TGA) was performed on a SDT Q 600 device from TA Instruments with 10-30 mg samples in 100 μL alumina pans, under a 100 mL/min N₂ flow with a heating rate of 5° C./min between 20° C. and 600° C. (FIG. 17). The TGA data indicates that the lattice water molecules of the supramolecular framework structure gets removed in the temperature range of 20° C. to 100° C. (˜12% weight loss). This result is in good agreement with that obtained by elemental analysis to determine the amount of water of crystallization present in the noble metal-oxo cluster. The TGA data indicates that the compound is stable up to −200° C.

### Example 19: Single Crystal X-Ray Diffraction (XRD) Data and Analysis of “Pd₄₀{(CH₃)₂AsO₂}₁₆—GeW₁₂O₄₀”

Besides IR, elemental analysis and TGA, it was also attempted to characterize the product by single-crystal XRD. The crystal was mounted in Hampton cryoloop at 100 K using light oil for data collection. The XRD data was collected at 100 K. Indexing and data collection were carried on a Bruker Kappa X8 APEX II CCD single crystal diffractometer with κ geometry and Mo Kα radiation (λ=0.71073 Å). It was not possible to collect a proper single-crystal XRD dataset for lack of appropriate quality single crystals. However, the unit cell parameters could be measured, showing the following results: a=b=c=49.4955 (14) Å, α=β=γ=90°, Volume=121254(10) Å³.

### Example 20: Structure of the [Pd₄₀{(CH₃)₂AsO₂}₁₆(μ₂-OH)₁₆(μ₄-O)₂₄] Cluster in “Pd₄₀{(CH₃)₂AsO₂}₁₆—GeW₁₂O₄₀”

Due to lack of proper single-crystal XRD data, the atomic coordinates could not be calculated for the single-crystal structure. However, from the unit cell parameters, it is clear that the single-crystal structure of [Pd₄₀{(CH₃)₂AsO₂}₁₆(μ₂-OH)₁₆(μ₄-O)₂₄] cluster in “Pd₄₀{(CH₃)₂AsO₂}₁₆—GeW₁₂O₄₀” is similar to that of the [Pd₄₀{(CH₃)₂AsO₂}₁₆(μ₂-OH)₈(μ₂-ONa)₈(μ₄-O)₂₄] cluster in “Pd₄₀{(CH₃)₂AsO₂}₁₆—SiW₁₂O₄₀” albeit with [GeW₁₂O₄₀] replacing [SiW₁₂O₄₀].

### Example 21: Synthesis of “Pd₄₀{(CH₃)₂AsO₂}₁₆—Ba”, i.e., Noble Metal-Oxo-Cluster [Pd₄₀{(CH₃)₂AsO₂}₁₆(μ₂-OH)₁₆(μ₄-O)₂₄]·5Ba(NO₃)₂·7{Na(CH₃)₂AsO₂}·2{Na(CH₃COO)}·NaNO₃·80H₂O

A mixture of Pd(CH₃COO)₂ (0.04 g, 0.18 mmol) and Ba(NO₃)₂ (0.06 g, 0.23 mmol) was dissolved in 3 mL of a sodium dimethylarsinate (or sodium cacodylate) buffer solution (0.5 M, pH=6.5), and stirred at room temperature (20° C.) for 14 hours. The pH of the solution was then adjusted to −7.5 by the addition of NaOH solution and the resulting deep red solution was stirred for 10 hours at room temperature. The solution was filtered and kept for crystallization in an open vial at room temperature. Dark brown precipitate was formed after about 1-2 month, which was further recrystallized from deionized water over a period of 1-2 weeks to obtain dark red plate-shaped crystals. The crystals were collected by filtration, washed with acetonitrile and air dried. Yield: 5% based on Pd. This product was analyzed by XRD, IR, and elemental analysis and was identified as [Pd₄₀{(CH₃)₂AsO₂}₁₆(μ₂-OH)₁₆(μ₄-O)₂₄] cluster isolated in hydrated form and coordinated by barium salts including inter alia Ba(NO₃)₂, i.e., isolated as [Pd₄₀{(CH₃)₂AsO₂}₁₆(μ₂-OH)₁₆(μ₄-O)₂₄]·5Ba(NO₃)₂·7{Na(CH₃)₂AsO₂}·2{Na(CH₃COO)}·NaNO₃·80H₂O (“Pd₄₀{(CH₃)₂AsO₂}₁₆—Ba”).

### Example 22: Analysis of “Pd₄₀{(CH₃)₂AsO₂}₁₆—Ba”

The IR spectrum with 4 cm⁻¹ resolution was recorded on a Nicolet Avatar 370 FT-IR spectrophotometer on KBr pellet sample (peak intensities: w=weak; m=medium; s=strong). The characteristic region of the noble metal-oxo cluster is the fingerprint region or the region between 1000-400 cm⁻¹ due to metal-oxygen stretching and bending vibrations: 3600-3200 (s), 3100-2900 (w), 1635 (s), 1560 (m), 1420 (m), 1385 (s), 1270 (w), 1120-1060 (m), 905 (w), 825 (s), 805 (s), 660 (m), 585 (m), 630 (w), 550 (w), 500 (m), 460 (m). The FT-IR spectrum is shown in FIG. 18.

Elemental analysis for “Pd₄₀{(CH₃)₂AsO₂}₁₆—Ba” calculated (found): C, 5.35 (6.43), H, 2.87 (3.06), N, 1.37 (1.39), As, 15.35 (15.5), Na, 2.04 (1.9), Pd, 37.9 (38.6), Ba, 6.12 (6.6).

### Example 23: Single Crystal X-Ray Diffraction (XRD) Data and Analysis of “Pd₄₀{(CH₃)₂AsO₂}₁₆—Ba”

Besides IR and elemental analysis, the product was also characterized by single-crystal XRD. The crystal was mounted in Hampton cryoloop at 100 K using light oil for data collection. The XRD data was collected at 100 K. Indexing and data collection were carried on a Bruker Kappa X8 APEX II CCD single crystal diffractometer with κ geometry and Mo Kα radiation (λ=0.71073 Å). The SHELX software package (Bruker) was used to solve and refine the structure. An empirical absorption correction was applied using the SADABS program as disclosed in G. M. Sheldrick, SADABS, Program for empirical X-ray absorption correction, Bruker-Nonius: Madison, Wis. (1990). The structure was solved by direct method and refined by the full-matrix least squares method (Σw(|Fₒ|²−|F_{c}|²)₂) with anisotropic thermal parameters for all heavy atoms included in the model. The H atoms were not located. Also, it was not possible to locate the Na ions of the {Na(CH₃)₂AsO₂} units, {Na(CH₃COO)} units, and NaNO₃ and crystal water molecules by XRD, due to crystallographic disorder. Their exact numbers in the “Pd₄₀{(CH₃)₂AsO₂}₁₆—Ba” were thus based on elemental analysis. Compound “Pd₄₀{(CH₃)₂AsO₂}₁₆—Ba” crystallizes in the monoclinic space group C2/c. Crystallographic data are detailed in Table 5.

TABLE 5
Crystal data for “Pd₄₀{(CH₃)₂AsO₂}₁₆—Ba”

| Empirical formula | C₅₀H₃₂₀As₂₃Na₁₀Pd₄₀O₂₀₃Ba₅N₁₁ |
|---|---|
| Formula weight, g/mol | 11221.56 |
| Crystal system | Monoclinic |
| Space group | C2/c |
| a, Å | 29.136(4) |
| b, Å | 27.596(4) |
| c, Å | 30.631(5) |
| α, ° | 90 |
| β, ° | 99.527(4) |
| γ, ° | 90 |
| Volume, | 24290(6) |
| Z | 4 |
| D_{calc}, g/cm³ | 2.195 |
| Absorption coefficient, mm⁻¹ | 5.886 |
| F(000) | 14552 |
| Theta range for data collection, ° | 1.476 to 25.180 |
| Completeness to Θₘₐₓ % | 98.5% |
| Index ranges | −34 <= h <= 34, |
| | −32 <= k <= 32, |
| | −36 <= l <= 36 |
| Reflections collected | 296892 |
| Independent reflections | 21506 |
| R(int) | 0.2887 |
| Data/restraints/parameters | 21506/519/840 |
| Goodness-of-fit on F² | 1.148 |
| R₁^{[a]} (I > 2σ(I)) | 0.1716 |
| wR₂^{[b]} (all data) | 0.3190 |

^{[a]}R₁=Σ[|Fₒ|−|Fₒ|]/Σ|Fₒ|. ^{[b]}wR₂=[Σw(Fₒ²−Fₒ²)²/Σw(F_{c}²)²]^{1/2}

### Example 24: Structure of the [Pd₄₀{(CH₃)₂AsO₂}₁₆(μ₂-OH)₁₆₈(μ₄-O)₂₄] Cluster in “Pd₄₀{(CH₃)₂As O₂}₁₆—Ba”

The structure of the [Pd₄₀{(CH₃)₂AsO₂}₁₆(μ₂-OH)₁₆(μ₄-O)₂₄] cluster is displayed in FIG. 19. The 40 square planar Pd²⁺ ions form one ring containing 8 Pd²⁺ ions surrounded by one ring containing 24 Pd²⁺ ions and two rings containing 4 Pd²⁺ ions each.

Each [Pd₄₀{(CH₃)₂AsO₂}₁₆(μ₂-OH)₁₆(μ₄-O)₂₄] cluster is surrounded by Ba²⁺ ions and is associated with the cluster through weak electrostatic interactions.

### Example 25: Synthesis of Supported Noble Metal-Oxo Clusters (“Pd₁₆{(CH₃)₂AsO₂}₈”, “Pd₂₄{(CH₃)₂AsO₂}₁₆” “Pd₄₀{(CH₃)₂AsO₂}₁₆—SiW₁₂O₄₀”, and “Pd₆{(CH₃)₂AsO₂}₈Cl₃”)

### Synthesis of Mesoporous Silica Support SBA-15

8.0 g of Pluronic® P-123 gel (Mn˜5,800, Sigma-Aldrich) were added to 40 mL of 2 M HCl and 208 mL H₂O. This mixture was stirred for 2 hours in a water bath at 35° C. until it was completely dissolved. Then 18 mL of tetraethylorthosilicate (TEOS) was added dropwise, and the mixture was kept under stirring for 4 hours. Afterwards, the mixture was heated in an oven at 95° C. for 3 days. The white precipitate was collected by filtration, washed and air-dried. Finally, the product was calcined by heating the as-synthesized material to 550° C. at a rate of 1-2° C./min and kept at 550° C. for 6 hours to remove the templates.

### Synthesis of Modified SBA-15-Apts

1.61 mL of 3-aminopropyltriethoxysilane (apts) was added to 3 g of SBA-15, prepared according to the synthesis described above, in 90 mL toluene. This mixture was refluxed for 5 hours and then filtered at room temperature. The obtained modified SBA-15-apts was heated at 100° C. for 5 hours.

Preparation of Noble Metal-Oxo Clusters Supported on SBA-15-Apts (“Supported Noble Metal-Oxo Clusters”, i.e., Supported “Pd₁₆{(CH₃)₂AsO₂}₈”, Supported “Pd₂₄{(CH₃)₂AsO₂}₁₆”, Supported “Pd₄₀{(CH₃)₂AsO₂}₁₆—SiW₁₂O₄₀”, and Supported “Pd₁₆{(CH₃)₂AsO₂}₈Cl₃”)

The respective noble metal-oxo cluster (“Pd₁₆ {(CH₃)₂AsO₂}₈”, “Pd₂₄{(CH₃)₂AsO₂}₁₆”, “Pd₄₀{(CH₃)₂AsO₂}₁₆—SiW₁₂O₄₀”, and “Pd₁₆{(CH₃)₂AsO₂}₈Cl₃”) was dissolved in water (0.056 mmol/L), resulting in a colored solution. While stirring, SBA-15-apts was slowly added to the solution of the noble metal-oxo cluster so that the respective amounts of the noble metal-oxo cluster and SBA-15-apts were 5 wt % and 95 wt %, respectively. The mixture was kept under stirring for 24 hours at 40° C., filtered and then washed three times with water. The filtrate was colorless, indicating that the respective noble metal-oxo cluster was quantitatively loaded on the SBA-15-apts support, resulting in a supported noble metal-oxo cluster loading level on the solid support of about 5 wt %. The supported product was then collected and air-dried.

### Example 26: Activation of Supported Noble Metal-Oxo Clusters and Preparation of Supported Noble Metal-Oxo Cluster-Derived Metal Cluster Units (Supported “Pd₁₆{(CH₃)₂AsO₂}₈”-Derived Metal Cluster Unit, Supported “Pd₂₄{(CH₃)₂AsO₂}₁₆”-Derived Metal Cluster Unit, Supported “Pd₄₀{(CH₃)₂AsO₂}₁₆—SiW₁₂O₄₀”-Derived Metal Cluster Unit, and Supported “Pd₁₆{(CH₃)₂AsO₂}₈Cl₃”-Derived Metal Cluster Unit)

The supported noble metal-oxo clusters prepared according to example 25 were activated or transformed into the corresponding supported metal cluster units.

In a first example 26a, supported noble metal-oxo clusters prepared according to example 25 were activated by air calcination at 300° C. for 3 hours. In a second example 26b, supported noble metal-oxo clusters prepared according to example 25 were converted into corresponding supported noble metal-oxo cluster-derived metal cluster units by H₂ reduction at 300° C., 50 bar for 24 hours. In a third example 26c, supported noble metal-oxo clusters prepared according to example 25 were treated by the same method of example 26b, but followed with air calcination at 550° C. for 4.5 hours. In a fourth example 26d, supported noble metal-oxo clusters prepared according to example 25 were converted into corresponding supported noble metal-oxo cluster-derived metal cluster units by a chemical reduction conducted by suspending 100 mg of supported noble metal-oxo cluster in 15 mL of water followed by the addition of about 0.25 mL of hydrazine hydrate. The resulting solution was stirred for 12 hours, filtered, dried and then air calcined at 300° C. for 3 hours.

Without being bound by any theory, it is believed that calcination and optional hydrogenation or chemical reduction helps to activate the noble metal-oxo clusters by forming active sites.

### Example 27: Activation of Supported Noble Metal-Oxo Clusters and Preparation of Supported Noble Metal-Oxo Cluster-Derived Metal Cluster Units (Supported “Pd₁₆{(CH₃)₂AsO₂}₈”-Derived Metal Cluster Unit, Supported “Pd₂₄{(CH₃)₂AsO₂}₁₆”-Derived Metal Cluster Unit, Supported “Pd₄₀{(CH₃)₂AsO₂}₁₆—SiW₁₂O₄₀”-Derived Metal Cluster Unit, and Supported “Pd₁₆{(CH₃)₂AsO₂}₈Cl₃”-Derived Metal Cluster Unit)

The supported noble metal-oxo clusters prepared according to example 25 were activated by air calcination and then transformed into the corresponding supported noble metal-oxo cluster-derived metal cluster units by H₂ reduction.

In a first example 27a, supported noble metal-oxo clusters prepared according to example 25 were activated by air calcination at 150° C. for 1 hour. In a second example 27b, supported noble metal-oxo clusters prepared according to example 25 were activated by air calcination at 200° C. for 1 hour. In a third example 27c, supported noble metal-oxo clusters prepared according to example 25 were activated by air calcination at 300° C. for 30 minutes. In a fourth example 27d, supported noble metal-oxo clusters prepared according to example 25 were activated by air calcination at 550° C. for 30 minutes.

The activated supported noble metal-oxo clusters of examples 27a, 27b, 27c and 27d were converted into corresponding supported noble metal-oxo cluster-derived metal cluster units by H₂ reduction at 240° C. and 60 bar under stirring at 1500 rpm for 1-2 minutes. The H₂ reduction was conducted in-situ prior to the further use of the supported noble metal-oxo cluster-derived metal cluster units in order to provide fresh supported noble metal-oxo cluster-derived metal cluster units.

Without being bound by any theory, it is believed that calcination and hydrogenation helps to activate the noble metal-oxo clusters by forming active sites.

### Example 28: Preparation, Activation and Use of “Pd₄₀{(CH₃)₂AsO₂}₁₆—SiW₁₂O₄₀” Supported on SBA-15-apts (“Pd₄₀—SiW₁₂@SBA-15-Apts”)

### Synthesis of Mesoporous Silica Support SBA-15

120.0 g of Pluronic® P123 (Mn˜5,800, Sigma Aldrich) was stirred in a mixture of 100 ml of 37% HCl and 3.6 L of water until complete dissolution (˜4 hours). To this solution, 270 ml of tetraethylorthosilicate (TEOS) was added dropwise and the mixture was kept under stirring in a water bath for 16 hours at 36° C. Subsequently, the solution was aged at 95° C. under static conditions for 3 days. The resulting white precipitate was collected by filtration, washed, dried in air for 2 days, and calcined at 550° C. for 6 hours under air with a heating rate of 1° C./min in order to remove the template.

### Synthesis of Modified SBA-15-Apts

A mixture of 3-aminopropyltriethoxysilane (apts) (18 ml) and said SBA-15 (33.0 g) was refluxed for 5 hours in 1 litre of toluene followed by filtration at room temperature. The resultant white powder was dried at 100° C. for 5 hours to obtain the modified SBA-15-apts. Preparation of “Pd₄₀{(CH₃)₂AsO₂}₁₆—SiW₁₂O₄₀” supported on SBA-15-apts (“Pd₄₀—SiW₁₂@SBA-15-apts”)

114.2 mg of “Pd₄₀{(CH₃)₂AsO₂}₁₆—SiW₁₂O₄₀” (0.0078 mmol) as prepared according to Example 9 were dissolved in 50 mL of deionized water followed by the slow addition of 3.285 g of the SBA-15-apts under stirring. The quantities of the materials were taken such that the resultant composite material would have a ˜1 wt % Pd-loading. After stirring for a day, the mixture was filtered under vacuum and the residue was washed three times with deionized water and air-dried. The filtrate was found to be colourless, which indicated quantitative loading. The dried “Pd₄₀—SiW₁₂@SBA-15-apts” composite material was then calcined at 250° C. for 4 hours (heating rate of 0.5° C./min) to obtain the calcined pre-catalyst. Use of “Pd₄₀—SiW₁₂@SBA-15-apts” for the catalytic hydrogenation of arenes

The calcined pre-catalyst was activated in situ by reduction under H₂ in the Parr compact reactor used for the catalytic hydrogenation of arenes.

In a typical reaction, 100 mg of “Pd₄₀—SiW₁₂@SBA-15-apts” (0.009 mmol Pd content) was introduced into a 100 mL stainless-steel high-pressure Parr Compact reactor and 50 mL of a 0.5 M solution of the monocyclic arenes (o-xylene, p-xylene, m-xylene or toluene) or 50 mL of a 0.3 M solution of the bicyclic arene (naphthalene) in n-hexane was added. The catalyst was then activated by reduction in situ under H₂ (˜50 bar) at a temperature of 250° C. and subsequently the reaction was started by increasing the temperature to 300° C. and stirring the reaction mixture at 1000 rpm keeping the initial H₂ pressure at ˜90 bar. Instead of using milder H₂ pressures, a high reaction pressure of ˜90 bar was used in order to drive the reaction forward using the Le Chatelier's principle. The progress of the reaction was followed by monitoring the consumption of H₂ (pressure decrease) and gas chromatography (GC) analysis and the completion of the reaction was correlated with no further decrease in the H₂ pressures.

Recyclability experiments on the catalyst were performed by filtering off and drying the used catalyst and utilizing it again in subsequent catalytic cycles under the same reaction conditions.

The hot filtration experiment to gauge the heterogeneous nature of the catalytic reaction was performed by stopping the reaction after 20 min and filtering the reaction mixture at 50° C. The filtrate was then added to a clean reactor and subjected to the same reaction conditions. For monocyclic arenes, the reaction rate was found to be in the order o-xylene<m-xylene≈p-xylene<toluene. For the bicyclic naphthalene, quantitative conversion was observed after ˜200 minutes with a tetralin:cis-decalin:trans-decalin ratio of 74:4:22. The summary of the catalytic reactions is shown in Table 6.

TABLE 6
Comparison of reaction times, conversion and selectivity utilizing different monocyclic and bicyclic arenes as substrates.

| | | Reaction | | Selectivity |
|---|---|---|---|---|
| | | Time | Conversion | Ratio (S) |
| No. | Reactions | (mins) | (%) | (%/%) |
| 1 | 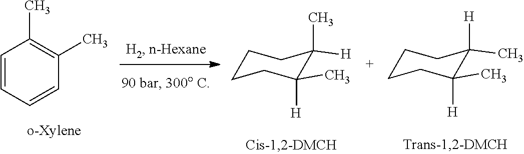 | 55 | ~99 | S_{c/t} = 37/63 |
| 2 | 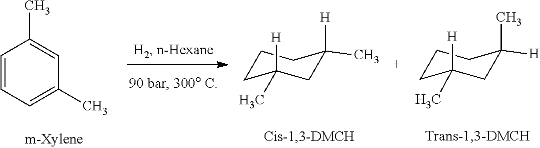 | 30 | ~99 | S_{c/t} = 76/24 |
| 3 | 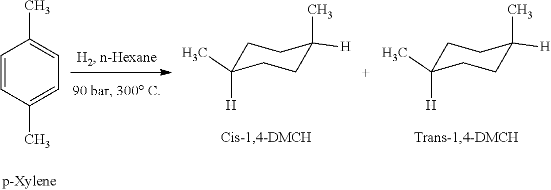 | 32 | ~98 | S_{c/t} = 49/60 |
| 4 | 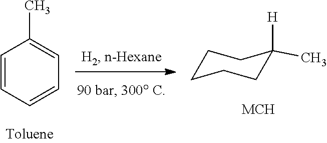 | 27 | ~100 | — |
| 5 | 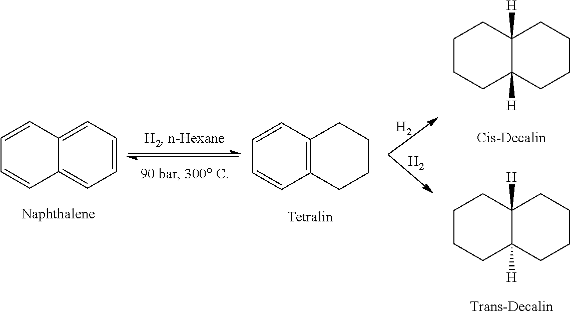 | 200 | ~100 | S_{c/t} = 74/4/22 |

All documents described herein are incorporated by reference herein, including any priority documents and/or testing procedures to the extent they are not inconsistent with this text. As is apparent from the foregoing general description and the specific embodiments, while forms of the invention have been illustrated and described, various modifications can be made without departing from the spirit and scope of the invention. Accordingly, it is not intended that the invention be limited thereby. Likewise, the term “comprising” is considered synonymous with the term “including” for purposes of Australian law.

### EMBODIMENTS

Additionally or alternately, the invention relates to the specific Embodiments:

Embodiment 1: Noble metal-oxo cluster represented by the formula

[Mₛ(R₂XO₂)_{z}(OR′)ₓO_{y}X′_{q}]

or solvates thereof, wherein
each M is independently selected from the group consisting of Pd, Pt, Rh, Ir, Ag and Au, and each M has d⁸ valence electron configuration,
each R is independently selected from the group consisting of hydrogen and substituted or unsubstituted hydrocarbyl, wherein each hydrocarbyl provides a carbon atom for coordination to X and wherein preferably no more than one R is hydrogen per (R₂XO₂) group,
each X is independently selected from the group consisting of P and As,
each R′ is independently selected from the group consisting of a proton or a monovalent cation,
each X′ is independently selected from the group consisting of monovalent anions,
s is a number from 8 to 96,
z is a number from 8 to 96,
x is a number from 2 to 48,
y is a number from 2 to 48, and
q is a number from 0 to 46,
with the proviso that x+q≤48.

Embodiment 2: Noble metal-oxo cluster of embodiment 1, wherein all M are the same; in particular wherein all M are Pd or Pt, preferably wherein all M are Pd.

Embodiment 3: Noble metal-oxo cluster according to embodiment 1 or 2, wherein all X are the same; in particular wherein all X are P, preferably wherein all X are As.

Embodiment 4: Noble metal-oxo cluster according to any one of the preceding embodiments, wherein each R, that is substituted or unsubstituted hydrocarbyl, is selected from the group consisting of unsubstituted or substituted alkyl, unsubstituted or substituted cycloalkyl, unsubstituted or substituted alkenyl, unsubstituted or substituted cycloalkenyl, unsubstituted or substituted alkynyl, and unsubstituted or substituted aryl, preferably unsubstituted or substituted alkyl, unsubstituted or substituted cycloalkyl, and unsubstituted or substituted aryl, more preferably unsubstituted or substituted alkyl and unsubstituted or substituted aryl, more preferably unsubstituted or substituted alkyl, more preferably an unsubstituted or substituted C₁-C₆ alkyl, more preferably an unsubstituted or substituted C₁-C₄ alkyl, most preferably an unsubstituted or substituted alkyl selected from —CH₃, —C₂H₅, -nC₃H₇, -iC₃H₇ and -tC₄H₉; in particular wherein each R is selected from the group consisting of unsubstituted alkyl, unsubstituted cycloalkyl, unsubstituted alkenyl, unsubstituted cycloalkenyl, unsubstituted alkynyl, and unsubstituted aryl, preferably unsubstituted alkyl, unsubstituted cycloalkyl, and unsubstituted aryl, more preferably unsubstituted alkyl and unsubstituted aryl, more preferably unsubstituted alkyl, more preferably an unsubstituted C₁-C₆ alkyl, more preferably an unsubstituted C₁-C₄ alkyl, most preferably an unsubstituted alkyl selected from —CH₃, —C₂H₅, -nC₃H₇, -iC₃H₇ and -tC₄H₉; in particular wherein all R are the same.

Embodiment 5: Noble metal-oxo cluster according to any one of the preceding embodiments, wherein each R′ is independently selected from the group consisting of a proton, monovalent cations of Li, Na, K, Rb and Cs, ammonium, guanidinium, tetraalkylammonium, protonated aliphatic amines and protonated aromatic amines, preferably a proton, monovalent cations of Li, Na, and K, ammonium, tetraalkylammonium, protonated aliphatic amines and protonated aromatic amines, more preferably a proton, monovalent cations of Li, Na and K, most preferably a proton; in particular wherein all R′ are the same; more particularly wherein all R′ are a proton, or a monovalent cation of Li, Na or K, most particularly wherein all R′ are a proton.

Embodiment 6: Noble metal-oxo cluster according to any one of the preceding embodiments, wherein each X′ is independently selected from the group consisting of monovalent anions of F, Cl, Br, I, CN, N₃, CP, FHF, SH, SCN, NCS, SeCN, CNO, NCO and OCN, preferably F, Cl, Br, I, CN, and N₃, more preferably Cl, Br, I and N₃, more preferably Cl, Br and I, most preferably Cl; in particular wherein all X′ are the same.

Embodiment 7: Noble metal-oxo cluster according to any one of the preceding embodiments, wherein s is 10 to 90, preferably s is 12 to 84, more preferably s is 14 to 72, and most preferably s is 16 to 54; in particular s is 12, 16, 18, 20, 24, 28, 32, 36, 40, 44, 48, 54, 60, 66, 72, 84 or 90, more particularly s is 16, 18, 24, 36, 40, 48, 60, 72 or 84, most particularly s is 16, 24 or 40.

Embodiment 8: Noble metal-oxo cluster according to any one of the preceding embodiments, wherein z is 8 to 90, preferably z is 8 to 72, more preferably z is 8 to 48, and most preferably z is 8 to 32; in particular z is 8, 10, 12, 14, 16, 18, 20, 22, 24, 26, 28, 30, 32, 36, 40, 44, 48, 54, 60, 66, 72, 84 or 90, more particularly z is 8, 12, 16, 20, 24, 28, 32, 36, 40 or 48, most particularly z is 8, 16 or 24.

Embodiment 9: Noble metal-oxo cluster according to any one of the preceding embodiments, wherein y is 4 to 40, preferably y is 6 to 36, more preferably y is 6 to 30, and most preferably y is 8 to 24; in particular y is 4, 6, 8, 10, 12, 14, 16, 18, 20, 22, 24, 26, 28, 30, 32, 36, 40, 44 or 48, more particularly y is 6, 8, 12, 16, 18, 20, 24, 32 or 36, most particularly y is 8, 12, 16 or 24.

Embodiment 10: Noble metal-oxo cluster according to any one of the preceding embodiments, wherein x is 4 to 40, preferably x is 6 to 36, more preferably x is 6 to 30, and most preferably x is 8 to 24; in particular x is 2, 4, 6, 8, 10, 12, 14, 16, 18, 20, 22, 24, 26, 28, 30, 32, 36, 40, 44 or 48, more particularly x is 4, 6, 8, 10, 12, 16, 18, 20, 24, 28 or 32, most particularly x is 8, 12 or 16.

Embodiment 11: Noble metal-oxo cluster according to any one of the preceding embodiments, wherein q is 0 to 36, preferably q is 0 to 24, more preferably q is 0 to 16, and most preferably q is 0; in particular q is 0, 1, 2, 3, 4, 5, 6, 7, 8, 9, 10, 11, 12, 14, 16, 18, 20, 22, 24, 26, 28, 30, 32, 34, 36, 38, 40, 42, 44 or 48, more particularly q is 0, 1, 2, 3, 4, 5, 6, 7, 8, 9, 10, 11, 12, 14, 16, 18, 20, 24, 28 or 32, most particularly q is 0.

Embodiment 12: Noble metal-oxo cluster according to any one of the preceding embodiments, wherein all M are the same and selected from the group consisting of Pd and Pt, all X are the same and selected from the group consisting of P and As, all R are the same and selected from the group consisting of unsubstituted or substituted alkyl and unsubstituted or substituted aryl, each R′ is independently selected from the group consisting of a proton and a monovalent cation of Li, Na and K, and all X′ are the same and selected from the group consisting of monovalent anions of Cl, Br, I and N₃, wherein s is 12 to 84, z is 8 to 72, y is 6 to 36, x is 6 to 36 and q is 0 to 24; in particular all M are Pd, all X are As, all R are the same and selected from the group consisting of unsubstituted or substituted alkyl, each R′ is a proton, and all X′ are Cl, wherein s is 8 to 48, z is 8 to 72, y is 6 to 30, x is 6 to 30 and q is 0 to 16; more particularly all M are Pd, all X are As, all R are the same and selected from the group consisting of unsubstituted or substituted C₁-C₆ alkyl, and each R′ is a proton, wherein s is 8 to 48, z is 8 to 72, y is 6 to 30, x is 6 to 30 and q is 0.

Embodiment 13: Noble metal-oxo cluster according to any one of the preceding embodiments, wherein all M are the same and selected from the group consisting of Pd and Pt, all X are the same and selected from the group consisting of P and As, all R are the same and selected from the group consisting of unsubstituted or substituted alkyl and unsubstituted or substituted aryl, and each R′ is independently selected from the group consisting of a proton and a monovalent cation of Li, Na and K, wherein s is 12 to 84, z is 8 to 72, y is 6 to 36, x is 6 to 36 and q is 0; in particular all M are Pd, all X are As, all R are the same and selected from the group consisting of unsubstituted or substituted alkyl, and each R′ is a proton, wherein s is 8 to 48, z is 8 to 72, y is 6 to 30, x is 6 to 30 and q is 0; more particularly all M are Pd, all X are As, all R are the same and selected from the group consisting of unsubstituted or substituted C₁-C₄ alkyl, and each R′ is a proton, wherein s is 16 to 54, z is 8 to 32, y is 8 to 24, x is 8 to 24 and q is 0.

Embodiment 14: Noble metal-oxo cluster according to any one of the preceding embodiments, represented by the formula

[Mₛ(R₂XO₂)_{z}(OR′)ₓO_{y}X′_{q}]·w(H₂O)·w′(A)

wherein w represents the number of attracted water molecules per noble metal-oxo cluster [Mₛ(R₂XO₂)_{z}(OR′)ₓO_{y}X′_{q}], and ranges from 1 to 240, preferably from 8 to 200, more preferably from 10 to 180, most preferably from 12 to 150, and
wherein each A is a neutral entity that is attracted to the noble metal-oxo cluster [Mₛ(R₂XO₂)_{z}(OR′)ₓO_{y}X′_{q}], in particular the structure and composition of the neutral entities A is such that they are capable of linking individual noble metal-oxo clusters [Mₛ(R₂XO₂)_{z}(OR′)ₓO_{y}X′_{q}] to each other in the solid state, more particularly wherein A is selected from the group consisting of carboxylic acids and derivatives thereof, phosphinic acids and derivatives thereof, arsenic acids and derivatives thereof, silicates, and tungstosilicates, wherein w′ represents the number of attracted neutral entities A per noble metal-oxo cluster [Mₛ(R₂XO₂)_{z}(OR′)ₓO_{y}X′_{q}], and ranges from 0 to 50, preferably from 0.10 to 25, more preferably from 0.15 to 20, most preferably from 0.20 to 10.

Embodiment 15: Noble metal-oxo cluster according to any one of the preceding embodiments, wherein the noble metal-oxo cluster is in the form of a solution-stable noble metal-oxo cluster.

Embodiment 16: Process for the preparation of the noble metal-oxo cluster of any one of embodiments 1 to 15, said process comprising:
(a) reacting at least one source of M and at least one source of R₂XO₂ and optionally at least one source of X′ to form a noble metal-oxo cluster [Mₛ(R₂XO₂)_{z}(OR′)ₓO_{y}X′_{q}] or a solvate thereof,
(b) optionally adding at least one source of A to the reaction mixture of step (a) to form a noble metal-oxo cluster [Mₛ(R₂XO₂)_{z}(OR′)ₓO_{y}X′_{q}] or a solvate thereof with neutral entities A being attracted to the noble metal-oxo cluster [Mₛ(R₂XO₂)_{z}(OR′)ₓO_{y}X′_{q}] or a solvate thereof, and
(c) recovering the noble metal-oxo cluster or solvate thereof.

Embodiment 17: Process according to embodiment 16, wherein in step (a) the concentration of the metal ions originating from the source of M ranges from 0.001 to 1 mole/l, the concentration of the R₂XO₂ anions originating from the source of R₂XO₂ ranges from 0.01 to 5.0 mole/l, optionally the concentration of the X′ ions originating from the source of X′ ranges from 0.001 to 1 mole/l, and optionally in step (b) the concentration of the neutral entities A originating from the at least one source of A ranges from 0.001 to 5 mole/l.

Embodiment 18: Process according to embodiment 16 or 17, wherein in step (a) in the at least one source of M all M are the same, preferably all M are Pd or Pt or Ir or Rh, more preferably all M are Pd or Pt, most preferably all M are Pd; or wherein in step (a) the at least one source of M comprises at least two different M selected from Pd, Pt, Rh, Ir, Ag and Au, preferably selected from Pd, Pt, Ir and Rh, more preferably selected from Pd, Pt and Rh, most preferably Pd and Pt.

Embodiment 19: Process according to any one of embodiments 16 to 18, wherein water, an organic solvent or a combination thereof is used as solvent, preferably water or a combination of water with an organic solvent is used as solvent; in particular water is used as solvent; and/or wherein in step (a) the reaction mixture is kept at a temperature of from 5° C. to 60° C., preferably from 10° C. to 50° C., more preferably from 12° C. to 40° C., most preferably 15° C. to 30° C.

Embodiment 20: Process according to any one of embodiments 16 to 19, wherein step (a) is carried out in an aqueous solution, and the pH of the aqueous solution ranges from 3 to 11, preferably from 4 to 10, more preferably from 5 to 9, most preferably from 6 to 8; and/or wherein step (a) is carried out in an aqueous solution comprising a buffer, preferably a 0.10 to 5.0 M solution of a buffer, more preferably a 0.15 to 2.5 M solution of a buffer, and most preferably a 0.20 to 1.5 M solution of a buffer.

Embodiment 21: Process according to any one of embodiments 16 to 20, wherein the solvent contains water and the at least one source of M is a water-soluble salt containing M, in particular a water-soluble salt of Pt^{II} or Pd^{II} or Rh^{III} or Ir^{III} or Au^{III} or Ag^{I}, preferably wherein M is Pd, the water-soluble Pd^{II} salt is selected from palladium chloride (PdCl₂), palladium nitrate (Pd(NO₃)₂), palladium acetate (Pd(CH₃COO)₂) and palladium sulphate (PdSO₄); wherein M is Pt, the water-soluble Pt^{II} salt is selected from potassium tetrachloroplatinate (K₂PtCl₄) and platinum chloride (PtCl₂); wherein M is Rh, the water-soluble Rh^{I} salt is selected from [(C₆H₅)₃P]₂RhCl(CO) and [Rh(CO)₂Cl]₂; wherein M is Ir, the is [(C₆H₅)₃P]₂IrCl(CO); wherein M is Au, the water-soluble Au^{III} salt is selected from gold chloride (AuCl₃), gold hydroxide (Au(OH)₃) and chloroauric acid (HAuCl₄·aq); and wherein M is Ag, the water-soluble Ag^{I} salt preferably used for generating the desired Ag^{III} by oxidation is selected from silver nitrate (AgNO₃), silver fluoride (AgF) and silver chloride (AgCl); in particular wherein the at least one source of M comprises at least one M-containing species that further comprises X′ groups or groups that form X′ groups in step (a) such that the at least one source of M is capable of contributing to the formation of the X′ groups for the noble metal-oxo cluster [Mₛ(R₂XO₂)_{z}(OR′)ₓO_{y}X′_{q}] or a solvate thereof.

Embodiment 22: Process according to any one of embodiments 16 to 21, wherein the solvent contains water and the at least one source of R₂XO₂ is water-soluble, preferably wherein X is P, dimethylphosphinic acid (Me₂PO₂H) or suitable salts thereof, such as Me₂PO₂Li, Me₂PO₂Na, and Me₂PO₂K, diethylphosphinic acid (Et₂PO₂H) or suitable salts thereof, such as Et₂PO₂Li, Et₂PO₂Na, and Et₂PO₂K, diphenylphosphinic acid (Ph₂PO₂H) or suitable salts thereof, such as Ph₂PO₂Li, Ph₂PO₂Na, and Ph₂PO₂K, phenylphosphinic acid (PhHPO₂H) or suitable salts thereof, such as PhHPO₂Li, PhHPO₂Na, PhHPO₂K, bis(trifluoromethyl)phosphinic acid [(CF₃)₂PO₂H] or suitable salts thereof, such as (CF₃)₂PO₂Li, (CF₃)₂PO₂Na, (CF₃)₂PO₂K, dibutylphosphinic acid (Bu₂PO₂H) or suitable salts thereof, such as Bu₂PO₂Li, Bu₂PO₂Na, Bu₂PO₂K, butylmethylphosphinic acid (BuMePO₂H) or suitable salts thereof, such as BuMePO₂Li, BuMePO₂Na, BuMePO₂K, methylphenylphosphinic acid (MePhPO₂H) or suitable salts thereof, such as MePhPO₂Li, MePhPO₂Na, MePhPO₂K, or diarylphosphinic acid (Ar₂PO₂H) or suitable salts thereof, such as Ar₂PO₂Li, Ar₂PO₂Na Ar₂PO₂K, wherein Ar is selected independently from the group consisting of aminophenyl, nitrophenyl or tolyl; and wherein X is As, dimethylarsinic acid (Me₂AsO₂H) or suitable salts thereof, such as Me₂AsO₂Li, Me₂AsO₂Na, and Me₂AsO₂K, diethylarsinic acid (Et₂AsO₂H) or suitable salts thereof, such as Et₂AsO₂Li, Et₂AsO₂Na, and Et₂AsO₂K, diphenylarsinic acid (Ph₂AsO₂H) or suitable salts thereof, such as Ph₂AsO₂Li, Ph₂AsO₂Na, and Ph₂AsO₂K, phenylarsinic acid (PhHAsO₂H) or suitable salts thereof, such as PhHAsO₂Li, PhHAsO₂Na, PhHAsO₂K, bis(trifluoromethyl)arsinic acid [(CF₃)₂AsO₂H] or suitable salts thereof, such as (CF₃)₂AsO₂Li, (CF₃)₂AsO₂Na, (CF₃)₂AsO₂K, dibutylarsinic acid (Bu₂AsO₂H) or suitable salts thereof, such as Bu₂AsO₂Li, Bu₂AsO₂Na, Bu₂AsO₂K, butylmethylarsinic acid (BuMeAsO₂H) or suitable salts thereof, such as BuMeAsO₂Li, BuMeAsO₂Na, BuMeAsO₂K, methylphenylarsinic acid (MePhAsO₂H) or suitable salts thereof, such as MePhAsO₂Li, MePhAsO₂Na, MePhAsO₂K, or diarylarsinic acid (Ar₂AsO₂H) or suitable salts thereof, such as Ar₂AsO₂Li, Ar₂AsO₂Na Ar₂AsO₂K, wherein Ar is selected independently from the group consisting of aminophenyl, nitrophenyl or tolyl; in particular wherein the at least one source of R₂XO₂ comprises at least one R₂XO₂R′ species such that the at least one source of R₂XO₂ is capable of contributing to the formation of the (OR′) groups for the noble metal-oxo cluster [Mₛ(R₂XO₂)_{z}(OR′)ₓO_{y}X′_{q}] or a solvate thereof, in particular wherein each R′ in the at least one R₂XO₂R′ species is independently selected from the group consisting of a proton, Li, Na, K, ammonium, tetraalkylammonium, protonated aliphatic amines and protonated aromatic amines, more preferably a proton, Li, Na and K, most preferably a proton.

Embodiment 23: Process according to any one of embodiments 16 to 22, wherein the at least one source of M, the at least one source of R₂XO₂, the solvent in step (a), optionally the at least one source of X′, optionally the buffer or any combination thereof provides and/or forms neutral entities A being attracted to the noble metal-oxo cluster [Mₛ(R₂XO₂)_{z}(OR′)ₓO_{y}X′_{q}] or a solvate thereof.

Embodiment 24: Supported noble metal-oxo cluster comprising noble metal-oxo cluster according to any one of embodiments 1 to 15 or prepared according to any one of embodiments 16 to 23, on a solid support.

Embodiment 25: Supported noble metal-oxo cluster according to embodiment 24, wherein the solid support is selected from polymers, graphite, carbon nanotubes, electrode surfaces, aluminum oxide and aerogels of aluminum oxide and magnesium oxide, titanium oxide, zirconium oxide, cerium oxide, silicon dioxide, silicates, active carbon, mesoporous silica, zeolites, aluminophosphates (ALPOs), silicoaluminophosphates (SAPOs), metal organic frameworks (MOFs), zeolitic imidazolate frameworks (ZIFs), periodic mesoporous organosilicas (PMOs), and mixtures thereof.

Embodiment 26: Process for the preparation of supported noble metal-oxo cluster according to embodiment 24 or 25, comprising the step of contacting noble metal-oxo cluster according to any one of embodiments 1 to 15 or prepared according to any one of embodiments 16 to 23, with a solid support.

Embodiment 27: Metal cluster unit of the formula

[M⁰ₛ],

wherein
each M⁰ is independently selected from the group consisting of Pd⁰, Pt⁰, Rh⁰, Ir⁰, Ag⁰, and Au⁰, and
s is a number from 8 to 96.

Embodiment 28: Metal cluster unit according to embodiment 27, wherein all M⁰ are the same; preferably wherein all M⁰ are Pd⁰ or Pt⁰, more preferably wherein all M⁰ are Pd⁰.

Embodiment 29: Metal cluster unit according to embodiment 27 or 28, wherein s is 10 to 90, preferably s is 12 to 84, more preferably s is 14 to 72, and most preferably s is 16 to 54; in particulars is 12, 16, 18, 20, 24, 28, 32, 36, 40, 44, 48, 54, 60, 66, 72, 84 or 90, more particularly s is 16, 18, 24, 36, 40, 48, 60, 72 or 84, most particularly s is 16, 24 or 40.

Embodiment 30: Metal cluster unit according to any one of the embodiments 27 to 29, wherein all M⁰ are the same and selected form the group consisting of Pd⁰ or Pt⁰ and wherein s is 14 to 72; in particular wherein all M⁰ are Pd⁰ and wherein s is 16 to 54; more particularly wherein all M⁰ are Pd⁰ and wherein s is 16, 18, 24, 36, 40, 48, 60, 72 or 84.

Embodiment 31: Metal cluster unit according to any one of the embodiments 27 to 30, wherein the metal cluster unit is in the form of particles, preferably wherein at least 90 wt % of the metal cluster unit particles are in the form of primary particles.

Embodiment 32: Metal cluster unit according to any one of the embodiments 27 to 31, wherein the metal cluster unit is dispersed in a liquid carrier medium thereby forming a dispersion of metal cluster unit in said liquid carrier medium; and wherein preferably a dispersing agent is present to prevent agglomeration of the primary particles of metal cluster unit, and in particular the dispersing agent forms micelles containing one primary particle of metal cluster unit per micelle.

Embodiment 33: Metal cluster unit according to any one of the embodiments 27 to 32, wherein the metal cluster unit is immobilized on a solid support thereby forming supported metal cluster unit.

Embodiment 34: Supported metal cluster unit according to embodiment 33, wherein the solid support is selected from polymers, graphite, carbon nanotubes, electrode surfaces, aluminum oxide and aerogels of aluminum oxide and magnesium oxide, titanium oxide, zirconium oxide, cerium oxide, silicon dioxide, silicates, active carbon, mesoporous silica, zeolites, aluminophosphates (ALPOs), silicoaluminophosphates (SAPOs), metal organic frameworks (MOFs), zeolitic imidazolate frameworks (ZIFs), periodic mesoporous organosilicas (PMOs), and mixtures thereof.

Embodiment 35: Process for the preparation of the dispersion of metal cluster unit of embodiment 32, said process comprising the steps of
(a) dissolving the noble metal-oxo cluster of any one of embodiments 1 to 15 or prepared according to any one of embodiments 16 to 23, in a liquid carrier medium,
(b) optionally providing additive means to prevent agglomeration of the metal cluster unit to be prepared, and
(c) subjecting the dissolved noble metal-oxo cluster to chemical or electrochemical reducing conditions sufficient to at least partially reduce said noble metal-oxo cluster into corresponding metal cluster unit.

Embodiment 36: Process for the preparation of the supported metal cluster units of embodiment 33 or 34, comprising the steps of
(a) contacting the dispersion of metal cluster unit of embodiment 32 or prepared according to embodiment 35 with a solid support, thereby immobilizing at least part of the dispersed metal cluster unit onto the support; and
(b) optionally isolating the supported metal cluster unit.

Embodiment 37: Process for the preparation of the supported metal cluster units of embodiment 33 or 34, comprising the steps of
(a) subjecting the supported noble metal-oxo cluster of embodiment 24 or 25 or prepared according to embodiment 26 to chemical or electrochemical reducing conditions sufficient to at least partially reduce said noble metal-oxo cluster into corresponding metal cluster unit; and
(b) optionally isolating the supported metal cluster unit.

Embodiment 38: Process according to any one of embodiments 35 or 37, wherein the chemical reducing conditions comprise the use of a reducing agent selected from organic and inorganic materials which are oxidizable by Pd^{II}, Pt^{II}, Rh^{I} and Rh^{III}, Ir^{I} and Ir^{III}, Ag^{I} and Ag^{III} and Au^{I} and Au^{III}.

Embodiment 39: Process for the homogeneous or heterogeneous conversion of organic substrate comprising contacting said organic substrate with the noble metal-oxo cluster of any one of embodiments 1 to 15 or prepared according to any one of embodiments 16 to 23, and/or with the supported noble metal-oxo cluster of embodiment 24 or 25 or prepared according to embodiment 26, and/or with the metal cluster unit of any one of embodiments 27 to 31, and/or with the dispersion of metal cluster unit of embodiment 32 or prepared according to embodiment 35 or 38, and/or with the supported metal cluster unit of embodiment 33 or 34 or prepared according to any one of embodiments 36 to 38.

Embodiment 40: Process according to embodiment 39, comprising:
(a) contacting a first organic substrate with one or more optionally supported noble metal-oxo clusters and/or one or more supported metal cluster units,
(b) recovering the one or more optionally supported noble metal-oxo clusters and/or the one or more supported metal cluster units;
(c) contacting the one or more optionally supported noble metal-oxo clusters and/or the one or more supported metal cluster units with a solvent at a temperature of 50° C. or more, and/or hydrogen stripping the one or more optionally supported noble metal-oxo clusters and/or the one or more supported metal cluster units at elevated temperature, and/or calcining the one or more optionally supported noble metal-oxo clusters and/or the one or more supported metal cluster units at elevated temperature under an oxygen containing gas, e.g. air, or under an inert gas, e.g. nitrogen or argon, to obtain recycled one or more optionally supported noble metal-oxo clusters and/or one or more supported metal cluster units;
(d) contacting the recycled one or more optionally supported noble metal-oxo clusters and/or the one or more supported metal cluster units with a second organic substrate which may be the same as or different from the first organic substrate; and
(e) optionally repeating steps (b) to (d).

Embodiment 41: Use of bidentate (R₂XO₂) capping groups for the preparation of noble metal-oxo clusters and/or metal cluster units, in particular for the preparation of noble metal-oxo clusters according to embodiments 1 to 15 and/or metal cluster units according to embodiments 27 to 33.

1.-18. (canceled)

19. A noble metal-oxo cluster represented by the formula
[Mₛ(R₂XO₂)_{z}(OR′)ₓO_{y}X′_{q}]
or solvates thereof, wherein:
each M is independently selected from the group consisting of Pd, Pt, Rh, Ir, Ag and Au, and each M has d⁸ valence electron configuration,
each R is independently selected from the group consisting of hydrogen and substituted or unsubstituted hydrocarbyl, wherein each hydrocarbyl provides a carbon atom for coordination to X,
each X is independently selected from the group consisting of P and As,
each R′ is independently selected from the group consisting of a proton or a monovalent cation,
each X′ is independently selected from the group consisting of monovalent anions,
s is a number from 8 to 96,
z is a number from 8 to 96,
x is a number from 2 to 48,
y is a number from 2 to 48, and
q is a number from 0 to 46,
with the proviso that x+q≤48.

20. The noble metal-oxo cluster of claim 19, wherein all M are the same and all X are the same.

21. The noble metal-oxo cluster of claim 19, wherein all M are Pd or Pt; and all X are As.

22. The noble metal-oxo cluster according to claim 19, wherein each R is selected from the group consisting of unsubstituted or substituted C₁-C₆ alkyl.

23. The noble metal-oxo cluster according to claim 19, wherein each R is selected from —CH₃, —C₂H₅, -nC₃H₇, -iC₃H₇ and -tC₄H₉.

24. The noble metal-oxo cluster according to claim 19, wherein each R′ is independently selected from the group consisting of a proton, monovalent cations of Li, Na, K, Rb and Cs, ammonium, guanidinium, tetraalkylammonium, protonated aliphatic amines and protonated aromatic amines; and wherein each X′ is independently selected from the group consisting of monovalent anions of F, Cl, Br, I, CN, N₃, CP, FHF, SH, SCN, NCS, SeCN, CNO, NCO and OCN.

25. The noble metal-oxo cluster according to claim 19, wherein all R′ are the same and are a proton, or a monovalent cation of Li, Na or K; and wherein each X′ is independently selected from the group consisting of F, Cl, Br, I, CN, and N₃.

26. The noble metal-oxo cluster according to claim 19, wherein:
s is 14 to 72;
z is 8 to 48;
y is 6 to 30;
x is 6 to 30; and
q is 0 to 16.

27. The noble metal-oxo cluster according to claim 19, wherein:
s is 16, 24 or 40;
z is 8, 16 or 24;
y is 8, 12, 16 or 24;
x is 8, 12 or 16; and
q is 0.

28. The noble metal-oxo cluster according to claim 19, wherein all M are the same and selected from the group consisting of Pd and Pt, all X are the same and selected from the group consisting of P and As, all R are the same and selected from the group consisting of unsubstituted or substituted C₁-C₆ alkyl, each R′ is independently selected from the group consisting of a proton and a monovalent cation of Li, Na and K, and all X′ are the same and selected from the group consisting of monovalent anions of Cl, Br, I and N₃, wherein s is 12 to 84, z is 8 to 72, y is 6 to 36, x is 6 to 36 and q is 0 to 24.

29. The noble metal-oxo cluster according to claim 19, wherein all M are Pd, all X are As, all R are the same and selected from the group consisting of unsubstituted C₁-C₆ alkyl, each R′ is a proton, and all X′ are Cl, wherein s is 8 to 48, z is 8 to 72, y is 6 to 30, x is 6 to 30 and q is 0 to 16.

30. The noble metal-oxo cluster according to claim 19, wherein all M are Pd, all X are As, all R are the same and selected from the group consisting of unsubstituted C₁-C₆ alkyl, and each R′ is a proton, wherein s is 8 to 48, z is 8 to 72, y is 6 to 30, x is 6 to 30 and q is 0; or wherein s is 16 to 54, z is 8 to 32, y is 8 to 24, x is 8 to 24 and q is 0.

31. The noble metal-oxo cluster according to claim 19, represented by the formula
[Mₛ(R₂XO₂)_{z}(OR′)ₓO_{y}X′_{q}]·w(H₂O)·w′(A)
wherein w represents the number of attracted water molecules per noble metal-oxo cluster [Mₛ(R₂XO₂)_{z}(OR′)ₓO_{y}X′_{q}], and ranges from 1 to 240, and
wherein each A is a neutral entity that is attracted to the noble metal-oxo cluster [Mₛ(R₂XO₂)_{z}(OR′)ₓO_{y}X′_{q}], the structure and composition of the neutral entities A being such that they are capable of linking individual noble metal-oxo clusters [Mₛ(R₂XO₂)_{z}(OR′)ₓO_{y}X′_{q}] to each other in the solid state, wherein A is selected from the group consisting of carboxylic acids and derivatives thereof, phosphinic acids and derivatives thereof, arsenic acids and derivatives thereof, silicates, and tungstosilicates,
wherein w′ represents the number of attracted neutral entities A per noble metal-oxo cluster [Mₛ(R₂XO₂)_{z}(OR′)ₓO_{y}X′_{q}], and ranges from 0 to 50.

32. The noble metal-oxo cluster according to claim 19, wherein the noble metal-oxo cluster is in the form of a solution-stable noble metal-oxo cluster.

33. A process for the preparation of the noble metal-oxo cluster of claim 19, said process comprising:
(a) reacting at least one source of M and at least one source of R₂XO₂ and optionally at least one source of X′ to form a noble metal-oxo cluster [Mₛ(R₂XO₂)_{z}(OR′)ₓO_{y}X′_{q}] or a solvate thereof,
(b) optionally adding at least one source of A to the reaction mixture of step (a) to form a noble metal-oxo cluster [Mₛ(R₂XO₂)_{z}(OR′)ₓO_{y}X′_{q}] or a solvate thereof with neutral entities A being attracted to the noble metal-oxo cluster [Mₛ(R₂XO₂)_{z}(OR′)ₓO_{y}X′_{q}] or a solvate thereof, and
(c) recovering the noble metal-oxo cluster or solvate thereof.

34. A supported noble metal-oxo cluster comprising noble metal-oxo cluster according to claim 19, on a solid support; wherein the solid support is selected from polymers, graphite, carbon nanotubes, electrode surfaces, aluminum oxide and aerogels of aluminum oxide and magnesium oxide, titanium oxide, zirconium oxide, cerium oxide, silicon dioxide, silicates, active carbon, mesoporous silica, zeolites, aluminophosphates (ALPOs), silicoaluminophosphates (SAPOs), metal organic frameworks (MOFs), zeolitic imidazolate frameworks (ZIFs), periodic mesoporous organosilicas (PMOs), and mixtures thereof.

35. A metal cluster unit of the formula
[M⁰ₛ],
wherein:
each M⁰ is independently selected from the group consisting of Pd⁰, Pt⁰, Rh⁰, Ir⁰, Ag⁰, and Au⁰, and
s is a number from 8 to 96.

36. The metal cluster unit according to claim 35, wherein all M⁰ are the same and selected from Pd⁰ and Pt⁰, and s is a number from 14 to 72.

37. The metal cluster unit according to claim 35, wherein the metal cluster unit is in the form of particles, wherein at least 90 wt % of the metal cluster unit particles are in the form of primary particles.

38. The metal cluster unit according to claim 35, wherein the metal cluster unit is dispersed in a liquid carrier medium thereby forming a dispersion of metal cluster unit in said liquid carrier medium; and wherein a dispersing agent is present to prevent agglomeration of the primary particles of metal cluster unit.

39. The metal cluster unit according to claim 35, wherein the metal cluster unit is immobilized on a solid support thereby forming supported metal cluster unit; wherein the solid support is selected from polymers, graphite, carbon nanotubes, electrode surfaces, aluminum oxide and aerogels of aluminum oxide and magnesium oxide, titanium oxide, zirconium oxide, cerium oxide, silicon dioxide, silicates, active carbon, mesoporous silica, zeolites, aluminophosphates (ALPOs), silicoaluminophosphates (SAPOs), metal organic frameworks (MOFs), zeolitic imidazolate frameworks (ZIFs), periodic mesoporous organosilicas (PMOs), and mixtures thereof.
